(19) United States
(12) Patent Application Publication
(10) Pub. No.: US 2015/0328616 A1
(43) Pub. Date: Nov. 19, 2015

(54) SURFACE MEDIATED SYNTHESIS OF POLYNUCLEOTIDES, POLYPEPTIDES AND POLYSACCHARIDES AND RELATED MATERIALS, METHODS AND SYSTEMS

(71) Applicant: CALIFORNIA INSTITUTE OF TECHNOLOGY, PASADENA, CA (US)

(72) Inventors: Matthew GETHERS, PASADENA (CA); William A. GODDARD, III, PASADENA (CA); Paul S WEISS, LOS ANGELES, CA (US); John RANDALL, RICHARDSON, TX (US)

(21) Appl. No.: 14/711,738

(22) Filed: May 13, 2015

Related U.S. Application Data
(60) Provisional application No. 61/992,725, filed on May 13, 2014.

(51) Int. Cl. B01J 19/00

(52) U.S. Cl. CPC B01J 19/0046; B01J 2219/00731; B01J 2219/00722; B01J 2219/00725; B01J 2219/00587; B01J 2219/00596; B01J 2219/00529; B01J 2219/00527; B01J 2219/0043; B01J 2219/00432

(57) ABSTRACT

Surface mediated polymer synthesizing methods and related systems and materials are described where monomers are attached to monomer binding regions on a surface and subsequently form chemical bonds with adjacent monomers on the surface to form linear polymers selected from polynucleotide, polypeptides and polysaccharides.

### CROSS REFERENCE TO RELATED APPLICATIONS

This application claims priority of U.S. Provisional Application Ser. No. 61/992,725 filed May 13, 2014 with docket number CIT-6236-P3 and entitled “SURFACE MEDIATED SYNTHESIS”, the disclosure of which is incorporated herein by reference in its entirety.

### FIELD

The present disclosure relates to polymer synthesis and related methods on structured surfaces. In particular, the present disclosure relates to a surface mediated synthesis of polynucleotides, polypeptides and polysaccharides and related materials, methods, and systems.

### BACKGROUND

Polymers and the related methods of assembly have long been of interest chemical and biological fields. In particular, synthesis of polypeptides, polysaccharides and polynucleotides, is an area of intensive importance in particular when directed to synthesis of sequence specific polypeptide and polynucleotides.

Synthesis of polymers such as polynucleotides can be performed with a solid-phase synthesis process in which molecules are bound on a support and synthesized step-by-step in a reactant solution. This approach makes it easier to remove excess reactant or byproduct from the product compared with synthesis using a solution state process.

However, despite development of several approaches, efficient, cost effective and/or accurate synthesis of polynucleotides, polypeptides and polysaccharides remains a challenge in particular when performed in connection with polymers such as DNA in which the sequence of the monomer in the polymer can be of great importance.

### SUMMARY

Provided herein is a surface mediated synthesis of a linear polymer selected from a polynucleotide, a polypeptide and a polysaccharide and containing a plurality of constituent monomers of a same or different type, and related materials, methods and systems in which individual monomers of the polynucleotides, polypeptides and polysaccharide are attached to the surface adjacent to one another, prior to initiating the coupling reactions resulting in polymerization.

In particular, according to a first aspect, a method for synthesis of a surface-attached linear polymer containing a plurality of constituent monomers of a same or different type is described. The linear polymer is selected from the group consisting of a polynucleotide containing a plurality of nucleotides of same or different type, a polypeptide containing a plurality of amino acids of same or different type, and a polysaccharide containing a plurality of saccharides of same or different type.

The method comprises: a) attaching monomers of each type of constituent monomer contained in the linear polymer to be synthesized to attachment sites of a corresponding set of monomer binding regions on a coated surface to provide attached monomers of each type of constituent monomers of the linear polymer, and b) performing a coupling reaction between polymerizing functional groups of the thus providing attached monomers of each type of constituent monomers of the liner polymer to obtain the surface-attached linear polymer.

In the method corresponding sets of monomer binding regions for all types of constituent monomers contained in the polymer, form on the patterned surface a plurality of monomer binding regions each monomer binding region of the plurality of monomer binding regions having an attachment site located at a distance MBD with respect to an attachment site of an adjacent monomer binding region of the plurality of monomer binding regions wherein

$$M B D ≅ \frac{C Wem + C Wam}{2}$$

in which CWem is a characteristic width of a monomer bound to said each monomer binding region of the plurality of monomer binding regions and CWam is a characteristic width of a monomer bound to the adjacent monomer binding region of the plurality of monomer binding regions, so that adjacent constituent monomers attached to the plurality of monomer binding regions present corresponding polymerizing functional groups at a distance approximately equal to the bond length ±50% one with respect to another

According to a second aspect, a support for synthesis of a surface-attached linear polymer is described. The linear polymer contains a plurality of constituent monomers of a same or different type is described. The linear polymer is selected from the group consisting of a polynucleotide containing a plurality of nucleotides of same or different type, a polypeptide containing a plurality of amino acids of same or different type, and a polysaccharide containing a plurality of saccharides of same or different type The support comprises at least one set of monomer binding regions patterned on a coated surface of the support so that a sequential order of the monomer binding regions corresponds to a sequential order of positions of a single type of constituent monomer in the polymer, the at least one set of monomer binding regions forming a plurality of patterned monomer binding regions. In the support, each monomer binding region of the plurality of monomer binding regions having an attachment site located at a distance MBD with respect to an attachment site of an adjacent monomer binding region of the plurality of monomer binding regions wherein

$$M B D ≅ \frac{C Wem + C Wam}{2}$$

in which CWem is a characteristic width of a monomer bound to said each monomer binding region of the plurality of monomer binding regions and CWam is a characteristic width of a monomer bound to the adjacent monomer binding region of the plurality of monomer binding regions, so that adjacent constituent monomers attached to the plurality of monomer binding regions present corresponding polymerizing functional groups at a distance approximately equal to the bond length ±50% one with respect to another.

According to a third aspect a method to provide a support for a surface attached polymer synthesis is described. The method comprises providing a support having a surface capable of attaching monomers of each type of monomers contained in the polymer and covering the surface with a mask of inert material to provide a coated surface. The method further comprises patterning the coated surface to provide at least one set of monomer binding regions patterned on the coated surface of the support so that a sequential order of the monomer binding regions corresponds to a sequential order of positions of a single type of monomer in the polymer, the at least one set of monomer binding regions forming a plurality of patterned monomer binding regions. In the patterned coated surface each monomer binding region of the plurality of monomer binding regions has an attachment site located at a distance MBD with respect to an attachment site of an adjacent monomer binding region of the plurality of monomer binding regions wherein

$$M B D ≅ \frac{C Wem + C Wam}{2}$$

in which CWem is a characteristic width of a monomer bound to said each monomer binding region of the plurality of monomer binding regions and CWam is a characteristic width of a monomer bound to the adjacent monomer binding region of the plurality of monomer binding regions—each monomer binding region of the plurality of monomer binding regions configured so that adjacent monomers attached to the plurality of monomer binding regions present polymerizing functional groups at a distance approximately equal to the bond length ±50% one with respect to another.

According to a fourth aspect a mask is described for use with a surface capable of attaching each type of monomers of a polymer to be synthesized in a surface attached polymer synthesis. The mask comprises at least one set of holes patterned on the mask so that a sequential order of holes on the mask corresponds to a sequential order of positions of a single type of monomer in the polymer, the at least one set of holes forming a plurality of patterned holes within a same mask or in combination with additional masks. In the mask or combination of masks the plurality of patterned holes are configured and distanced so that each hole of the plurality of holes is located with respect to an adjacent hole of the plurality of holes to provide attachment sites of underneath monomer binding regions on the surface are at a distance MBD wherein

$$M B D ≅ \frac{C Wem + C Wam}{2}$$

in which CWem is a characteristic width of a monomer bound to an attachment site of the surface underneath the each hole of the plurality of holes and CWam is a characteristic width of a monomer bound to an attachment site of the surface underneath the adjacent hole of the plurality of holes.

According to a fifth aspect a combination of masks is described for use with a surface capable of attaching each type of monomers of a polymer to be synthesized in a surface attached polymer synthesis herein described. In the combination of masks each e mask comprises one set of holes patterned on the mask so that a sequential order of holes on the mask corresponds to a sequential order of positions of a single type of monomer in the polymer. In the combination of masks the one set of holes of each mask of the combination of masks forms a plurality of patterned holes within a same mask or in combination with additional masks. In the mask or combination of masks the plurality of patterned holes are configured and distanced so that each hole of the plurality of holes is located with respect to an adjacent hole of the plurality of holes to provide attachment sites of underneath monomer binding regions on the surface are at a distance MBD wherein

$$M B D ≅ \frac{C Wem + C Wam}{2}$$

in which CWem is a characteristic width of a monomer bound to an attachment site of the surface underneath the each hole of the plurality of holes and CWam is a characteristic width of a monomer bound to an attachment site of the surface underneath the adjacent hole of the plurality of holes

According to a sixth aspect, a system for a surface attached polymer synthesis is described. The system comprises a support of the present disclosure, together with at least one of monomers of the type of monomers contained in the polymer, reagents to perform deposition of the monomers, and reagents for performing coupling of the monomers.

According to a seventh aspect, a system for a surface attached polymer synthesis is described. The system comprises a surface of material capable attaching each type of monomers contained in a polymer to be synthesized; one or more masks herein described and optionally, at least one of monomers of the each type of monomers contained in the polymer, reagents to perform deposition of the monomers, and reagents for performing coupling of the monomers.

According to a eight aspect, a surface attached polymer is described. The surface attached polymer is formed by polymerized monomers, each of which is attached to a surface of a support herein described.

The materials, compositions, methods and systems for the surface attached polymer synthesis herein described, allow in some embodiments to perform sequence specific polymerization of polynucleotides, polypeptides and/or polysaccharide polymers.

The materials, compositions, methods and systems for the surface attached polymer synthesis herein described, allow in some embodiments, direct synthesis of custom-length polynucleotide, polypeptide or polysaccharide polymers.

The materials, compositions, methods and systems for the surface attached polymer synthesis herein described, allow in some embodiments opportunity for correction in case bonding to the surface of one or more monomers forming the polymer to be synthesized fails, by repeating the deposition of the one or more monomers.

The materials, compositions, methods and system for the surface attached polymer synthesis herein described, allow in some embodiments to synthesize the polymer by synthesizing fragments of the polymer and then use such fragment in subsequent assemblies including a subsequent assembly performed by surface mediated synthesis herein described.

The materials, compositions, methods and system for the surface attached polymer synthesis herein described, allow in some embodiments to perform the coupling reactions with no need to terminate one reaction before starting another reaction as all bonds along the polymer are made simultaneously.

The materials, compositions, methods and system for the surface attached polymer synthesis herein described, allow in some embodiments the direct synthesis of longer polymer fragments and reduce the need for subsequent assembly steps.

Accordingly, the materials, compositions, methods and system for the surface attached polymer synthesis herein described, allow in some embodiments to reduce costs, turnaround time, and complexity in the synthesis process of several polymers.

The materials, compositions, methods and system for the surface attached polymer synthesis herein described, can be used in connection with applications wherein polymer synthesis is desired, in particular in connection with linear polynucleotide, polypeptide and polysaccharide having different types of monomers positioned in the linear polymer in a sequential order and/or in connection with synthesis of a polynucleotide, polypeptide and/or polysaccharide having a defined length. Exemplary applications comprise synthesis of both homopolymers and heteropolymers, in biological and non-biological applications and additional applications identifiable by a skilled person.

The details of one or more embodiments of the disclosure are set forth in the accompanying drawings and the description below. Other features and objects will be apparent from the description and drawings, and from the appended claims

### BRIEF DESCRIPTION OF THE DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a schematic representation of an exemplary type of constituent monomer with monomer polymerizing functional groups defining a characteristic width. In particular, FIG. 1A shows a schematic illustration of a modified D-glucose with monomer polymerizing functional groups on carbon 1 and carbon 6 (labeled with arrows) defining a characteristic width; FIG. 1B illustrates two modified D-glucose monomers placed adjacent to one another with the monomer polymerizing functional groups of each monomer labeled with arrows.

FIG. 2 shows a schematic representation of an exemplary type of constituent monomer with monomer polymerizing functional groups defining a characteristic width. FIG. 2A illustrates a first Leucine-Alanine bipeptide with two monomer polymerizing functional groups (labeled with arrows) defining a characteristic width of the monomer formed by the bipeptide; FIG. 2B illustrates a second Glycine-Valine bipeptide with two monomer polymerizing functional groups (labeled with arrows) defining a characteristic width of the monomer formed by the bipeptide. FIG. 2C illustrates the two bipeptides each attached with a linker, placed adjacent to one another on the surface with the reactive moieties of each dipeptide labeled with arrows.

FIG. 3 shows a schematic illustration of attachment of two monomers (monomer 1 and monomer 2) on a surface. CW indicates the Characteristic Width of the monomers and MAS indicates the Minimum Allowable Spacing of the surface. In this scenario, the monomers have the same CW, which is equal to the MAS.

FIG. 4 shows a schematic illustration of attachment of two monomers (monomer 1 and monomer 2) on a surface. CW1 indicates the Characteristic Width of monomer 1, CW2 indicates the characteristic width of monomer 2 and MAS indicates the Minimum Allowable Spacing of the surface. In this case, the sum of the CW1 and CW2 is equal to twice the MAS.

FIG. 5 shows a schematic illustration of attachment of two monomers (monomer 1 and monomer 2) on a surface. CW indicates the Characteristic Width and MAS indicates the Minimum Allowable Spacing of the surface. In this case, both monomers have the same CW, which is less than the MAS.

FIG. 6 shows a schematic illustration of a directional monomer (black arrow) functionalized with two chemically orthogonal linkers (Linker 1 and Linker 2 dotted). In the illustration of FIG. 6, the directional monomer spans two attachment sites of a surface and is attached to the surface through binding of chemically orthogonal functional groups on Linker 1 (diamond) and Linker 2 (circle) to corresponding functional groups presented on to the surface (diamond on solid line corresponding to the diamond on Linker 1; and circle on solid line corresponding to the circle on Linker 2).

FIG. 7 shows a schematic illustration of a directional monomer (black arrow) functionalized with two chemically orthogonal linkers as shown in FIG. 6, in an inverse orientation wherein interaction of the two chemically orthogonal linkers with the corresponding functional groups presented on the surface is minimized.

FIG. 8A to 8D shows a schematic illustration of various configurations of an attachment linker according to embodiments herein described, where the linker (solid black line) is functionalized with a surface linking functional group (SLFG), an anchor functional group (AFG) and/or a Linker functional group (LFG).

FIG. 9A to 9D shows a schematic illustration of various configurations of an orienting linker according to embodiments herein described, where the linker (solid black line) is functionalized with a surface linking functional group (OFG), an anchor functional group (OAFG) and/or a Linker functional group (LFG).

FIG. 10 shows a schematic illustration of directional monomers (black arrows) each spanning one attachment site, in which each monomer is functionalized with two linkers, one attaching the monomer to the designated attachment site (solid black line connecting the arrow to the surface) and a secondary linker attaching the monomer to a corresponding functional group presented on an adjacent attachment site. (diamond on dotted gray line on the monomer and diamond on solid gray line on the surface)

FIG. 11 shows a schematic illustration of a directional monomer (black arrow) functionalized with two chemically orthogonal linkers as shown in FIG. 10, in an inverse orientation wherein interaction of the two chemically orthogonal linkers with the corresponding functional groups presented on the surface is minimized.

FIG. 12 shows a schematic illustration of a directional monomer (black arrow) functionalized with two chemically orthogonal linkers as shown in FIG. 10, where two adjacent monomers compete for a secondary linkage site.

FIGS. 13A to 13F show a schematic illustration of an exemplary surface synthesis methods and related materials and systems for a monomers having a same CW (black arrow) performed with orienting linkers (dashed lines) binding orienting anchor functional group (gray triangle) on a surface.

FIGS. 14A to 14J show a schematic illustration of an exemplary surface synthesis methods and related materials and systems for a monomers having a same CW (black arrow) and either a surface linking group (downward triangle) and orienting linker (dashed lines), or only the a surface linking group (downward triangle). In the schematics of FIG. 14A to 14J attachment is performed using a combination of a primary anchor (upward gray triangle) orienting anchor (diamond) and a first and second protection group.

FIG. 15 shows a schematic illustration of a method for surface mediated synthesis according to embodiments of the disclosure wherein attaching of monomers is performed by laying out the entire sequence of monomers on a nanostructured surface first, and then performing coupling reactions to polymerize the monomers thus forming a surface attached polymer.

FIG. 16 shows a schematic illustration of exemplary embodiments herein described in which a coated surface presents a mask of inert material (dark gray) and patterning the surface comprises sequentially unmasking regions of the surface (light gray). In particular, FIG. 16A shows an exemplary embodiment in which for each type of monomers of a polynucleotide sequence GATA, the attaching is sequentially performed by unmasking a set of monomer binding regions (step 3 for G, step 5 for A and step 7 for T) and binding the monomer (step 4 for G; step 5 for A and step 8 for T) FIG. 16B shows an exemplary embodiment in which for a plurality of polynucleotides having a common initial sequence AG to be synthesized on a same surface, the attaching is sequentially performed by unmasking a set of monomer binding regions (step 3 for A, step 5 for G) and binding the monomer (step 4 for A; step 5 for G) in all the plurality of polymers.

FIG. 17 shows a schematic representation of a masking system formed by masks 1 to 4 each having a masking portion (grey) and a set of holes (white). In the schematic illustration of FIG. 13 the system Masks 1 to 4 are to be used in a stacked combination where mask 1 is on top and Mask 4 is on the bottom according to embodiments herein described.

FIG. 18 shows an exemplary stacking process of the masking system of FIG. 17 wherein the stacking order is indicated by the arrow. In the schematics of FIG. 17 the holes are indicated in white the masking regions are indicated in grey and the holes covered by masking region of a stacked mask are indicated in light gray.

FIG. 19 shows a schematic illustration of an exemplary process of synthesizing an exemplary polynucleotide using the masking system formed by separate layers of holey graphene of FIG. 18. In the illustration of FIG. 19, G indicates the gold substrate, MS indicates a stacked masking system of FIG. 18 and 1, 2, 3 and 4 indicate the respective masks of the illustration of FIG. 19.

FIG. 20 shows a schematic illustration of exemplary embodiments in which a coated surface is a passivated surface and patterning the coated surface comprises activating regions of the surface of the passivated material. In particular, the schematic of FIG. 20 shows that removal of a hydrogen from a passivated silicon surface to provide an available site for binding a functional group on a monomer or a linker. The removal of the hydrogen is done with a Scanning Tunneling Microscope, the tip of which is denoted by the inverted triangle that is positioned over the hydrogen that is to be removed.

FIG. 21 shows a schematic illustration of exemplary embodiments in which a coated surface is a passivated surface and patterning the coated surface comprises activating regions of the surface of the passivated material. In particular, the schematic of FIG. 21A shows addition of an alkene ([2+2] cycloaddition, bottom) or a conjugated diene ([4+2] cycloaddition or Diels-Alder reaction, top). The schematic of FIG. 21B shows activation of a region in a passivated silicon surface by removing a hydrogen from a first Si atom (e.g. by hydrogen lithography) (step 1), removing a hydrogen from a second Si atom adjacent to the first Si atom, (step 2) thus providing radical electrons (step 3) which form a weak pi-bond between the first and second Si atoms (step 4) thus providing the activated region of the passivated silicon surface that can be used for site-specific cycloaddition (steps 5 and 6).

FIG. 22 shows a schematic illustration of attachment of a compound with protected functional group on an activated region of a passivated surface formed by a pi-bond according to an exemplary embodiment herein described. In particular the schematic of FIG. 22, a protected, functionalized cyclopentenes having a functional group (FG) protected with a protection group (PG) conjugated to the silicon surface.

FIG. 23 shows a schematic illustration of activating a region of a passivated surface according to exemplary embodiments herein described. In particular in FIG. 23, activating a region in a passivated silicon surface is performed by removing hydrogens from a dimer pair (left panel) thus forming a silicon-silicon pi bond between a Si pair formed by adjacent Si atoms on the passivated silicon surface (right panel).

FIG. 24 shows a schematic illustration of addition of an anchor (A1) to an activated region of a passivated surface according to an exemplary embodiment herein described. In particular, in the illustration of FIG. 24, addition of a protected, functionalized cyclopentene having a functional group (FG1) protected with a protection group (PG1) is shown via cycloaddition to a silicon-silicon pi bond presented on the silicon surface.

FIG. 25 shows a schematic illustration of activating a region of a passivated surface attaching an anchor A1 having a functional group (FG1) and a protection group (PG1) (left panel) and addition of an anchor A2 to the newly formed activated region (right panel) according to an exemplary embodiment herein described. In particular, in the illustration of FIG. 25, addition of a protected, functionalized cyclopentene A2 having a functional group (FG2) protected with a protection group (PG2) is performed via cycloaddition to a silicon-silicon pi bond presented on the silicon surface adjacent to the anchor (A1).

FIG. 26 shows a schematic illustration of removal of protection group (PG1) from the anchor A1 of FIG. 24 and subsequent addition of a monomer (M1).

FIG. 27 shows a schematic illustration of an anchor (A2) presenting a functional group (FG2) protected by a protection group (PG2), the anchor (A2) attached to an activated region of a passivated silicon surface adjacent to an anchor (A1) presenting monomer (M1) attached to functional group (FG1) (left panel) according to an exemplary embodiment herein described. In particular, in the illustration of FIG. 27, protection group (PG2) is removed from anchor (A2) (central panel) and replaced by monomer (M2) attached to the functional group (FG2) (right panel)

FIG. 28 shows a schematic illustration of polymerization of monomers on the anchor (A1) and anchor (A2) of FIG. 27 to form a product (P).

FIG. 29 shows a schematic illustration of activating a region of a passivated surface and attaching a compound with protected functional group on the activated region formed by a pi-bond according to an exemplary embodiment herein described. In particular in the illustration of FIG. 29, a schematic of steps a-d for the placement of styrene monomer functionalized with an N-hydroxysuccinimide (NHS) ester on a surface is shown. Steps a shows the removal of both hydrogens on adjacent Si atom to produce a weak pi bond; step b shows the cycloaddition of the anchor tertbutyloxycarbonyl (tBOC) 1-Amino-Cyclopentene (ACP) t-BOC-ACP; step c shows the removal of t-Boc with acid and step d is the coupling of styrene monomer to the exposed amino group via an NHS ester.

FIG. 30 shows a schematic illustration of a lateral view (left panel) top view (Central panel) and transversal view (right panel) of the lattice agreement between styrene monomers arranged on the silicon surface and the silicon substrate.

FIG. 31 shows a schematic illustration of a process to provide a mask of inert material including a plurality of patterned holes, to transfer the mask to a support, and t to deposit molecules to the patterned surface according to an exemplary embodiment herein described. In particular, in the illustration of FIG. 31, an Au nanoparticle catalyzed oxidative process for preparation of a “holey” graphene mask for 1-adamantanethiol deposition: Au (light gray) is deposited on a monolayer sheet of graphene (dark gray) on a SiO₂ substrate (black) (step 1) and then annealed to form nanoparticles (step 2). The Au is then etched (step 3) and washed (step 4). “Holey” graphene is then transferred to a Au(111)/mica substrate (step 5) and annealed to remove adventitious solvent (step 6); the same substrate is then exposed to a vapor solution of 1-adamantanethiol (1AD) for deposition (step 7)

FIG. 32 shows depiction of a holey graphene according to an exemplary embodiment herein described. FIG. 32A and FIG. 32B show pictures of a “holey” graphene measured with transmission electron microscopy (TEM) supported on a 200 mesh formvar/copper grid ( ): each image was acquired at an accelerating voltage of 300 kV using a FEI Titan microscope; holes measured with TEM are 37±8 Å in diameter and are randomly distributed across the graphene layer; FIG. 32C shows a diffraction image of the holey graphene shown in FIG. 32B, where the hexagonal pattern of graphene is observed; FIG. 32D shows schematic that depicts “holey” graphene with randomly distributed holes and an inset showing a graphene layer.

FIG. 33 shows topographic imaging of the mask of FIG. 32. In particular, FIG. 33A shows the original transmission electron microscopy image from FIG. 32B before segmentation; FIG. 31B shows an image histogram of pixel intensities of the data of FIG. 33A showing the intensity threshold cut off used to create an image binary; FIG. 33C shows a resulting binary mask, where graphene holes are separated from the graphene layer; FIG. 33D shows a small outlier artifacts in the image binary are removed; FIG. 33E shows the diameters of the remaining holes are displayed in a bar graph, binned by diameter (10 Å bin width), for an average 37±8 Å hole size.

FIG. 34 shows scanning tunneling imaging of the graphene mask. In particular, FIG. 34A and FIG. 34B show scanning tunneling micrographs (Itunneling=3 pA, Vsample=−1.0 V) of “holey” graphene on Au(111)/mica directly after deposition from solution of water and acetone; images show protrusions higher in intensity and depressions lower in intensity; the more intense protrusions as solvent that has not desorbed from the holes, and depressions as holes (without solvent) within the graphene overlayer; FIG. 34C show after annealing at 100° C. for 24 h, all solvent is evaporated and only the depressions (holes) remain.

FIG. 35 shows scanning tunneling micrographs of the graphene of FIG. 34 after annealing on a gold surface according to an exemplary embodiment herein described—FIG. 35A shows a scanning tunneling micrograph (Itunneling=3 pA, Vsample=−1.0 V) of “holey” graphene on Au(111)/mica along two monoatomic step edges after annealing at 100° C. for 24 h; FIG. 35B shows a higher resolution of the larger box in FIG. 35A; FIG. 35C shows a higher resolution image of the smaller box in FIG. 35A; insets in FIG. 35B shows a fast Fourier transform, where graphene displays a hexagonal nearest neighbor spacing of 5.0±0.5 Å; FIG. 35D shows a schematic showing a pore in graphene exposing the underlying Au(111) substrate that further depicts the measured (2×2) Moire superstructure of graphene on Au. The exposed gold is bounded by the hexagonal pore. The area outside of this pore is gold covered by graphene. The diamond at the center of the pore denotes the 1×1 cell of the gold surface, and the diamond in the lower left corner of the image represents the 2×2 cell Moire superstructure.

FIG. 36 shows scanning tunneling micrographs of a graphene mask on a gold substrate and related MATLAB computation. In particular, FIG. 36A shows scanning tunneling micrograph (Itunneling=3 pA, Vsample=−1.0 V) of “holey” graphene on Au(111)/mica. FIG. 36B shows a apparent height histogram corresponding to the micrograph of FIG. 36A; masking techniques, performed in MATLAB, enable a “holey” regions and graphene regions to be isolated and analyzed independently; FIG. 36C shows the image in FIG. 36A segmented by apparent height; the graphene layer is 2.1±1.2 Å higher in average apparent height compared to the exposed Au region as shown in FIG. 36D.

FIG. 37 shows scanning tunneling micrographs of an exemplary 1-AD holey graphene/gold substrate herein described. FIG. 37A shows a scanning tunneling micrograph (Itunneling=3 pA, Vsample=−1.0 V) of “holey” graphene on Au(111)/mica after exposure to a vapor solution of 1-adamantanethiol (1AD) in ethanol; FIG. 37B and FIG. 37C show two regions where 1AD has assembled on Au(111) within the confines of the pores of the holey graphene; (FIG. 37C, inset) a fast Fourier transform shows local order of both the self-assembled molecules in the pores and the graphene overlayer with nearest-neighbor spacings of 7.4±1.0 Å and 5.0±1.0 Å, respectively; FIG. 37D shows a schematic of the arrangement in FIG. 37C where the graphene pore is filled with assembled 1AD; FIG. 37E shows ball-and-stick model of the 1AD molecule with hydrogens not shown, for clarity.

FIG. 38 shows scanning tunneling micrographs (Itunneling=3 pA, Vsample=−1.0 V) of “holey” graphene filled with 1-adamantanethiolate (1AD) on Au(111)/mica, where the spacing between adjacent 1AD molecules and carbon atoms in graphene is recorded; images of the molecules were first smoothed, thresholded, and fit for centroids, and analyzed in the molecular regions highlighted; the inserted molecular layer shows an average spacing (across multiple images) of 7.4±1.0 Å, while the graphene mask shows an average spacing of 5.0±1.0 Å.

FIG. 39 shows scanning tunneling micrographs of a graphene mask on a gold substrate and related MATLAB computation. In particular, FIG. 39A shows scanning tunneling micrograph (Itunneling=3 pA, Vsample=−1.0 V) of “holey” graphene filled with 1-adamantanethiolate on Au(111)/mica. FIG. 39B shows a corresponding apparent height histogram; masking techniques, performed in MATLAB, enable filled regions and bare graphene regions to be isolated and analyzed independently; FIG. 39C and FIG. 39D show the image of FIG. 39A segmented by apparent height and displayed; a 1-admantanethiolate patch is 1.1±0.5 Å higher in average apparent height compared to the graphene layer.

FIG. 40 shows scanning tunneling topographs of a gold graphene support before and after a second anneal of graphene with gold. In particular FIG. 40A shows a scanning tunneling micrograph (Itunneling=3 pA, Vsample=−1.0 V) of “holey” graphene with the 2D pores filled with assembled 1-adamantanethiol on Au(111)/mica; FIG. 40B shows a schematic of removal of adsorbates from pores after annealing at 250° C. for 24 h; FIG. 40C, and FIG. 40D show scanning tunneling micrographs (Itunneling=3 pA, Vsample=−1.0 V) of the same sample after complete molecular desorption, recorded at two different resolutions, as indicated; (FIG. 40D, inset) a fast Fourier transform shows the recovered hexagonal spacing (5.0±0.5 Å) measured previously.

FIG. 41 shows scanning tunneling micrographs (Itunneling=3 pA, Vsample=−1.0 V) of “holey” graphene on Au(111)/mica after a second 1 adamantanethiolate vapor deposition for 24 h; each sample was regenerated, prior to the second deposition step, by annealing at 250° C.; images depict 1AD molecules within a “holey” graphene framework. FIGS. 41A and 41B show micrograph of two different samples.

FIG. 42 shows a schematic illustration of a monosaccharide monomer and a corresponding polysaccharide attached to a surface according to an embodiment herein described. FIG. 42A shows the chemical structure of a D-Glucosammine presenting polymerizing functional groups formed by a hydroxyl group (OH) and phenyl thiol ether (SPh) where indicated) attaching a linker moiety ending with cyclopentene. FIG. 42B shows a schematic illustration of the polyglucosamine formed on a silica surface by a plurality of the D-Glucosammine monomers attaching a linker of FIG. 42A.

### DETAILED DESCRIPTION

Provided herein is a surface mediated synthesis of linear polymer containing a plurality of a same or different constituent monomers and related materials, methods and systems in which individual monomers of the linear polymer are attached to the surface adjacent to one another, prior to initiating the coupling reactions resulting in polymerization.

The term “surface” as used herein indicates the outside part or uppermost layer of a substrate material. The term “substrate” as used herein indicates an underlying support or substratum. Exemplary substrates include solid substrates, such as plates, microtiter well plates, magnetic beads, wafers, nanoparticles, nanotubes and additional substrates identifiable by a skilled person upon reading of the present disclosure. The substrate material in the sense of the disclosure is selected so that the atoms on the outside part or uppermost layer can form a covalent bond with an adsorbate and in particular with adsorbate monomers Exemplary substrate material are provide by elements or compounds such as Gold, Carbon, Silicon, or Silicon Oxides and the surfaces can be crystals of those elements or compounds, Surfaces in the sense of the disclosure can be flat, curved, or angled or otherwise shaped as will be understood by a skilled person. A substrate can be formed entirely of a substrate material or the substrate material can be layered on top of another material, such as gold over mica. Exemplary surfaces in the sense of the disclosure comprise surface of gold plates, nanoparticles, functionalized carbon nanotubes and similar structures identifiably by a skilled person.

The term “synthesis” as used herein indicates the forming or building of a more complex substance or compound from elements or simpler compounds. In particular, synthesis in the sense of the present disclosure relates to polymerization of monomers performed on a surface. The term “polymerization” as used herein indicates a process of reacting monomer molecules together in a chemical reaction coupling the monomers to form a polymer.

The term “polymer” as used herein indicates a large molecule (macromolecule) composed of repeating structural units connected by covalent chemical bonds. In polymers herein described a “backbone” of a polymer is a sequence of covalently bonded atoms that constitute a major uninterrupted linear structure of the polymer. For example in polypeptides the portion formed by the alpha carbon, the amine group and the carboxyl group of the amino acids monomers forms the backbone of the polypeptide polymer.

The term “monomer” or “monomer unit” as used herein indicates a molecule capable of reacting with identical or different molecules to form a polymer through covalent link of corresponding functional groups presented on the backbone of the monomer herein also indicated as polymerizing functional groups. The term “backbone” of a monomer refers to the linear moiety linking the two polymerizing functional groups of the monomer, which in the synthesized polymer is part of the backbone of the polymer. In some instances the linear moiety attaches variable side chains and/or additional functional groups presented on the backbone of the monomer and/or on the variable side chains of the monomer. Monomers that present two polymerizing functional groups are used to form linear polymers. Monomers that present more than two polymerizing functional group are used to form branched polymers in combination with monomers presenting two polymerizing functional groups wherein the monomers presenting more than two polymerizing functional groups provide branches of the polymer.

Monomers forming a polymer are also indicated as the constituent monomer of that polymer and can be formed by a single repeating structural unit of the polymer or by molecules containing multiple repeating structural units of the polymer. Constituent monomers of a polymer can be of a same type or of a different type, wherein the type is defined by the number of repeating structural units of the polymer, moiety forming the backbone of the monomer, in presence, number, positioning and composition of variable side chains and/or in presence number positioning and composition of functional groups presented on the atoms forming the backbone of the constituent monomer and/or in one or more of the variable side chains.

Accordingly for a given polymer, constituent monomers of a same type are monomers that include a same number of repeating structural unit for the polymer and/or a same moiety forming the backbone of the monomer, same number of side chain each having the same positioning and chemical nature, same number of functional groups each having a same positioning, and chemical nature. For the same polymer, constituent monomers of a different type are monomers that include a different number of repeating structural units of the polymer, and/or a different moiety forming the backbone of the monomer, different number of side chain each having the same positioning and chemical nature and/or different number of functional groups each having a same or different positioning, and/or a same or different chemical nature, as will be understood by a skilled person.

In methods and systems herein described the surface synthesis method is directed to the synthesis of a linear polymer containing a plurality of constituent monomers of a same or different type.

The term linear polymers as used herein indicated a polymer formed by a plurality of monomers each having two polymerizing functional groups, joined end-to-end along the backbone of the polymer. Accordingly a linear polymer in the sense of the disclosure is without branches or cross-linked monomers. Linear polymers comprise polymers of any length. A linear polymer formed by up to 50 monomers units is herein identified as an oligomer in which the specific length of the oligomer varies depending on the specific linear polymer. Examples of oligomers include dimers, trimers and tetramers, which are oligomers composed of two, three and four monomers, respectively.

The linear polymer synthesized by surface mediated synthesis herein described is selected from polysaccharides polynucleotide and polypeptides each formed by respective constituent monomers.

The term “polysaccharide” as used herein indicates polymeric carbohydrate molecules composed of chains of monosaccharide repeating structural units bound together by glycosidic linkages. Polysaccharides have a general chemical formula of Cₓ(H₂O)_{y} and can provide the constituent monosaccharides or oligosaccharides on hydrolysis. Polysaccharides are formed by monosaccharides units linked by glycosidic linkages. Examples of polysaccharides are cellulose, starch, glycogen and many others that are identifiable to a skilled person in the art. Polysaccharides can be a homopolysaccharide or a heteropolyssacharide depending on their monomsaccharide components. A homopolysaccharide consists of same types of monosaccharides whereas a heteropolysaccharide is composed by different types of monosaccharides.

The term “monosaccharide” refers to the structural unit that forms the polysaccharides having a general formula (CH₂O)ₙ, where n is three or more or derivative thereof formed by modified functional groups presented on the backbone of the monomer. In monosaccharides, the backbone of the monomer is formed by the cyclic ether portion of the saccharide, and the polymerizing functional groups are an hemiacetal group and hydroxyl group presented on the monosaccharide. Additional functional groups can also be presented on the backbone such as carboxylase and amino groups as will be understood by a skilled person. Different types of monosaccharides are defined by the number of carbons in the cyclic ether portion forming the backbone the specific polymerizing functional groups their positioning and position of the any additional functional group stemming from the backbone such as —OH and —CH₂OH group attached to the carbons.

In monosaccharides the coupling of corresponding polymerizing functional groups presented on monomers results in formation of glycosidic covalent linkage or glycosidic bonds. Glycosidic linkage are labeled as α or β depending on the anomeric configuration of the C₁ involved in the glycosidic bonds. For example, maltose, which links two glucose molecules, has α glycosidic bond, while lactose links glucose and galactose in a β glycosidic bond instead. Glycosidic linkage can be formed between C₁ and C₄ as well as other carbon groups, such as between C₁ and C₆, between C₁ and C₂ and between C₁ and C₃ groups. In the maltose for example, two molecules of glucose are linked by an α-1,4-glycosidic bond, whereas sucrose shown below are linked by an α,β-2 glycosidic bonds. In further exemplary polysaccharides glucan, the terminal glucose of the glucan is linked to its adjacent glucose via a β-1,6 glycosidic bond while the remaining glucoses are linked together via β-1,3 glycosidic bonds.

The term “polynucleotide” as used herein indicates an organic polymer composed of two or more repeating structural units including nucleotides, nucleosides or analogs thereof. The term “nucleotide” refers to any of several compounds that consist of a ribose or deoxyribose sugar joined to a purine or pyrimidine base and to a phosphate group and that is the basic structural unit of nucleic acids. The term “nucleoside” refers to a compound (as guanosine or adenosine) that consists of a purine or pyrimidine base combined with deoxyribose or ribose and is found especially in nucleic acids. The term “nucleotide analog” or “nucleoside analog” refers respectively to a nucleotide or nucleoside in which one or more individual atoms have been replaced with a different atom or with a different functional group. Exemplary nucleoside analog is a ribose moiety modified with an extra bridge connecting the 2′ and 4′ carbons providing the monomer of “locked nucleic acid”. The term “nucleoside phosphoramidite” refers to a derivative of a nucleoside used in synthetic coupling reactions to produce polynucleotides. Accordingly in monomeric unit of a polynucleotide the backbone of the monomer is formed by a cyclic ether and the polymerizing functional groups are the phosphate group presented in position 3 of the cyclic ether and the hydroxyl group presented on the 5 methylene group to position 4 of the cyclic ether. Additional functional groups that can be presented on the cyclic ether such as hydroxyl groups or other groups identifiable by a skilled person.

Different types of nucleotide monomers can be defined by a different functional groups presented on the cyclic ether and/or by side chains such as base groups, (cytosine (C), thymine (T), adenine (A), guanine (G)) and Uracil (U), denoted as “A”, “T”, “C” “G”, “U”, that are connected to the sugar (deoxyribose or ribose) of each polynucleotide monomer. Accordingly, the term polynucleotide includes nucleic acids of any length including DNA, RNA, DNA or RNA analogs and fragments thereof. A polynucleotide of three or more nucleotides and of less than 50 nucleotides is also called nucleotidic oligomers or oligonucleotide. Exemplary polynucleotides composing herein described are formed by DNA molecules, and in particular DNA oligomers.

In a polynucleotide monomer the constituent nucleotides are joined by phosphodiester bonds formed between the 5′ carbon of one polynucleotide monomer and the 3′ carbon of an adjacent polynucleotide monomer. Accordingly, in a polynucleotide monomer corresponding polymerizing functional groups of the two adjacent nucleotides are the phosphate group of one nucleotide and the 5′ carbon group of the adjacent nucleotide.

The term “polypeptide” as used herein indicates an organic polymer composed of two or more repeating structural units formed by amino acid and/or analogs thereof. As used herein the term “amino acid”, or “amino acid residue” refers to any of the twenty naturally occurring amino acids including synthetic amino acids with unnatural side chains and including both D and L optical isomers. The term “amino acid analog” refers to an amino acid in which one or more individual atoms have been replaced, either with a different atom, isotope, or with a different functional group but is otherwise identical to its natural amino acid analog. In an amino acid the backbone of the monomer is formed by carbon moiety linking the amino group and the carboxyl group which form the polymerizing functional groups of the amino acid. The backbone of the amino acid can link side chains and/or functional groups. Different types of amino acid monomers are defined by the side chain groups, commonly denoted as “R”, that are connected to the a carbon of each amino acid monomer. For example, the R group is —CH3 in Ala, —H in Gly, —CH-2(CH₃) in Val. The term “polypeptide” includes amino acid polymers of any length including full length proteins and peptides, as well as analogs and fragments thereof. A polypeptide of three or more amino acids is also called a protein oligomer or oligopeptide. Oligopeptide can comprise two to twenty amino acids and can include dipeptides, tripeptides, tetrapeptides, and pentapeptides.

The amino acids are linked in polypeptide by amide bond (peptide bond) between monomer polymerizing functional groups of two adjacent amino acids, that is, the carboxyl group of one amino acid with the amino group of the adjacent amino acid. An exemplary tetrapeptide (Val-Gly-Ser-Ala) in which the amino acids are connected to the adjacent amino acids through covalent bonds between carboxyl groups and the amino groups.

In embodiments herein described the constituent monomer of the polynucleotide polypeptide and polysaccharide herein described can present functional groups additional to the polymerizing functional groups

The term “functional group” as used herein indicates specific groups of atoms within a molecular structure that are responsible for the characteristic chemical reactions of that structure. Exemplary functional groups include hydrocarbons, groups containing halogen, groups containing oxygen, groups containing nitrogen and groups containing phosphorus, groups containing hydrogen, groups containing gold and sulfur all identifiable by a skilled person. In particular, functional groups in the sense of the present disclosure comprise a hydroxyl group, carbonyl group, Si—H, silene, S═Si double bond on silicon surface, olefin, carboxylic acid, amine, triarylphosphine, phosphoramidite, azide, acetylene, sulfonyl azide, thiol, thio acid and aldehyde. Additional functional groups can be identified by a skilled person upon reading of the present disclosure.

As used herein, the term “corresponding functional group” refers to a functional group that can react to another functional group. Thus, functional groups that can react with each other can be referred to as corresponding functional groups. For example, corresponding polymerizing functional groups or other corresponding functional group presented by the monomers can be selected to comprise the following: carboxylic acid group and amine group, azide and acetylene groups, azide and triarylphosphine group, sulfonyl azide and thio acid, and aldehyde and primary amine, phosphoramidite group and hydroxyl group, olefin and S═Si double bond on silicon surface, thiol and Au. In some instances, corresponding functional groups can include a nucleophilic group and an electrophilic group as can be identified by a person skilled in the art upon reading the present disclosure. For example, a nucleophile and an α,β-unsaturated carbonyl compound can be a Michael donor and Michael acceptor for a Michael addition reaction. Michael donors can include a carbanion or a thiolate.

The term “present” as used herein with reference to a compound or functional group indicates attachment performed to maintain the chemical reactivity of the compound or functional group as attached. Accordingly, a functional group presented on a monomer, is able to perform under the appropriate conditions the one or more chemical reactions that chemically characterize the functional group.

Coupling reactions between corresponding functional groups presented on monomers herein described are identifiable by a skilled person based on the specific pair of functional groups that are coupled. Suitable coupling reactions comprise chemical polymerizations reactions such as anionic polymerization, cationic polymerization (e.g. between olefins and heterocylic monomers), radical polymerization, ring opening metathesis polymerization (ROMP), condensation, and photoinitiated polymerization which can be performed on various functional groups herein described as will be understood by a skilled person.

In particular coupling reactions between polymerizing functional groups of the constituent monomers of polynucleotide polypeptide and polysaccharide herein described comprise phosphate groups and the 5′ carbon groups for polynucleotides, carboxyl groups and amino groups for polypeptides, and hemiacetal group and hydroxyl group for polysaccharides. The polymerization process applicable for the surface mediated synthesis herein described can be identified based on the polymer to be synthesized and the related polymerization reactions as will be understood by a skilled person.

In some embodiment, following coupling reactions between functional groups herein described, various chemical structures are formed that can be cleavable or non-cleavable as will be understood by a skilled person upon reading of the disclosure. In particular following coupling of functional groups, structure can be formed that in presence of a cleaving agent or light would unstabilize a covalent bond of the structure thus resulting in cleavage of that covalent bond.

In embodiments herein described the atoms of the polymerizing functional groups have characteristic width (CW) which is the magnitude of the characteristic vector for the monomer. The term “characteristic vector” (CV) of a monomer refers to the vector pointing between the two atoms within a monomer to which new bonds are formed with two adjacent monomers. The two atoms defining the characteristic vector of the monomer are comprised in the polymerizing functional group as will be understood by a skilled person

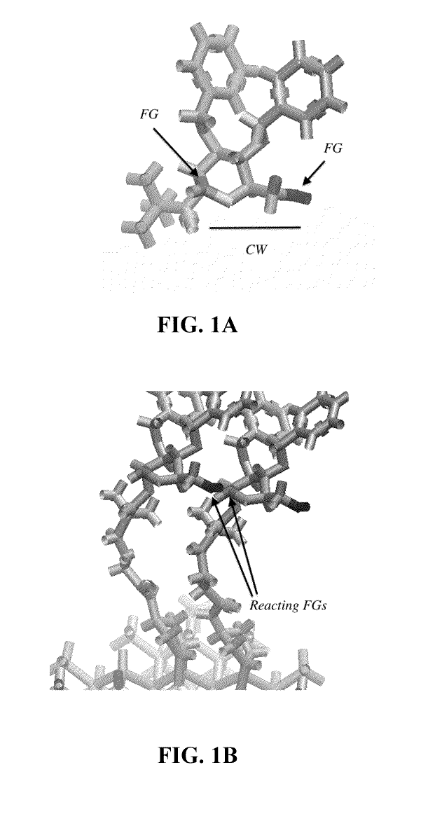

Reference is made to the exemplary illustration of FIG. 1 showing an exemplary constituent monomer of a polysaccharide including one repeating structural unit provided by modified D-Glucose. In the illustration of FIG. 1, the polymerizing functional groups are denoted by arrows the label “FG”. The functional group on the right is the hydroxyl group attached to the 6′ carbon and the functional group on the left is the anomeric carbon (1′). The vector drawn from the anomeric carbon to the 6′ hydroxyl is one of two valid characteristic vectors, the other being the vector drawn from the 6′ hydroxyl to the anomeric carbon. Each of those vectors can be considered a characteristic vector, so long as the vectors are chosen for each monomer such that all the characteristic vectors point in a same direction in the polymerized polymer. The magnitude of the characteristic vector is denoted by the length of the line labeled CW. The vector and magnitude can be calculated by examining the coordinates of the atoms in the polymerization functional groups, the coordinates generated either from experimental data or theoretical models, and taking the difference between the x, y, and z coordinates.

In some embodiments, the characteristic vector and the characteristic width of a monomer can be calculated by first obtaining a 3D model of the monomer, drawing a line between the two atoms to which the two adjacent monomer bond, and measuring the length of the line. The 3D model of the monomer can be obtained from experimental data such as an X-ray crystal structure or an NMR structure. Alternatively, the 3D model can be obtained from a theoretical model such as a properly equilibrated structure produced by molecular dynamics simulations. Additional methods to identify the CW of a monomer are identifiable by a skilled person. For example the CW of the natural alpha amino acids is approximately 2.5 Angstroms. The CW of DNA and RNA nucleoside phosphoramidites is approximately 5.0 Angstroms, wherein the term “approximately as used herein indicates a margin of +/−5%),

Additional exemplary monomers comprising one repeating structural unit of the linear polynucleotide, polypeptide and polysaccharides herein described include amino acids that can polymerize to form proteins, or nucleotides that can polymerize to form nucleic acids such as DNA and RNA, or monosaccharide such as glucose that can polymerize to form polysaccharide such as cellulose.

In some embodiments, monomers can be formed by oligomers comprising a plurality of structural repeating unit of the linear polymer to be synthesized each presenting polymerizing functional groups that are able to covalently couple with other same or different monomeric unit including a same or other oligomer to form polymer molecules.

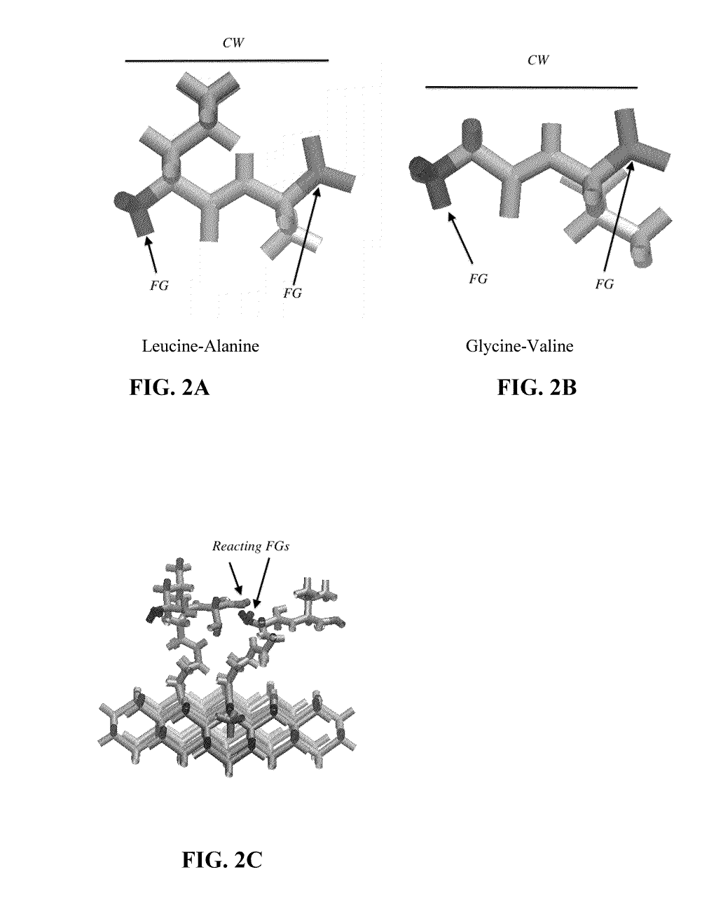

Reference is made to the illustration of FIG. 2 showing an exemplary monomer formed by a constituent oligomer of a polypeptides formed by a Leucine-Alanine bipeptide. In particular, FIG. 2A shows the Leucine-Alanine bipeptide, where the N-terminus (nitrogen) is on the left and denoted by the arrow and label “FG” for functional group, and the C-terminus (carboxyl group) is on the right and also denoted by an arrow and label “FG” for functional group. The characteristic vector is the vector drawn between the nitrogen and the carbonyl carbon of the carboxyl group, and the magnitude is denoted by the length of the line with the label “CW” for characteristic width. FIG. 2B is the second bipeptide, Glycine-Valine. The N and C termini are again denoted with arrows and the label “FG” and the characteristic vector is again drawn between the nitrogen and the carbonyl carbon of the carboxyl group, the magnitude denoted by the length of the line labeled “CW” for characteristic width. FIG. 2C shows both bipeptide monomers attached to a Si 100 surface via a linker, and positioned such that the C-terminus of the first bipeptide is within the proximity of the N-terminus of the second bi-peptide, the condition required for reaction of the two to for a tetrapeptide.

Additional exemplary monomers comprising a plurality of repeating structural unit of the linear polynucleotide, polypeptide and polysaccharides herein described include tetrapeptide that can polymerize to form proteins, or oligonucleotides (e.g. of 5 or 10 residues) that can polymerize to form nucleic acids such as DNA and RNA, or disaccharides such as maltose, and cellobiose, that can polymerize to form polysaccharide such as starch or cellulose as well as lactose and sucrose.

In some embodiments the monomers of the polynucleotide, polypeptide and/or polysaccharides herein described are rigid. In some embodiments the monomers of the polynucleotide, polypeptide and/or polysaccharides herein described are flexible. The term “rigid” refers to a monomer in which the characteristic width remains approximately constant at room temperature and pressure within a margin of error identifiable to a skilled person in the art. Examples of rigid monomers are amino acids, nucleotides and monosaccharides.

The term “flexible” in connection with a monomer indicates a monomer in which the characteristic width varies of at least ±5% at room temperature and pressure within a margin of error identifiable to a skilled person in the art. Examples of flexible monomers are oligomers such as a polypeptide consisting of 10 or more amino acids. In flexible monomers determination of the CW can be made taking into account the potential width when the monomer when stretched out linearly. In flexible monomers where no experimental structures are available to present the monomer stretched out linearly, use of theoretical techniques for calculation of the CW is preferable.

In some embodiments, the polymer to be synthesized with a surface synthesis process herein described is formed by of a same repeating structural units which can be polymerized with constituent monomers of a same or different type, and the polymer formed is a homopolymer. In some embodiments the polymer synthesized with a surface synthesis process herein described is formed by different repeating structural units which can be polymerized with constituent monomers of a same or different type, and the polymer formed is a heteropolymer.

In embodiments herein described, the different types of monomers forming a polymer to be synthesized are first attached to monomer binding regions of a coated surface.

The term “attach” or “attachment” as used herein, refers to connecting or uniting by a bond, link, force or tie in order to keep two or more components together, which encompasses either direct or indirect attachment such that, for example, a first compound is directly bound to a second compound or material, and the embodiments wherein one or more intermediate compounds, and in particular molecules, are disposed between the first compound and the second compound or material.

In particular, in some embodiments, the monomer can be attached to the surface through covalent binding of a surface linking functional group of the monomer with a corresponding anchor functional group presented at an attachment site of the monomer binding regions of the coated surface.

In particular, in embodiments herein described monomers of a same type of constituent monomer of the linear polymer are directly or indirectly attached to attachment sites of a corresponding set of monomer binding regions on the coated surface through covalent binding of the surface linking functional groups of the monomers with corresponding anchor functional groups on the attachment sites of the corresponding set of monomer binding regions.

In embodiments herein described corresponding monomer binding regions for all type of monomers contained in the polymer, form on the coated surface a plurality of monomer binding regions each having an attachment site located at a distance MBD with respect to an attachment side of an adjacent monomer binding region such that

$$M B D ≅ \frac{C Wem + C Wam}{2} \qquad ( 1 )$$

in which CWem is a characteristic width of a monomer bound to the each monomer binding region and CWam is a characteristic width of a monomer bound to the adjacent monomer binding region,

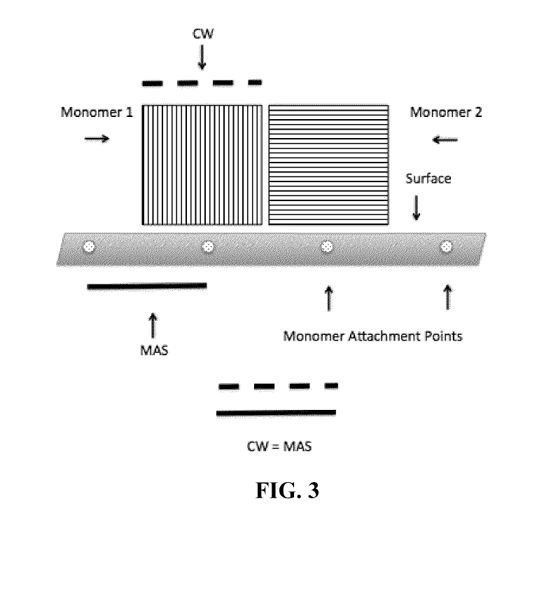

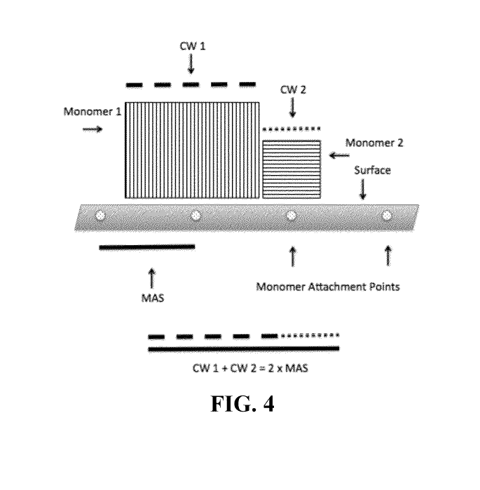

Reference is made in this connection to the schematic illustration of FIG. 3, where adjacent monomer 1 and monomer 2 are schematically illustrated in connection with the surface to which they are attached on attachment sites located approximately at the center of the respective monomer. In the schematic illustration of FIG. 3 the characteristic width is approximately bisected, that is, half of the characteristic vector is projecting toward the adjacent monomer on the right and the other half to the adjacent monomer on the left (FIG. 3). As illustrated in the schematics of FIG. 3 in methods and systems herein described two monomers of equal characteristic width contribute when bound approximately half of their characteristic width to meet at the center according to equation 1, so the total “reach” of both monomers is one characteristic width. The same equation applies to scenarios where the monomers have different characteristic width as illustrated in FIG. 4 where the distance between the attachment sites on the surface is equal to (CW1+CW2)/2 in accordance with equation 1 as will be understood by a skilled person.

In embodiments herein described, in order to allow attachment between adjacent monomers during the surface mediated synthesis in accordance with equation (1), selection of the surface shall be performed taking into account the minimum allowable spacing for the surface.

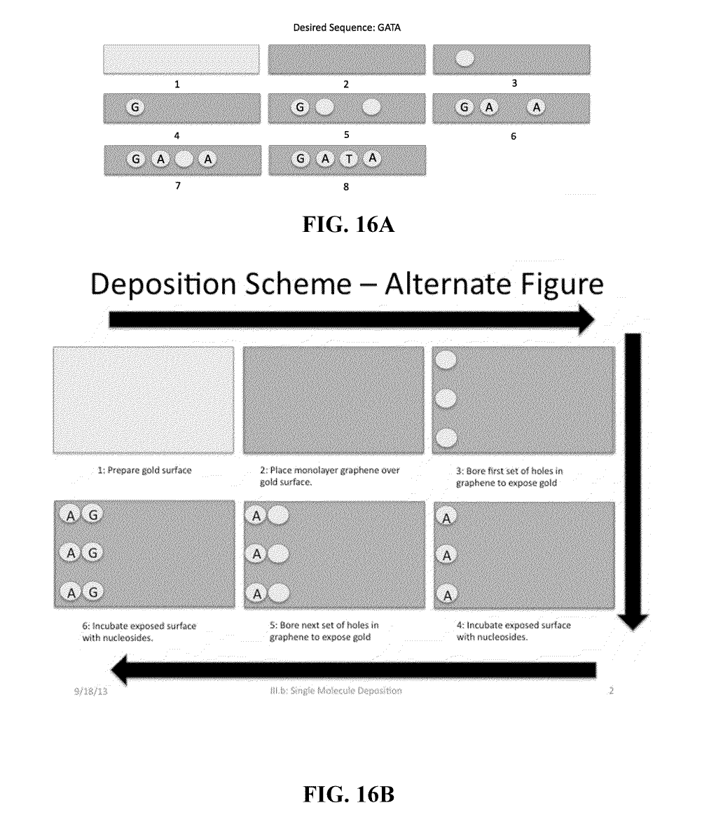

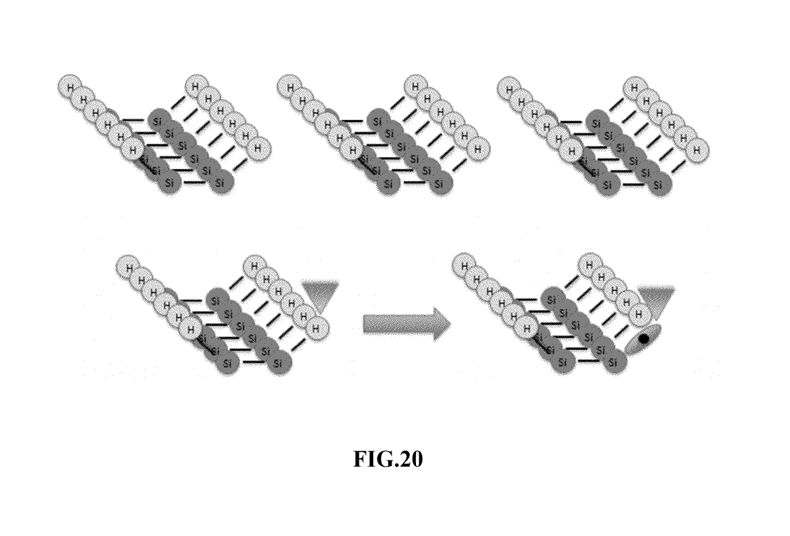

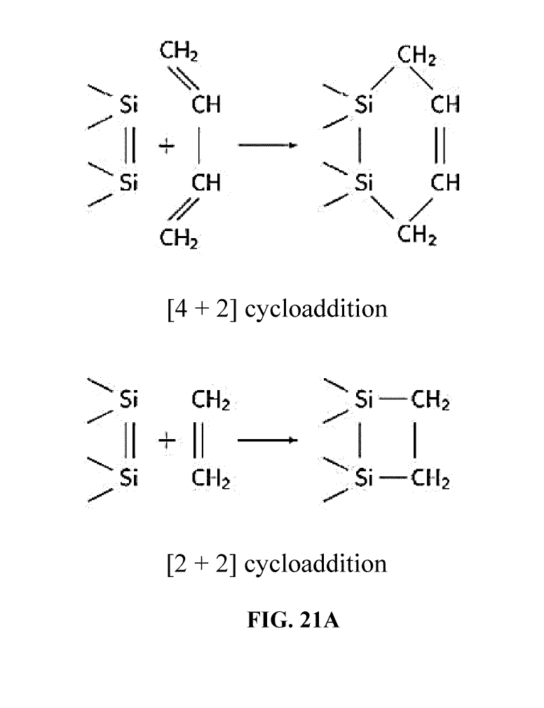

The term “minimum allowable spacing” (MAS) of a surface refers to the smallest distance between attachment points achievable on the surface. This limit can be set by both structural constraints due to the substrate material and/or the configuration of the surface, such as the crystal structure of a surface, and the resolution of techniques used to prepare the attachment sites on the surface. Accordingly, to determine the MAS, the first consideration is the means by which the monomer will attach to the surface. For example, in the Silicon (100) system, a monomer can bind at each dimer pair, which is separated at 3.8 Angstroms along a dimer row [1]. This limit is set by the structure of the Silicon crystal itself and the nature of coupling, and can be determined by consulting scientific databases and academic papers in which these parameters are elucidated, or by determining the structure of the surface through appropriate techniques like crystallography and scanning tunneling microscopy. A second consideration is limitations imposed by the process for creating the monomer binding region on the surface in accordance with the present disclosure (see e.g. illustration of FIGS. 16 and 20 and related portions of the specification). For example for Self Assembled Monolayers of n-alkanethiols on the gold surface, for example, adsorbate molecules are typically separated at spacings of about 5 Angstroms. For example the placement of pores in a graphene mask used to pattern deposition, however, is limited in accuracy to about a nanometer due to the limitations of TEM sculpting [2]. Thus, the MAS for the gold graphene system would have an MAS of ˜1 nm despite the 5 Angstrom spacing of SAMs on gold without the mask. In other masks limitations in making holes/pores can be due to electronics (piezoelectrics typically can be preferred), and the effect of thermal drift on the accuracy of an instrument according to variables which will be understood by a skilled person.

In embodiments herein described, selection of the surface for synthesis of a certain polymer is performed to ensure that the MBD for attachment of all types of monomers of the polymers of the surface is approximately (herein also ≅, i.e. within a margin of +/−5%), equal to or greater than a minimum allowable spacing of the surface where attachment is to be performed.

Accordingly in view of equation 1, in embodiments herein described where the monomers polymerized have approximately a same characteristic width the characteristic width of the monomers can be equal to the minimum allowable spacing as shown in the schematic illustration of FIG. 3. For example. DNA, RNA, and peptide monomers and oligomers with a same number of monomers have the same structure and so have the same CW. Many oligosaccharides also have a same CW as the monomers are all made of n-membered rings (with n=5,6,7, etc.). For the case of DNA, the CW for each nucleotide monomer is ˜5 Angstroms, so the MBD=(5+5)/2=5 Angstroms. As the Silicon 100 surface has dimer pairs spaced at 3.8 Angstroms, for adjacent DNA nucleotide monomers the MBD>=MAS.

In some embodiments the characteristic width of single monomers can be smaller or larger than the MAS of the coated surface (see schematics of FIG. 4). In those embodiments a combination of monomers shall be selected so that the MAS is approximately equal or smaller than the MBD for each pair of adjacent monomers in accordance the above indication as will be understood by a skilled person.

For example, the characteristic width of a single amino acid is approximately 2.5 Å, much less than the minimum allowable spacing of the Si (100) surface, which is about 3.8 Å. A dipeptide consisting of two amino acids can be used as a constituent monomer instead, which has a characteristic width of approximately 6 Å and satisfies the minimal allowable spacing requirement of the Si (100) surface. Example 25 describes a surface mediated synthesis of a peptide on the Si (100) surface using bipeptides as constituent monomers.

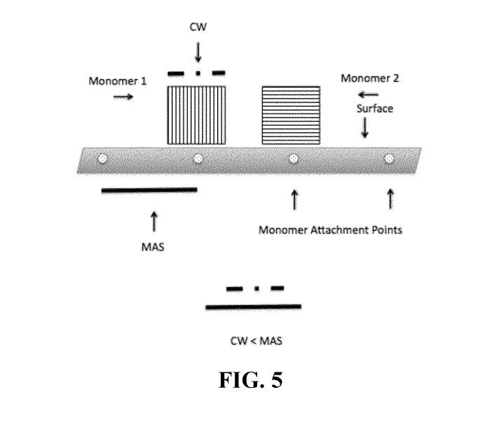

In embodiments where the characteristic width of the monomers is less than the minimum allowable spacing of the surface (FIG. 5), polymerizing functional groups can still react with each other if the monomer can provide a compensatory movement to place the corresponding polymerizing functional groups of a pair of monomers close enough in order for the coupling reaction between the corresponding polymerizing functional groups to take place. In some of those embodiments the monomer is formed by a flexible monomer allowing positioning of the corresponding functional groups under appropriate thermodynamic conditions. In some of those embodiments the monomer is attached to the surface through a flexible linker. In those embodiments calculation of the compensatory movement and positioning in view of the reaction conditions and the features of the linker will have to be performed to identify the features allowing the propoper positioning of the polymerizing functional groups as will be understood by a skilled person.

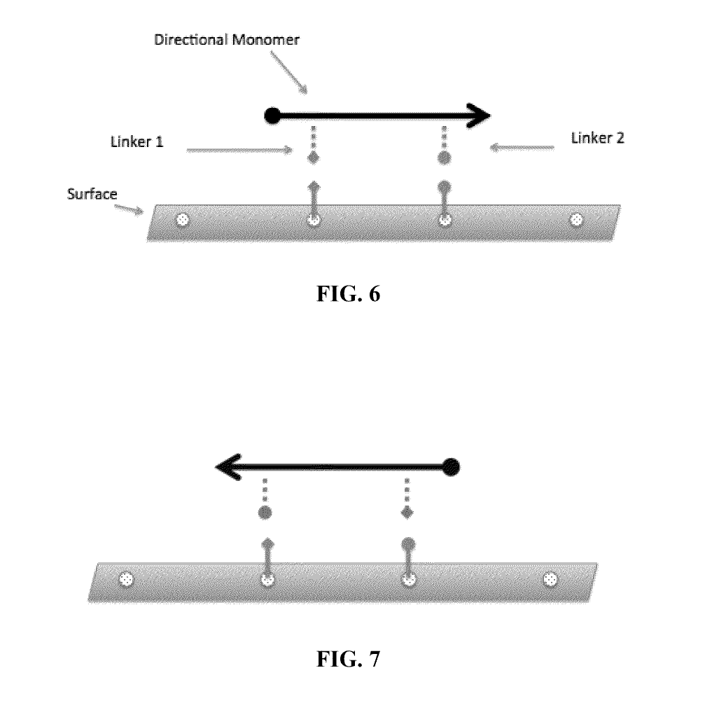

In some embodiments, the characteristic width can be greater than the MAS and the related monomer can be attached to two or more attachments sites in the corresponding monomer binding region on the surface. In those embodiments, the MBD is typically greater than or equal to twice the MAS of the coated surface. Reference is made to the schematic illustration of FIG. 6 and FIG. 7 showing a monomer a directional monomer attached through multiple attachment sites. In some of those embodiments when the characteristic width is greater than the minimum allowable spacing, the monomer can, in some cases, reorient to accommodate possible steric interactions between two adjacent monomers. An exemplary monomer according to the schematics of FIG. 6 and FIG. 7 is a tripeptide through two linkers. The CW of the tripeptide is 9.7 Angstroms, so the MBD of a homopolymer made of this tripeptide would be MBS=(9.7+9.7))/2=9.7 Angstroms. This MBD is not only greater than the MAS of the Si 100 surface using the dimer pairs (3.8 Angstroms), it is greater than twice the MAS (2*3.8=7.6 Angstroms), so it is feasible to use two linkers to anchor the monomer to the surface.

In some instances, two adjacent attachments sites on the surface can be spaced apart by a distance that is multiples of the minimum allowable spacing of the surface. In such instances, the characteristic width of the monomers is preferred to be equal to or possibly greater than the distance between these two adjacent attachments sites. These embodiments are exemplified in both the previous example with the tripeptide in which adjacent monomers are spaced at 2*MAS. Again, the MBD=(9.7+9.7)/2=9.7 which is greater than 2*MAS=2*3.8=7.6.

In some embodiments, the monomer is attached to the surface through direct binding of a surface linking functional group of the monomer to an anchor functional group presented on the attachment site of the coated surface. In some embodiments one or both of the surface linking group and the anchor groups can be presented for attachment on a linker herein indicated as attachment linker or primary linker.

A “linker” as used herein is an organic moiety formed by carbon atoms alone or in combination with other elements covalently linked to form a structure having two terminus each terminus either presenting a functional group or being covalently linked to one of the surface or the monomer. The structure of a linker herein described can be formed by one or more linear or cyclic units and is chemically stable with respect to the chemistry of the functional group and of the reactions between functional groups. Linker can be used to provide attachment of certain monomer to a surface, provide stability to an attached monomer, control orientation of an attached monomer and/or minimize conformational changes of an attached monomer.

Exemplary linkers are formed by substituted or unsubstituted alkane, substituted or unsubstituted alkene, conjugated or unconjugated polyene, polyyne, substituted or unsubstituted polyalkene, poylalkyne, substituted or unsubstituted heteroalkane, monocyclic alkane, polycyclic alkane, substituted or unsubstituted arene, substituted or unsubstituted heteroarene, ethylene, cyclohexane, benzene, naphthalene, spiroalkane, heterospiroalkane, polyalkoxy, ethyleneglycol, polyethyleneglycol, and other moiety comprising most of the aromatic chain and aliphatic groups as will be understood by a skilled person.

A linker in the sense of the disclosure when not attached can independently present at its two terminus functional groups thus providing a functionalized linker in the sense of the disclosure. Various functional groups herein described can be used in connection to linkers to provide functionalized linkers of the disclosure. Exemplary functional groups comprise thiol, hydroxy, carboxylic acid amine and additional functional group identifiable by a skilled person. For example, exemplary functionalized linkers presenting a thiol group comprise Thiol Linkers to Gold Surface, 3-Chloro-1-propanethiol, 3-Mercaptopropionic acid, 16-Mercaptohexadecanoic acid, 6-Mercaptohexanoic acid, 4-Mercaptobenzoic acid, 12-Mercaptododecanoic acid NHS ester, 6-Mercapto-1-hexanol, 4-Mercapto-1-butanol, 11-Amino-1-undecanethiol hydrochloride, 11-Azido-1-undecanethiol, Olefin Linkers to Activated Silicon Surface.

In attachment linkers used for attaching the monomer to the surface, functional groups presented at the terminus are typically a surface linking functional group (SLFG) an anchor functional group (AFG) and a linker functional group (herein also linking functional group or LFG) capable of binding corresponding functional groups on the surface or the monomer.

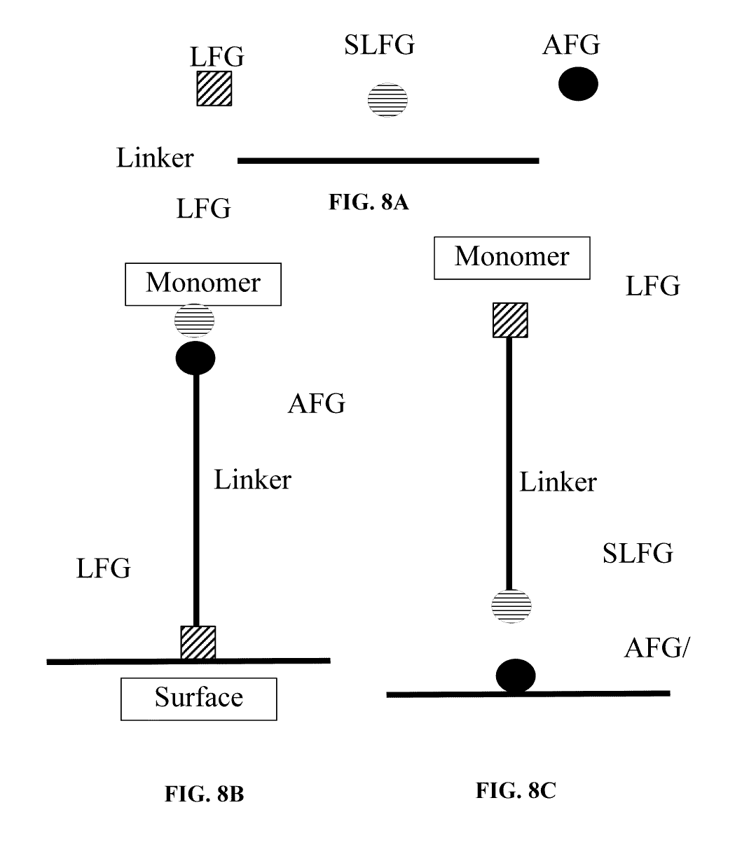

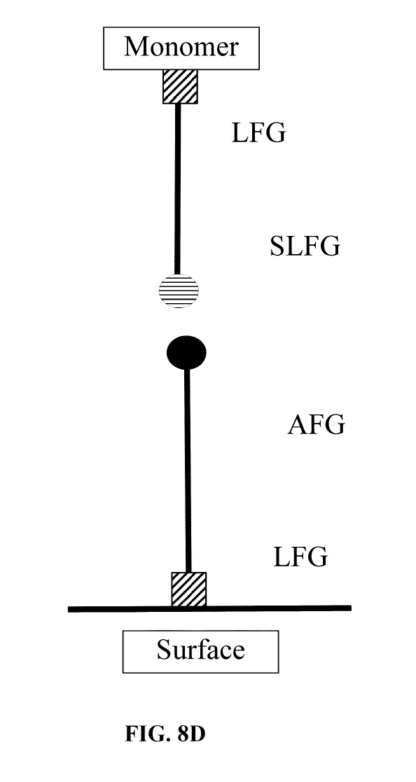

Reference is made to the schematic illustration of FIG. 8A to 8D illustrating various configuration of the functional groups SLFD, AFG and LFG on attachment linkers herein described. The primary linkers in the schematic configurations of FIGS. 8A to 8D can be used in the attachment of the monomer to the surface at respective attachment points in various configurations as will be understood by a skilled person.

In those embodiments the LFG forms one or more bonds with the monomer in such a way that loss of chemical reactivity between corresponding polymerizing functional groups of the monomers is minimized. In particular, in embodiments herein described a linker is typically selected to be orthogonal to the polymerizing functional groups of the monomer or other portions of the monomer, to minimize reactions that can lead to reduced reactivity of the moiety by adding or withdrawing electronic density or by steric blocking or through the chemistry of the linkage.

In some embodiments the linker is formed by a flexible linker. The term “flexible” when referred to a linker indicates a linker in which the position of the terminus varies of at least ±5% at room temperature and pressure within a margin of error identifiable to a skilled person in the art. A flexible linker (herein also FSL) is selected for attachment of corresponding functional groups with a length that allows the attached monomer to align its characteristic vector in a direction parallel with the direction of polymerization but minimize reaction of a monomer attached at a non-adjacent attachment site.

The linker is typically selected to have a structure that minimizes interference with polymerization chemistry, wherein the interference can be performed e.g. by either by sterically blocking reactive moieties or by altering the reactivity of those moieties. A monomer for surface mediated synthesis can be functionalized with a linker and in particular with an FSL to facilitate attachment to the surface and/or allow proper orientation of the monomer on the surface. In some embodiments, this linker can also allow the monomer to be centered above the attachment site such that the critical width is bisected by the attachment site. In several embodiments linkers can be typically formed by n-alkane chains, where n describes the number of sp3 hybridized carbon atoms in the chain. The chain can be interspersed with non-carbon atoms such as nitrogen and oxygen. The linker can have rigid components, so long as the terminal portion is flexible and short to allow for interaction with adjacent monomers and proper orientation. This arrangement allows for benzenes, acetylenes, fullerenes, cage molecules, and other rigid groups to be components of the linker.

Linkers can be categorized into linkers containing particular atoms, aromatic, flexible, rigid, cleavable, and non-cleavable based on the chemical properties of the organic moiety forming the structure. Examples of linkers include functionalized n-alkane thiols (flexible, non-cleavable), functionalized adamantane thiols (rigid), the Merrifield Chloromethyl linker (aromatic and cleavable), the trityl linker (aromatic), silyl ethers (containing particular atoms). In embodiments herein described linkers are typically selected to be orthogonal one with respect to others and to functional groups and moieties presented on the linker, the monomers and/or the surface

The term orthogonal or chemically orthogonal as used herein with reference to linkers, functional groups materials surface and other items indicates two items that do not chemically interfere with each other. Exemplary orthogonal items comprise For example, Fmoc, Dde, t-Boc and MeNPOC are orthogonal to each other. Fmoc is readily removed by a piperidine solution to which Dde, t-Boc and MeNPOC are stable. t-Boc is deprotected by a trifluoracetic acid solution to which Fmoc, Dde, and MeNPOC are stable. Dde is removed by a hydrazine solution to which Fmoc, t-Boc and MeNPOC are stable. MeNPOC is labile to visible light to which Fmoc, Dde and t-Boc are stable.

In some embodiments, monomers are attached to the surface through linkers according to any of the configuration illustrated in FIGS. 8A to 8D. Attachment through linkers can be performed in various embodiments including for examples embodiments where the conditions required for binding of a monomer to the surface do not allow correct positioning of the monomer (e.g. in view of the respective CW and MAS and/or in view of the rigidity and/or chemical properties of the nature and/or the surface). In other embodiments, linkers can be used to minimize any chemical interference that can occur when the monomers are directly attached to the surface.

In embodiments herein described, the different types of monomers forming a polymer to be synthesized are attached to a surface in an orientation allowing formation, under suitable conditions, of covalent bonds one with another. In particular in embodiments herein described so that polymerizing functional group of each monomer can come within a bond length ±50% with respect to a corresponding polymerizing functional group of an adjacent monomer.

The term “bond length” indicates the distance between the centers of two covalently bonded atoms. The length of the bond is determined by the number of bonded electrons (the bond order). The higher the bond order, the stronger the pull between the two atoms and the shorter the bond length. Generally, the length of the bond between two atoms is approximately the sum of the covalent radii of the two atoms. Bond length is reported in picometers. Therefore, bond length increases in the following order: triple bond<double bond<single bond. Bond length between atoms of neighboring monomers can be identified with methods identifiable by a skilled person. For example to find the bond length, one can make reference to charts such as the one reported in the following Table 1 to identify the radius of the atoms of the two neighboring monomers involved in the binding.

TABLE 1

Covalent radii

| | | Single | Single | Double | Triple |
|---|---|---|---|---|---|
| | | Bonds | Bonds | Bonds | Bonds |
| Number | Element | [1] | [2] | [2] | [2] |
| 1 | H | 31 | 32 | | |
| 2 | He | 28 | 46 | | |
| 3 | Li | 128 | 133 | 124 | |
| 4 | Be | 96 | 102 | 90 | 85 |
| 5 | B | 84 | 85 | 78 | 73 |
| 6 | C | 76 | 75 | 67 | 60 |
| 7 | N | 71 | 71 | 60 | 54 |
| 8 | O | 66 | 63 | 57 | 53 |
| 9 | F | 57 | 64 | 59 | 53 |
| 10 | Ne | 58 | 67 | 96 | |
| 11 | Na | 166 | 155 | 160 | |
| 12 | Mg | 141 | 139 | 132 | 127 |
| 13 | Al | 121 | 126 | 113 | 111 |
| 14 | Si | 111 | 116 | 107 | 102 |
| 15 | P | 107 | 111 | 102 | 94 |
| 16 | S | 105 | 103 | 94 | 95 |
| 17 | Cl | 102 | 99 | 95 | 93 |
| 18 | Ar | 106 | 96 | 107 | 96 |
| 19 | K | 203 | 196 | 193 | |
| 20 | Ca | 176 | 171 | 147 | 133 |
| 21 | Sc | 170 | 148 | 116 | 114 |
| 22 | Ti | 160 | 136 | 117 | 108 |
| 23 | V | 153 | 134 | 112 | 106 |
| 24 | Cr | 139 | 122 | 111 | 103 |
| 25 | Mn | 150 | 119 | 105 | 103 |
| 26 | Fe | 142 | 116 | 109 | 102 |
| 27 | Co | 138 | 111 | 103 | 96 |
| 28 | Ni | 124 | 110 | 101 | 101 |
| 29 | Cu | 132 | 112 | 115 | 120 |
| 30 | Zn | 122 | 118 | 120 | |
| 31 | Ga | 122 | 124 | 117 | 121 |
| 32 | Ge | 120 | 121 | 111 | 114 |
| 33 | As | 119 | 121 | 114 | 106 |
| 34 | Se | 120 | 116 | 107 | 107 |
| 35 | Br | 120 | 114 | 109 | 110 |
| 36 | Kr | 116 | 117 | 121 | 108 |
| 37 | Rb | 220 | 210 | 202 | |
| 38 | Sr | 195 | 185 | 157 | 139 |
| 39 | Y | 190 | 163 | 130 | 124 |
| 40 | Zr | 175 | 154 | 127 | 121 |
| 41 | Nb | 164 | 147 | 125 | 116 |
| 42 | Mo | 154 | 138 | 121 | 113 |
| 43 | Tc | 147 | 128 | 120 | 110 |
| 44 | Ru | 146 | 125 | 114 | 103 |
| 45 | Rh | 142 | 125 | 110 | 106 |
| 46 | Pd | 139 | 120 | 117 | 112 |
| 47 | Ag | 145 | 128 | 139 | 137 |
| 48 | Cd | 144 | 136 | 144 | |
| 49 | In | 142 | 142 | 136 | 146 |
| 50 | Sn | 139 | 140 | 130 | 132 |
| 51 | Sb | 139 | 140 | 133 | 127 |
| 52 | Te | 138 | 136 | 128 | 121 |
| 53 | I | 139 | 133 | 129 | 125 |
| 54 | Xe | 140 | 131 | 135 | 122 |
| 55 | Cs | 244 | 232 | 209 | |
| 56 | Ba | 215 | 196 | 161 | 149 |
| 57 | La | 207 | 180 | 139 | 139 |
| 58 | Ce | 204 | 163 | 137 | 131 |
| 59 | Pr | 203 | 176 | 138 | 128 |
| 60 | Nd | 201 | 174 | 137 | |
| 61 | Pm | 199 | 173 | 135 | |
| 62 | Sm | 198 | 172 | 134 | |
| 63 | Eu | 198 | 168 | 134 | |
| 64 | Gd | 196 | 169 | 135 | 132 |
| 65 | Tb | 194 | 168 | 135 | |
| 66 | Dy | 192 | 167 | 133 | |
| 67 | Ho | 192 | 166 | 133 | |
| 68 | Er | 189 | 165 | 133 | |
| 69 | Tm | 190 | 164 | 131 | |
| 70 | Yb | 187 | 170 | 129 | |
| 71 | Lu | 187 | 162 | 131 | 131 |
| 72 | Hf | 175 | 152 | 128 | 122 |
| 73 | Ta | 170 | 146 | 126 | 119 |
| 74 | W | 162 | 137 | 120 | 115 |
| 75 | Re | 151 | 131 | 119 | 110 |
| 76 | Os | 144 | 129 | 116 | 109 |
| 77 | Ir | 141 | 122 | 115 | 107 |
| 78 | Pt | 136 | 123 | 112 | 110 |
| 79 | Au | 136 | 124 | 121 | 123 |
| 80 | Hg | 132 | 133 | 142 | |
| 81 | Tl | 145 | 144 | 142 | 150 |
| 82 | Pb | 146 | 144 | 135 | 137 |
| 83 | Bi | 148 | 151 | 141 | 135 |
| 84 | Po | 140 | 145 | 135 | 129 |
| 85 | At | 150 | 147 | 138 | 138 |
| 86 | Rn | 150 | 142 | 145 | 133 |
| 87 | Fr | 260 | 223 | 218 | |
| 88 | Ra | 221 | 201 | 173 | 159 |
| 89 | Ac | 215 | 186 | 153 | 140 |
| 90 | Th | 206 | 175 | 143 | 136 |
| 91 | Pa | 200 | 169 | 138 | 129 |
| 92 | U | 196 | 170 | 134 | 118 |
| 93 | Np | 190 | 171 | 136 | 116 |
| 94 | Pu | 187 | 172 | 135 | |
| 95 | Am | 180 | 166 | 135 | |
| 96 | Cm | 169 | 166 | 136 | |
| 97 | Bk | | 168 | 139 | |
| 98 | Cf | | 168 | 140 | |
| 99 | Es | | 165 | 140 | |
| 100 | Fm | | 167 | | |
| 101 | Md | | 173 | 139 | |
| 102 | No | | 176 | 159 | |
| 103 | Lr | | 161 | 141 | |
| 104 | Rf | | 157 | 140 | 131 |
| 105 | Db | | 149 | 136 | 126 |
| 106 | Sg | | 143 | 128 | 121 |
| 107 | Bh | | 141 | 128 | 119 |
| 108 | Hs | | 134 | 125 | 118 |
| 109 | Mt | | 129 | 125 | 113 |
| 110 | Ds | | 128 | 116 | 112 |
| 111 | Rg | | 121 | 116 | 118 |
| 112 | Cn | | 122 | 137 | 130 |
| 113 | Uut | | 136 | | |
| 114 | Uuq | | 143 | | |
| 115 | Uup | | 162 | | |
| 116 | Uuh | | 175 | | |
| 117 | Uus | | 165 | | |
| 118 | Uuo | | 157 | | |

One can then calculate the sum of the two radii of the atoms involved in the covalent bond to find the bond length as will be understood by a skilled person.

Positioning of monomers resulting in presentation of corresponding polymerizing functional groups at bond length ±50% one with respect to the other can be verified with techniques known or identifiable by a skilled person upon reading of the instant disclosure. An exemplary approach to verify orientation of monomers attached to a surface comprise preparing an atomic model of the surface, the anchor (if applicable), the linker (if applicable), and the monomer. These models can come from experimental data such as X-ray Crystallography and NMR, or theoretical calculations. The relationship of each monomer to each of its adjacent monomers is be considered in turn. Each monomer is be attached to the surface using the intended chemistry. Once attached, the conformations of the entire model (both monomers, the linker, the anchor, and the surface) which place the reactive moieties of both monomers within a bond length of one another, and all other bonds, dihedral angles, torsions, and non-bond interactions are within acceptable limits is determined. “Acceptable limits” can be defined as within 10% of equilibrium values for bonds, angles, and torsions. These equilibrium values can be obtained from molecular dynamic force fields or directly computed with quantum mechanics techniques. For the non-bond interactions, “acceptable limits” can be defined as not being larger than several kT, where k is the Boltzmann constant and T is the temperature at which reactions will be taking place. In this way, a reactive conformation space is determined for each attached monomer pair. The next step is to determine whether there is at least one conformation for each monomer that allows all monomers to react. For monomers with a periodic structure, this process can be done on the smallest periodic unit, where the periodicity is defined as the adjacent reactive moieties being in the same relative position.

Verification of orientation of attached monomers following attachment can also be performed with X-ray and NMR techniques, possible with fluorescent techniques like FRET where FRET pairs are placed on adjacent monomers to determine both proximity and orientation. I don't have better ideas than that at the moment.

Additional features to be considered in determining positioning comprise the ability of the attached monomer to react with the coated surface, orthogonality of the functional groups and monomers with coated part of the surface, location of the attachment site on the surface. Those conditions. Those features can be found based on known information on compatibility of the process with the desired surface, chemistry of the monomers and related functional groups as well as chemistry of the surface. In addition or in the alternative, experiments can be done to determine whether or not the chemical conditions or structures of a certain system create incompatibilities taking also into account reagents for the respective coupling reactions. For example in an approach each monomer, reagent, and combination of monomers and reagents, incubate with the surface for time periods consistent with the reaction item, and then characterize the surface and the reagents to see if significant changes have occurred. The assays can be microscopy, spectroscopy, crystallography, etc. and other techniques known to people skilled in the art. For example DNA polymerization on Si (100) for example, it would be necessary to determine if the nucleoside phosphoramidite monomers bind to the surface non-specifically, or are inactivated in anyway upon exposure to the passivated Si (100) surface. The effects of the tricholoracetic acid (deprotection), tetrazole (phosphoramidite activation), Iodine (oxidation), and acetonitrile (solvent) on Si (100) would be examined. As the linkage of the monomers to the surface would be through the amine and NHS ester, the chemistry of the NHS ester reaction (making the pH slightly basic) will have to be tested both against the Si (100) surface and the nucleoside phosphoramidite monomer for changes in structure or reactive chemistry. Some effects on both the monomers and surface are acceptable so long as they don't change the chemistry, or the changes come after a component has served its purpose. For example, a reagent can be used that alters the structure of Si (100) after the DNA has been polymerized or while the DNA is being removed from the surface.

In embodiments herein described, monomers are formed by molecules that have directionality, such as a DNA monomer with 5′ and 3′ ends, and which require to be positioned at a certain orientation in order for the polymerization to take place in the correct direction. Other examples include peptides (N-Terminus and C-Terminus), some oligosaccharides (cellulose). In some of those embodiments, correct orientation can be obtained by applying an electric field to monomers that have a dipole moment.

In particular some embodiments when each monomer has a similar dipole moment in terms of direction and magnitude, the application of an electric field can be used to orient the monomers along the direction of polymerization. When monomers have negligible or dissimilar dipole moments, the monomers can be functionalized with a molecule to create or modify a dipole moment in each monomer.

The term “direction of polymerization” (DP) refers the vector pointing between the two terminal attachment points in a row, encompassing all attachment points. The direction of polymerization defines the vector along which a single polymer chains forms.

In some embodiments, to orient monomers using an electric field, the dipole moment vector of the monomer is determined using methods such as standard quantum mechanics simulation methods. Next, the relationship between the dipole moment and the characteristic vector is determined, namely, the angle between the two vectors in the 3D space, referred to as a “characteristic angle”. The cosine of the characteristic angle is equal to the dot product of the unit vectors of the characteristic vector and the dipole moment. The dipole moment, and accordingly the electric field to be applied, is oriented in such a way that the characteristic vector is aligned along the direction of polymerization. The dipole moment orientations that satisfy this criterion trace out a cone around the direction of polymerization, the angle of the cone being the characteristic angle. Any orientation of the electric field that aligns with this cone will align the monomer properly. The simplest orientations would be the ones in which the electric field is initially parallel with the direction of polymerization, and then tilted upward or downward at the characteristic angle.

In some of those embodiments, once the characteristic angle has been determined, electrodes are set up surrounding the substrate such that the Electric field is oriented along any one of the vectors enclosed by the cone surrounding the direction of polymerization. In the simplest implementation, this would be done by simply orienting the electrodes such that the vector pointing between them is aligned to any one of the vectors in the cone. The field is typically uniform so as to avoid migration of monomers. The electrodes can be either attached to the substrate itself, or be external and surrounding it. In some instances, the STM tip can be used as one of the electrodes. Typical field strengths to induce orientation will be on the order of 1 V/Angstrom, though better estimates can be determined on a case by case basis through molecular modeling to take into account the barriers to rotation posed by solvent, adjacent monomers, the linkage to the surface, and any Electric field screening effects that can be present.

In addition or in the alternative to use of electric field for orientation, functionalized groups can be used to perform attachment of monomers on the surface so that the attached monomer is in an orientation allowing formation, under suitable conditions, of covalent bonds one with another in a specific orientation.

In particular, in some embodiments binding the monomer to the surface in a particular orientation can be performed through an orienting functional group (OFG) located on the monomer and a corresponding orienting anchor functional group (OAFG) located on the surface.

In some embodiments the orienting functional group (OFG) and orienting anchor functional group (OAFG) can be located at the terminus of linker in functionalized linkers herein indicated as orienting linkers or secondary linkers.

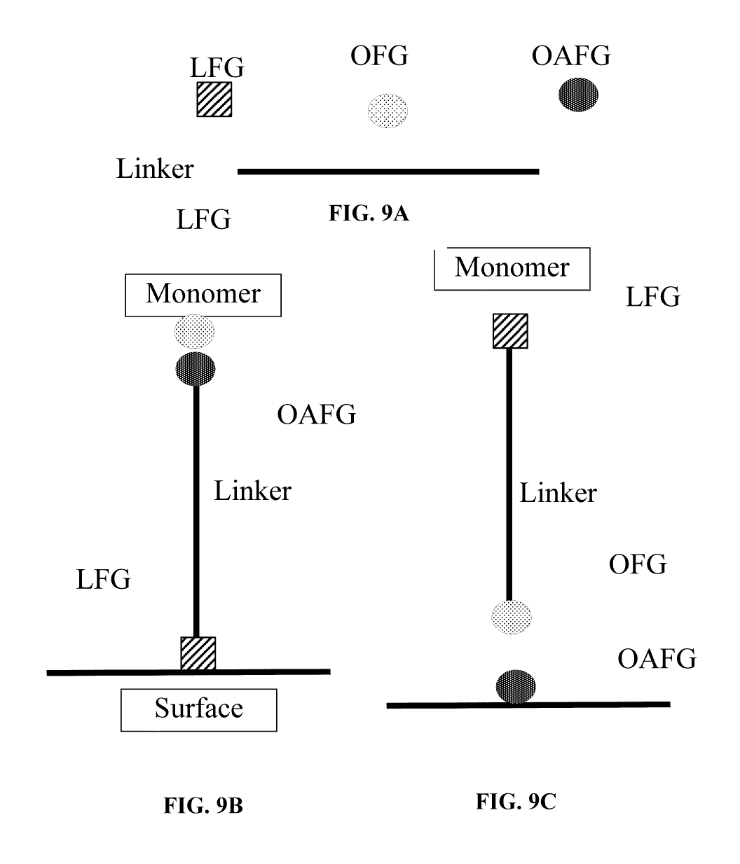

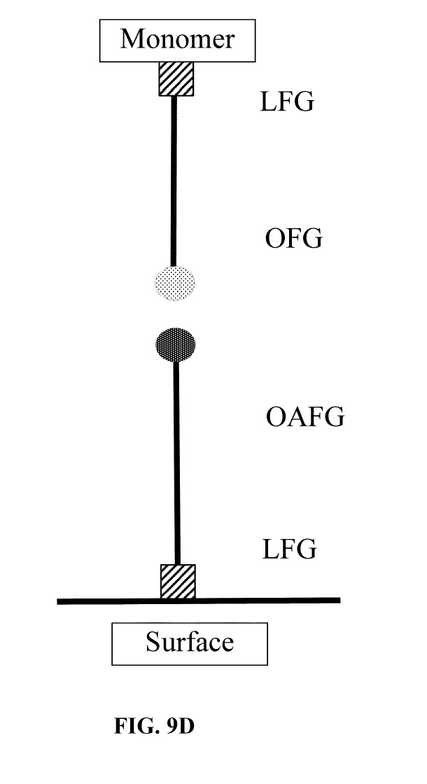

In secondary linkers the functional groups presented at the terminus of the linker are typically an orienting functional group (OFG) capable of binding a corresponding orienting anchor functional groups (OAFG) for the purpose of orienting the monomer and a linker functional group (herein also linking functional group or LFG) capable of binding corresponding functional groups on the surface or the monomer in any of the configuration shown in the schematic illustration of FIG. 9A to 9D.

In some embodiments, orienting linkers can be used in combination with the linker The functionalized linkers in the schematic configurations of FIGS. 9A to 9D can be used as orienting linker in some embodiments of the disclosure.

In particular in some embodiments, attaching the monomers to attachment sites of corresponding monomer binding region can be performed by using a combination of primary (attachment) linkers and secondary (orienting) linkers.

In particular, the attachment linkers can be used to attach the monomer to the corresponding attachment site while the orienting linkers can be used to obtain, “directional” attachment of the monomer. The number and positioning of orienting linkers for deposition and directional attachment will depend on whether or not the monomer is deposited on the surface directly, or if there is an intermediate coupling step and on the attachment of an adjacent monomer.

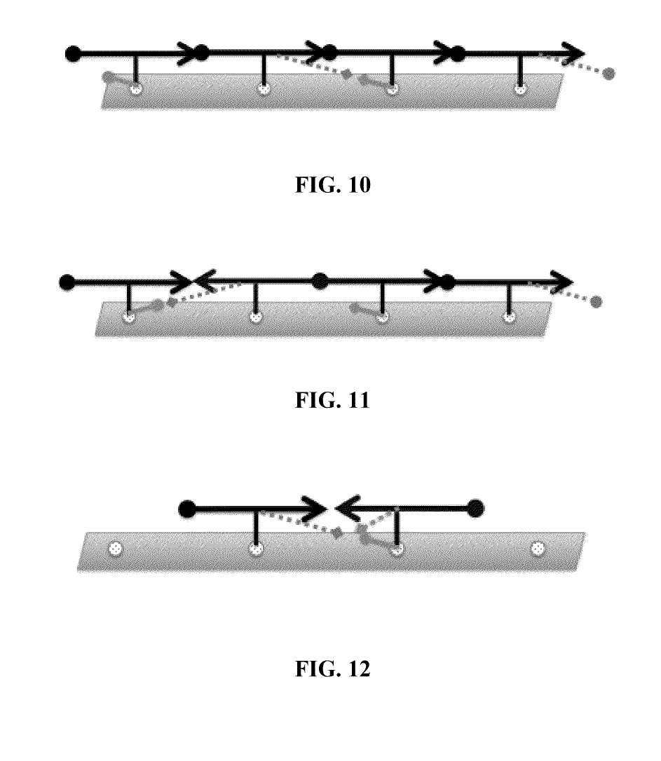

In some embodiments when the monomer spans only one attachment site, the monomer can also be functionalized with a an attachment (primary linker) and an orienting (secondary) chemically orthogonal one with the other, Reference is made to the schematic illustration of FIG. 10 showing a primary linker (solid black line) attaching the monomer to a corresponding attachment site (white circle), and a secondary linker (dashed) attaching the monomer an adjacent attachment site. The binding of the orienting linker orients the monomer in a particular direction (FIG. 10). In FIG. 10, the orienting linker (shown in dotted line) terminated with a orienting functional group (diamond) bonds binds with its corresponding orienting anchor functional group (diamond) presented at an adjacent attachment site. When the orienting functional group presented on the secondary linker reacts with its corresponding orienting anchor functional group on the surface, the monomer is attached in a particular orientation on the surface. In embodiments providing a variation of the schematics of FIG. 10, the orienting functional group and corresponding orienting anchor functional group can be presented directly on the monomer and the surface respectively or on linkers in any of the configuration shown in FIGS. 9A to 9D.

An exemplary application of the schematics of FIG. 10 is provided by the dipeptides already described in FIGS. 2A and 2B, where a second linker is added to the second amino acid at the alpha carbon, bearing chemistry to bind a thiol. The three anchors in this case would be one bearing an amine and a PGA1, and two anchors bearing both an amine and a thiol, both having the same amine protection PGA2 and each having a different and orthogonal thiol protection PGT1 and PGT2. The anchor in this case can be a 1-amino-2-thio-cyclopentene or 1-amino-5-thio-cylcopentene.

The embodiments of FIG. 10 also exemplifies embodiments for polymerization of a directional polymer such as polynucleotides, polypeptide where one monomer of each adjacent pair of monomers needs to be oriented in order to promote polymerization in the correct direction as schematically show in the illustration of FIG. 10 and herein described. In the illustration of FIG. 10 so long as one of the two adjacent monomers presents at bond length only one of the polymerizing functional groups, the adjacent monomers can react ensuring a same direction.

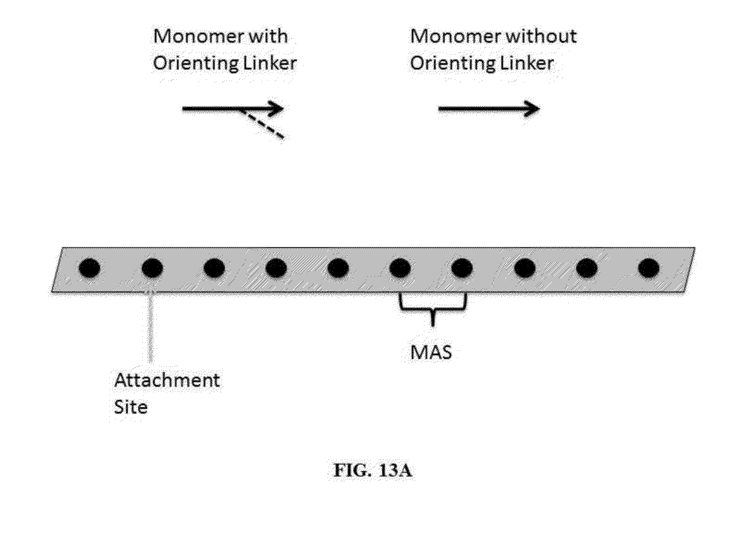

In the illustration of FIG. 10 every other attachment site has a reactive partner for the secondary linker. As such, there is a possibility that the monomer can swivel 180 degrees and interact with the other adjacent monomer, as shown in FIGS. 11 and 12. To minimize the orientation shown in FIG. 11 and FIG. 12, two chemically orthogonal pairs of secondary linkers can be used alternately as shown in FIG. 10. In this case, the linker (dashed line terminated with a diamond) attached to one monomer is incompatible with the reactive pair attached to the attachment site left to the monomer (solid line terminated with a circle), so the two will not react and the monomer will not be fixed in that orientation.

In some embodiments, orienting linkers can be attached to the surface at separate attachment sites with respect to the attachment sites of the monomers

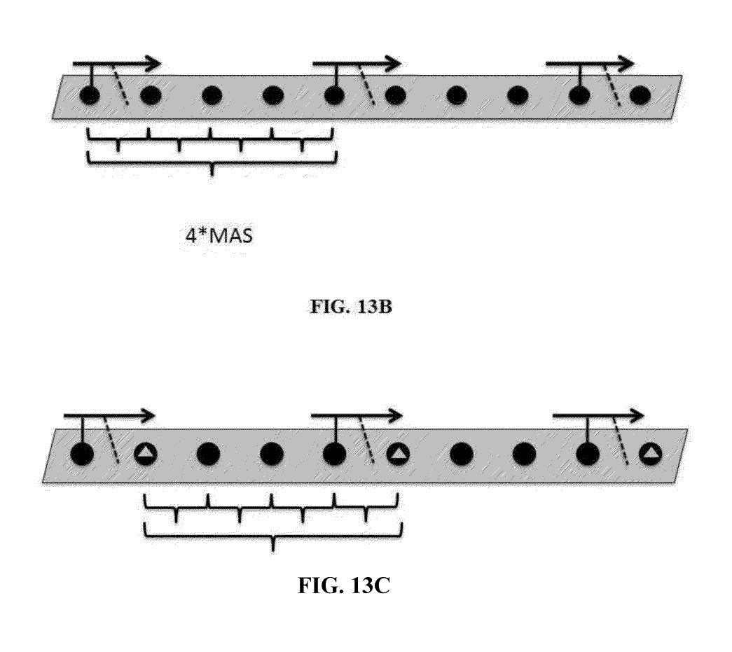

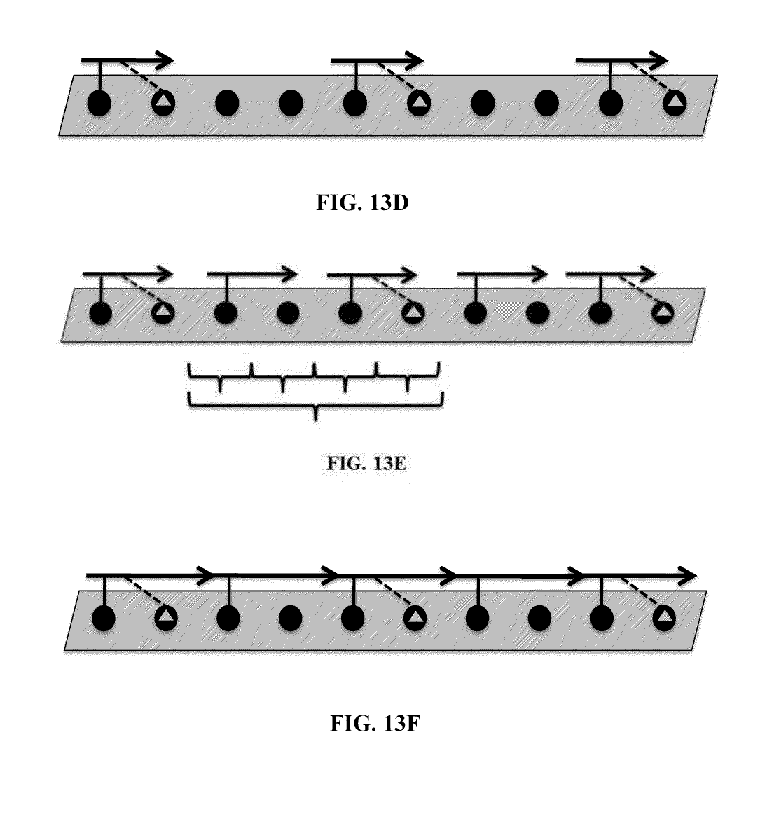

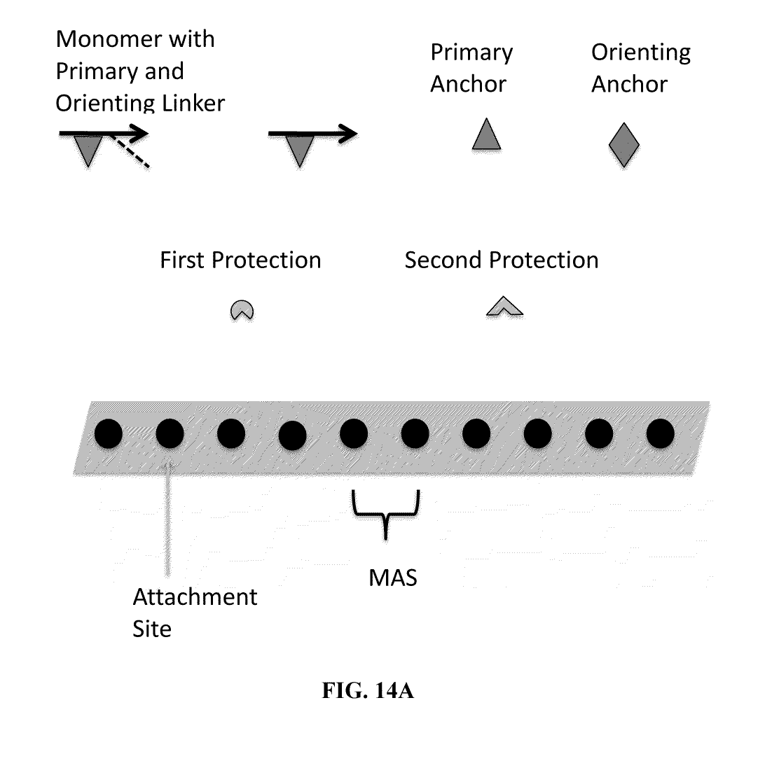

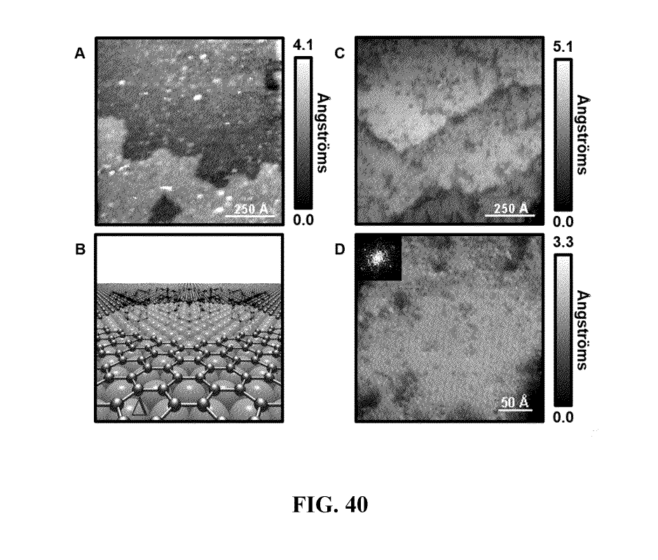

Reference is made to the schematic illustration of FIGS. 13A-13F where an exemplary embodiments showing attachment and orientation for a directional polymer having monomers with a same CW is illustrated. In attaching monomers to a surface according to such approach two separate classes of a same type of monomer are typically used, one presenting the orienting functional group at a terminus of an orienting linker, and one without orienting functional groups (FIG. 13A). The monomer with the orienting linker will be deposited on the surface first such that it is spaced at four times the attachment sites of other monomers with the orienting linker. In the illustration of FIG. 13A where the monomers have a same CW, such distance is approximately equal to 4 times the MBD. In the illustration FIGS. 13A and 13B MBD is equal to MAS and therefore the monomer presenting the orienting linkers are placed at every fourth MAS from the attachment site of the other monomers with the orienting linker (FIG. 13B). This attachment will be followed by the deposition of an orienting anchor functional group corresponding to the orienting functional group on the orienting linker at an attachment site immediately adjacent to every monomer just deposited and presenting the orienting anchor functional group (FIG. 13C). According to this approach, the orienting anchor functional group is consistently to the right or to the left of every monomer. In the schematic illustration of FIG. 13 the orienting anchor functional group is consistently to the right of every monomer. The orienting functional groups on the orienting linkers are then chemically bound by the corresponding orienting anchor functional groups, fixing the orientation of the monomer (FIG. 13D). Finally, the monomers without the orienting linker are deposited, such that each of the monomer without an orienting linker is spaced at 4*MBD, which in the schematics of FIG. 40E is equal to 4*MAS (FIG. 13E). The resulting attached monomers comprise a monomer with an orienting linker and an adjacent monomer without the orienting linker. Once the adjacent monomer without the orienting linker is deposited, polymerization can commence (FIG. 13F). As one monomer of every adjacent pair is fixed in a particular direction, the polymer will be polymerized in a specific direction. In this approach one coupling chemistry can be used to orient one of the adjacent monomers on the surface

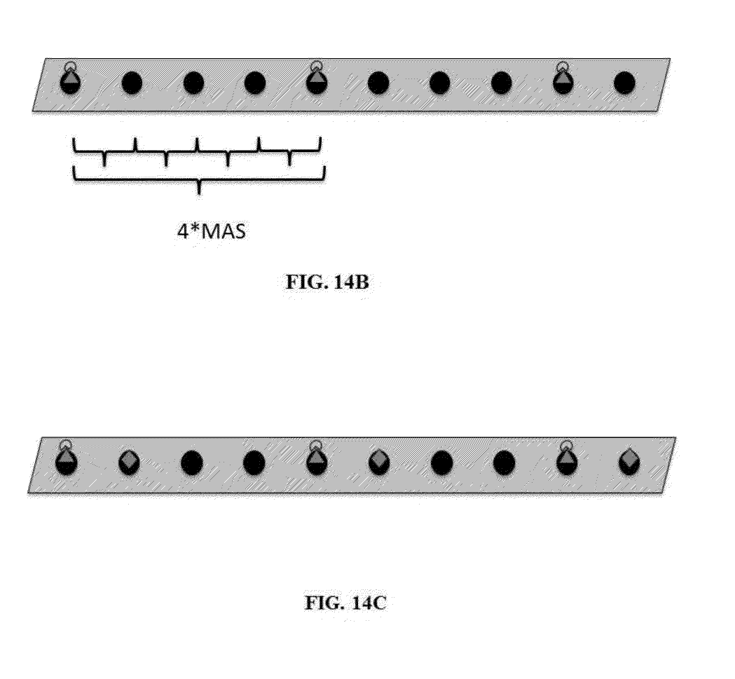

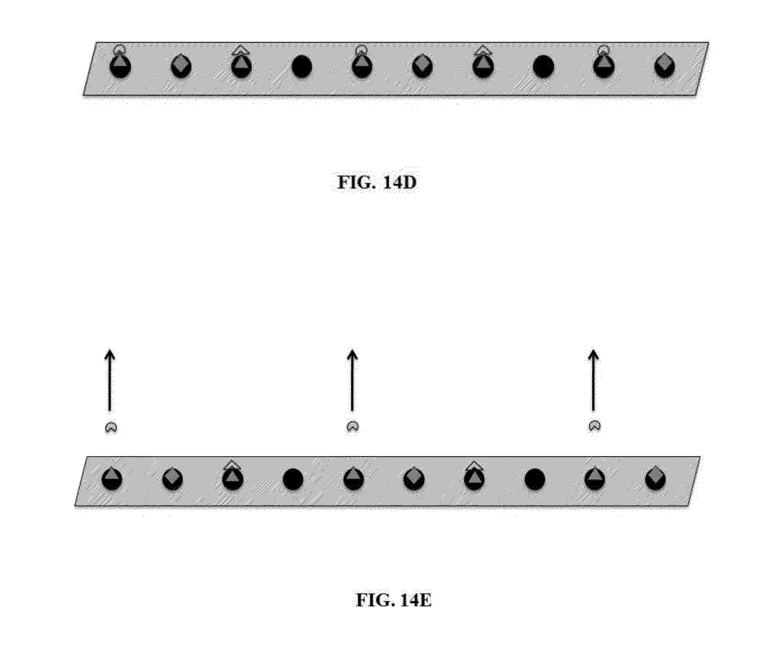

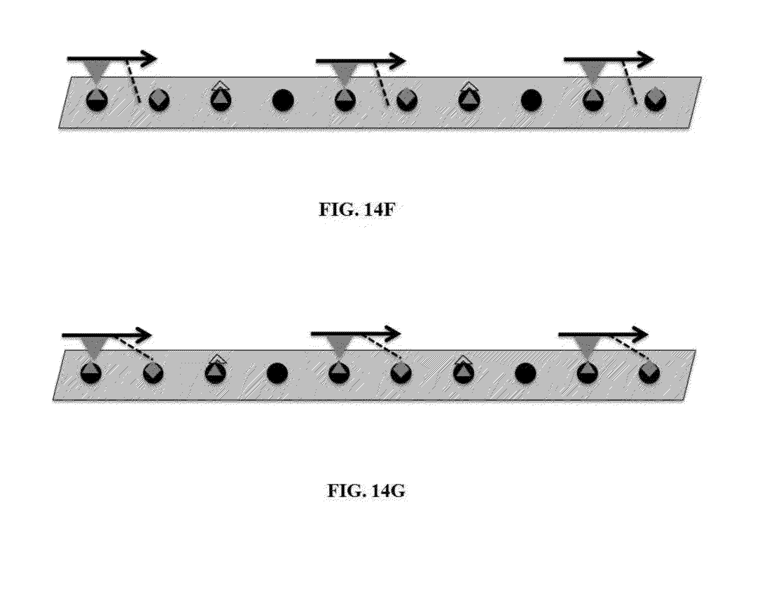

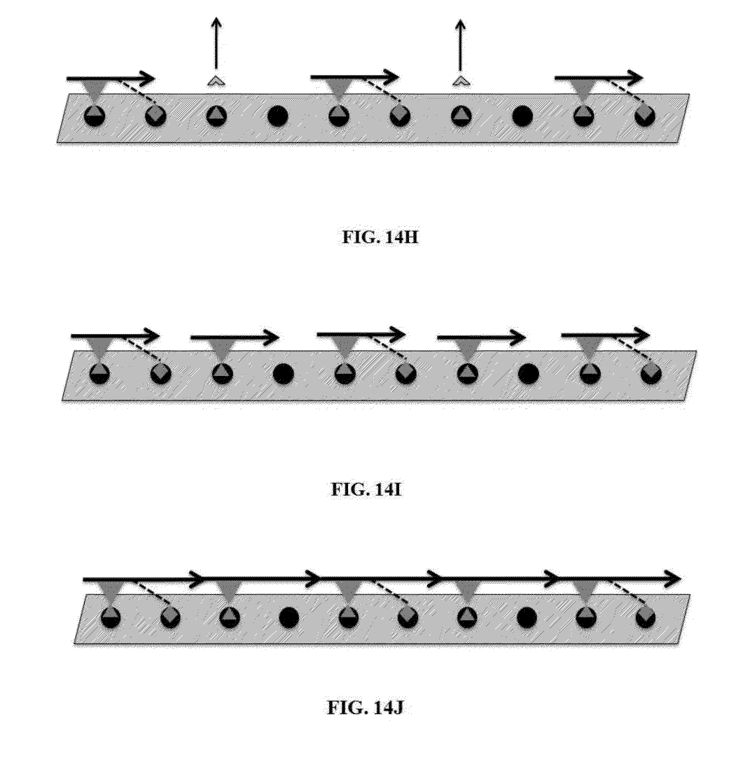

In some embodiments the use of orienting linkers can be performed in combination with use of protection groups and different coupling chemistries. Reference is made to the schematic illustration of FIGS. 14A-14J showing a variation of the approach schematically illustrated in FIG. 13A-13F. According to the approach of FIG. 14A-14F an anchor functional group and an orienting anchor functional groups are presented on functionalized linkers identified as primary anchor and orienting anchor, respectively (FIG. 14A) and are used in combination with corresponding protection groups, where a first protection group and a second protection group protect the anchor functional group on the primary anchors with orthogonal chemistry (FIG. 14A). In the approach of FIGS. 14A to 14F, two sets of monomers are attached: a first set of monomer only presenting a surface linking functional group corresponding to the anchor functional group presented on the primary anchor (first monomer species); and a second set of monomers further comprising an orienting linker presenting orienting functional groups corresponding to the orienting anchor functional groups presented on the orienting anchors (second monomer species).

Accordingly, in these embodiments, two orthogonal binding chemistries and two orthogonal protection chemistries are required as will be understood by a skilled person. According to this approach a first of primary anchors protected with first protection groups are attached to the surface spaced at 4* MBD (also 4*MAS) with respect to one another (FIG. 14B). Next a set of unprotected orienting anchors is deposited on the surface, each unprotected orienting anchor deposited consistently right adjacent to each of the previously deposited first set of primary anchor, with each unprotected orienting anchor deposited at 1 MBD from a primary anchor, and 4*MBD with respect to one another. (FIG. 14C). A second set of protected primary anchors protected with the second protection group is then deposited right adjacent to the unprotected orienting anchor with each protected primary anchor of the second set of protected primary anchor located at 1 MBD from the unprotected orienting anchor functional group, and at 4*MAS away with respect to one another (FIG. 14D). In the next steps, the first of the two orthogonal protection groups is removed (FIG. 14E), and monomers of the second monomer species is deposited through attachment of the surface linking functional group and anchor group presented on the primary anchors (FIG. 14F). The orienting anchor functional group and orienting functional group of the second monomer species are then bound, fixing the orientation of the monomers of the second monomer species bound to the surface (FIG. 14G). The steps of FIG. 14E, FIG. 14F and FIG. 14G can also be performed in a different order directed to first performing the coupling of the orienting anchor functional group and orienting functional group after removal of the first protection group, and then perform the coupling of the surface linking functional group and anchor group. After the second monomer species is bound and fixed in a particular direction, the second protection group is removed (FIG. 14H), and monomers of the first species of monomer are deposited (FIG. 14I). After that, polymerization can take place (FIG. 14J). As one of each adjacent pair of monomers is fixed in a particular orientation, polymerization can take place in only one direction. In the illustration of FIG. 14J orientation of some of the monomer of the first species is achieved taking advantage of the interactions between dipole moments of adjacent monomers. In possible variations of this approach, one could minimize interference in binding between orienting anchors deposited on the surface by also protecting the orienting anchors with protection groups having orthogonal chemistries and performing sequential deprotection of the groups and subsequent binding of the monomer of the second species on the surface.

In an application of the above approach, in an exemplary embodiment where the monomer is a dipeptide, linkers can be added to the first and third amino acid, replacing the hydrogen on the alpha carbon. In this particular tripeptide, there are no side chain functional groups likely to interfere with surface attachment, and the amine N-terminus is protected until polymerization. In embodiments where the surface is silicon if the silicon surface is functionalized at the attachment sites with amines serving as surface anchors with alternating orthogonal protection groups, the orienting anchors are provided by thiol, and the linkers on the amino acid were functionalized with an NHS ester and a maleimidobenzoyl group. In such configuration, multiple monomers can be attached to the surface in a same direction.

Reference is made in this connection to the schematic illustration of FIG. 6. In the illustration of FIG. 6 the monomer spans two attachment sites, and the directional monomer can be functionalized with two attachment linkers presenting chemically orthogonal surface linking functional groups, denoted in the figure by the diamond and the circle connected to the dashed lines. The corresponding anchor functional groups are presented on the surface in the desired sequence, denoted by the diamond and circle connected to the solid line respectively. Since the attachment between the surface linking functional group and the corresponding anchor functional group can only be performed in one way, that is, diamond to diamond and circle to circle, the attachment between diamond and circle as shown in FIG. 7 is not permitted. As result, the monomer can be oriented in the desired direction. In embodiments according to the approach schematically illustrated in FIG. 6 the surface linking functional groups and the anchor functional groups can be presented directly on the monomer and the surface respectively or on linkers in any of the configuration shown in FIGS. 8A to 8D.

In embodiments herein described attachment of monomers in a desired orientation can be verified by detection of the monomer on the surface performed by crystallographic methods, spectroscopy, STM imaging, fluorescence techniques like FRET and additional techniques identifiable by a skilled person.

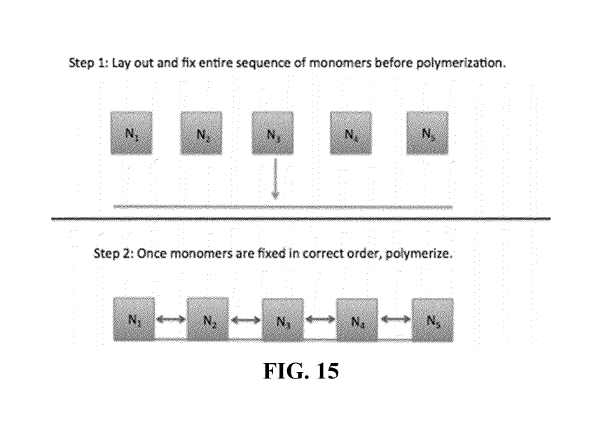

In embodiments herein described, the surface mediated synthesis is performed by: a) attaching each type of monomer contained in the polymer to a corresponding set of monomer binding regions on a coated surface, and b) performing a coupling reaction between polymerizing functional groups of the attached monomers to obtain a surface attached polymer. Those steps are illustrated in the schematic illustration of FIG. 15, wherein monomers N1 to N5 are initially attached to the schematic surface and then polymerized following attachment performed in the correct order.

In some embodiments of the process illustrated in the schematics of FIG. 15, where N1 to N5 are formed by a single type of monomer attachment of the monomers can be performed simultaneously through direct attachment or indirect attachment through linker to the surface as described herein before performing coupling reaction among the attached monomers.

In some embodiments of the process illustrated in the schematics of FIG. 15, where N1 to N5 are formed by a different types of monomer attachment of the monomers can be performed by attaching each type of monomer in sequential rounds of attachments, one round for each type of monomers to have all monomers N1 to N5 bound before performing coupling reaction between adjacent on to the surface according to the schematics of FIG. 15.

In methods and systems herein described and related supports, corresponding sets of monomer binding regions are located and distanced among themselves so that a sequential order of the monomer binding regions on the patterned coated surface corresponds to sequential order of positions of the each type of constituent monomer in the linear polymer. In those embodiments the attachment of each type can be performed.

In some embodiments, when the linear polymer contains one type of constituent monomers or two types of constituent monomers, each presenting orthogonal surface linking functional group and corresponding anchor functional group, the a) attaching monomers of each type of constituent monomer to corresponding set of monomer binding regions is performed by a single round of attachment.

In some of those embodiments, the linear polymer contains different types of constituent monomers and a) attaching monomers of each type of constituent monomer is performed by sequentially performing rounds of attaching, one round for each type of constituent monomer or one round for two types of constituent monomers, presenting orthogonal surface linking functional group and corresponding anchor functional group to the at least one attachment site of the corresponding set of monomer binding regions. In those embodiments a) attachment is then followed by b) performing a coupling reaction between polymerizing functional groups of the attached monomers to obtain a surface attached polymer after each type of constituent monomer is attached.

In particularly, in embodiments herein described, the attachment of monomers, performed simultaneously or in rounds of attachment, is performed on a coated surface patterned to expose monomer binding regions of the surface capable of attaching the monomers.

The term “coated surface” as used herein indicates a surface presenting moieties that are substantially inert and therefore not chemically reactive with the monomers of the polymer to be synthesized. Coating of a surface can be provided by covering the surface with a layer of masking material or by chemical treatment such as passivation. In embodiments herein described a coated surfaces can be treated to remove impurities, before and/or after coating (e.g. by annealing at high temperatures or by direct exposure to a flame or harsh solvents). Different surfaces have different properties which are considered in the selection of proper surface for a surface mediated synthesis and related coating herein described. For example, silica has functional groups corresponding to double bonds and can therefore be used to perform attachment of anchor groups (such as cyclopentene through binding of double bonds on the surface. Also Si [111] have different properties than Si [100] due to the differences in atomic structures which can affect the attachment of monomers and related polymerization as will be understood by a skilled person upon reading of the present disclosure. Silica coating can be performed by passivation as will be understood by a skilled person. In another example a gold surface can bind thiols functional groups presented on a monomer or on related attachment linkers or orienting linker. Therefore gold can be chosen as a surface for attachment of such monomers. Gold coating can be performed by providing a layer of masking material as will be understood by a skilled person upon reading of the present disclosure.

In embodiments herein described the coated surface is patterned to provide monomer binding regions formed by chemically reactive functional groups presented on the surface that are chemically reactive and present

The term “pattern” as used herein indicates a modification of the coated surface resulting in presentation of one or more sets of functional groups on the surface capable of binding with corresponding functional groups on monomers to be attached.

In some embodiments, herein described for each type of monomer to be attached on the surface a separate round is performed of: i) patterning the coated surface to selectively provide the corresponding set of monomer binding regions on the coated surface, thus forming a patterned coated surface; ii) attaching at least one anchor compound at at least one attachment site of each monomer binding region of the corresponding set of monomer binding regions on the coated surface and iii) depositing one or more monomers of said type of monomer on the monomer binding regions of the corresponding set of monomer binding regions.

In particular patterning the coated surface can be performed by different techniques and approaches that are dependent on the structure of the coated surfaces.

In some embodiments, the coated surface is provided by a surface covered by a mask formed by a layer of a material that is chemically inert (substantially not chemically reactive) with respect to binding reactions of monomers of the polymers to be synthesized. In those embodiments patterning of the coated surface can be performed by nanoscopic breaches in the mask to allow access for monomers to bind the underlying surface in preparation for polymerization. In some of those embodiments, such modification can be performed by removing atoms in an selected portions of the masking material performed by methods and approaches identifiable by a skilled person based on the masking material used.

Masking material according to the disclosure indicates a material impermeable to the constituent monomers of the polymer to be synthesized i.e. a material structured so penetration by constituent monomers of the polymer through a layer, (i.e. with a thickness over the surface to be coated) is minimized. Masking material can interact through chemisorption or physisorption with the underlying surface as will be understood by a skilled person. Impermeability of masking materials to constituent monomers of a polynucleotide, polypeptide or polysaccharide herein described can be tested by placing the a thickness above the surface to be masked, and determining whether or not the molecule of interest can bind to the surface at the tested thickness. Binding can be assayed through imaging such as STM, or spectroscopy in which you would look for bond modes specific to interactions between the monomer and surface. An additional test can be performed by having the mask divide a chamber into two parts, and loading the molecule of interest in one chamber, and monitoring the accumulation of the molecule in the second chamber. For a perfectly impermeable membrane accumulation of monomers in the second chamber would not be detectable.

In some embodiments herein described a mask is typically formed by a two-dimensional (2D) material or single layer material which are materials made consisting of a single layer of atoms or molecules, e.g. an atomically or molecularly thin in one dimension such as graphene, silicene, phosphorene, In some embodiments a mask can be formed by multilayer material which are materials formed by multiple layers of atomically thin materials. Masks generally have a thickness that allows monomers to bind the underlying surface through the pores introduce to the masks alone or in combination with other masks according to embodiments herein described. A same material can be provided for a single layer material or multiple layer material depending on the surface the monomers to be attached and whether or not the mask is used alone or in a combination of masks. Graphene, for example, is atomically thin (3.4 angstroms), and would allow a monomer functionalized with a thiol to reach through the pore and attach to the underlying gold. Multilayer graphene (graphite) would be multiples of 3.4 Angstroms thick. Three-layer graphite are approximately 1 nm, and depending on how long and narrow the linker is, a monomer functionalized with a thiol can reach through the pore to the underlying gold surface possibly is presented on a linker.

The presentation or structure of the mask can change during the deposition of monomers to the underlying surface as will be understood by a skilled person upon reading of the disclosure. Parts of the mask or of any related combination of masks can be added, removed, or modified in order to facilitate patterned deposition of monomers.

In some embodiments the masking material can be provided by graphene [3], [4]. In those embodiments, patterning can be performed with electron-beam and chemical methods, surpassing the diffraction limit of photolithographic methods and placing it in league with scanning probe lithography in feature size. The graphene mask is reusable and can cover large areas. Graphene also has thermal stability, making it resilient to high-temperature fabrication processes [5]. In graphene mask thermal stability implies that the integrity of the graphene should not be compromised when annealing the masked substrate to remove adsorbates and thereby to regenerate the mask. For the mask to be effective the permeability of the mask to monomers should be minimized. This property will be governed by the lattice spacing of the mask, and the size of the molecule in question. Interaction between graphene, the surface, and impurities can cause the graphene lattice to become strained. This strain can enlarge or close the openings between atoms, or induce defects (missing atoms, tears) that can compromise the integrity of the mask.

Additional masking material can be provided by materials such silicene, phoshporene, borophene, 2D Metal Organic Frameworks (MOF), 2D Covalent Organic Frameworks (COF), 2D Zeolitic Imidazoline Frameworks (ZIF), and protein layers such as the surface layer (S-Layer) protein of Deinococcus radiodurans [6]. The layer need not be atomically thin, but thin enough to allow the molecules that attach through the mask to react with one another freely. These materials are considered 2D, atomically thin in one dimension, and large in the other two dimensions. They can act as a barrier to molecules passing from one side of the material to the other. These materials can be synthesized on or transferred to another surface. Such materials are non-reactive in most conditions, so they are expected not to bind or modify constituent monomers herein described or other molecules that are to be patterned. In choosing a particular mask for a surface and monomer, it can be verified through experiment, literature search, or simulation that the monomer does not react with the surface under the conditions for deposition or polymerization.

Masking material herein described is typically structure in layers that do not rest stably on the surface of choice, do not show detectable translation on the plane of the surface or in a direction away from the surface. In some embodiments, a mask can have covalent interaction with the surface so long as it doesn't impede the bonding or polymerization of the monomers.

In some embodiments where the coating of the surface is provided by a mask, the patterning can be performed by oxidation chemistry [7, 8], or e-beam techniques [2, 9-11] as well as additional techniques identifiable by a skilled person.

In some embodiments, the mask having a pattern of pores or holes in coating can be patterned before the coating is placed on the surface. In addition or in the alternative, the mask can be patterned while the coating is placed on the surface. In cases where the mask is patterned before it is placed on the surface, the mask can be used either individually for synthesizing homopolymers or in a stacked layer with other masks in which the openings for monomers is selectively revealed for synthesizing heterpolymers. If the pores are formed on the surface, the pore forming process needs to be compatible with the surface. For example, if e-beam methods are used in forming the pores, certain factors or conditions need to be taken into consideration to avoid ablating the gold underneath the mask.

In the resulting patterned coated surface, a sequential order of the monomer binding regions attached with monomers corresponds to a sequential order of positions of the type of monomers in the polymer.

In some embodiments, patterning the coated surface can be performed to selectively provide the corresponding set of monomer binding regions on the coated surface, thus forming a patterned coated surface in which monomer binding regions of the corresponding set of monomer binding regions are located and distanced among themselves so that a sequential order of the monomer binding regions on the patterned coated surface corresponds to sequential order of positions of the each type of constituent monomer in the linear polymer.

In those embodiment depositing one or more monomers of said each type of constituent monomer on the monomer binding regions of the corresponding set of monomer binding regions can be performed by specifically attaching a surface linking functional group of the one or more monomers to a corresponding anchor functional group presented on the at least one attachment sites,

In particular the depositing is performed so that each of the one or more monomers attached to the at least one attachment site is attached with an orientation allowing formation, under suitable conditions, of covalent bonds between polymerizing functional groups of the one or more monomers with corresponding polymerizing functional groups of another monomer attached to the surface when the corresponding polymerizing functional groups are presented at a bond length with respect to said polymerizing functional groups of the one or more monomers,

Reference is made to the exemplary schematic illustration of FIG. 16A where the methods systems and materials herein disclosure are exemplified in connection with a system where the surface is covered by a suitable mask and is patterned to bind the nucleotide monomers for the sequence “GATA”

In the illustration of FIG. 16A the surface (1) is provided and then coated with a mask (2). The patterning is the performed to expose monomer binding region on the surface which correspond to the polynucleotide constituent monomer G (FIG. 16A, (3). A nucleotide monomer G is then deposited on the corresponding monomer binding region (FIG. 16A (4)). Then the patterning and depositing steps are repeated for the polynucleotide constituent monomer A (FIG. 16A (5) and (6)), and then for the polynucleotide constituent monomer T (FIG. 16A (7) and (8)). The result is the sequence of polynucleotide constituent monomers “GATA” which can then be polymerized through standard phosphoramidite or other appropriate chemistry depending on the specific constituent polynucleotide monomers and related corresponding polymerizing functional groups.

In some embodiments the patterning of the surface for the GATA sequence can be performed by oxidative chemistry, e-beam or other techniques performed on a single mask. In some embodiments the patterning can be performed by having layers of making materials with different pores. A deposition with four molecules would require four layers. The layer closest to the substrate would have all pores for each of the four type of constituent monomers (A, G, C, and T). The layer on top of that would have pores for only 3 of the 4 four types of constituent monomers (A, G, and C, for example). The next layer would have pores for only 2 of the four (A, and G), and the top layer would have pores for only the one of the four (A).

In those embodiments, initially, only the pores for the A are revealed on the substrate. A's are introduced and they bind the substrate, occupying those pores. The first layer of masking material is then removed, leaving the A's occupying their pores, and revealing the pores for the G's. The G's are deposited, and the next layer is removed, revealing the pores for the C's. The C's are deposited, and the next layer is removed, revealing the pores for the T's. With all molecules deposited, polymerization can then be initiated.

In some embodiments, multiple polymers can be synthesized on a same surface. Reference is made to the exemplary illustration of FIG. 16B wherein the parallel synthesis or three different sequences according to the disclosure is schematically illustrated. The gold surface (1) is coated with a layer of graphene (2). Subsequently, a column of pores are introduced to the layer of graphene (3). Each pore corresponds to a monomer of an identical and separate polymer molecule. The first round of monomers (A) are added to the pores (4). Next, another column of pores are made (5), and a second round of deposition (G) follows (6). Each row now has two monomers adjacent to one another, prepared for polymerization. A similar approach can be applied to other linear polymer herein described with different types of constituent monomers (e.g. polynucleotide monomers presenting other bases or oligonucleotides) or different constituent monomers such as amino acid monomers of a same or different types.

In some of the embodiment schematically shown in the illustration of FIGS. 16A and 16B depositing can be preceded by attaching at least one linker at at least one attachment site of each monomer binding region of the corresponding set of monomer binding regions on the coated surface, the linker presenting an anchor functional group for binding to a corresponding surface linking functional group on a monomer of the each type of constituent monomers.

In an embodiment the system of the schematics of FIG. 16A and FIG. 16B can be provided by a gold and graphene system that can be designed along the line of self-assembled monolayers, or SAMs which been used to immobilize molecules that are subsequently coupled [12, 13].

In some of those embodiments the gold surface of the gold/graphene system can be deposited on a further layer of material, such as mica. The most common face of gold is the (111) surface and can be used in this application, though the other surfaces (100, 001, etc.) are also usable and can provide advantages in certain polymerizations. Stepped surfaces can also be useful. Gold can also be deposited on a nanostructured surface so as to reflect the contours of that surface. The graphene is formed by chemical vapor deposition (CVD) growth on a copper foil. Pores can be formed chemically by radical gold-catalyzed oxidation, or by Focused Ion Beam (FIB) bombardment. It has been demonstrated that the latter can be used to place pores in specific locations with a spacing of about a few nanometers. In such instances the gold graphene system to monomers can be used to polymerize monomers with larger characteristic widths, such as oligomers (for example, a 10 base pair oligomer of DNA is ˜3 nm). Alternatively, monomers can be deposited into narrow trenches on the gold surface and then aggregated subsequent to deposition.

In some embodiments, the mask can be transferred to the gold via the polydimethylsiloxane (PDMS) transfer method, wherein a thin layer of PDMS is coated onto the graphene, and the PDMS acts as a handle to move the graphene from one substrate to another. The PDMS is dissolved away after transfer to gold. Monomers can then be bound to the surface by deposition from solution or vapor phases, each monomer functionalized with a free thiol that can bind the gold surface. After all monomers have bound the surface, polymerization is initiated by setting reaction conditions appropriate for the particular polymer.

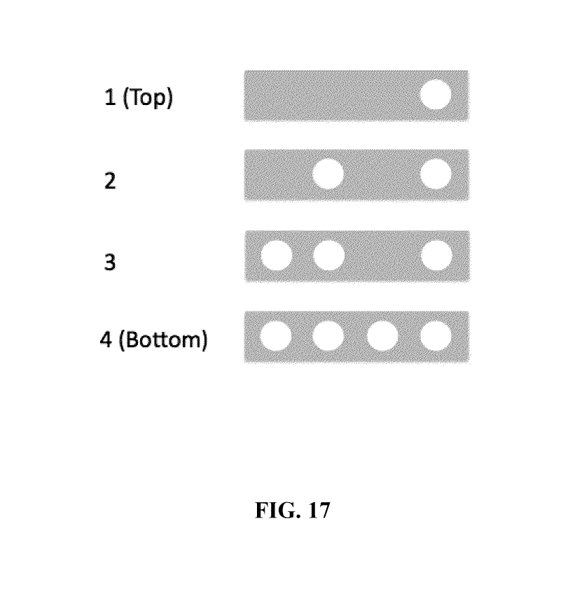

In some embodiments, a mask can be used together with other masks in a combination of masks as illustrated in FIGS. 17-19. In particular in FIG. 17 a set of masks used to create four monomer binding regions is schematically illustrated. In the illustration of FIG. 17, each mask represents a different stage of deposition of monomer on the corresponding monomer binding region. At each stage monomers will be able to bind to the surface only in regions exposed by the mask, and not already occupied by monomers deposited in previous deposition steps.

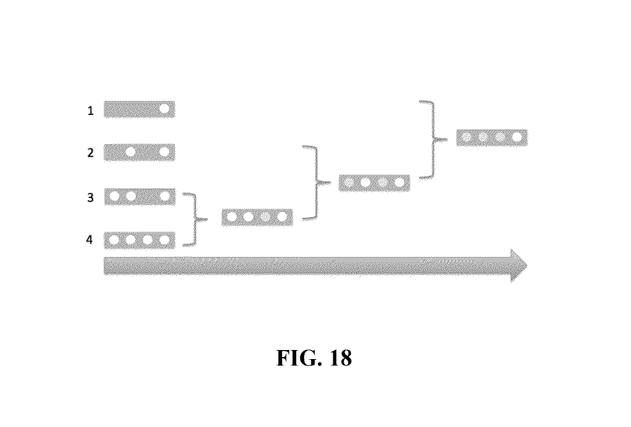

In the illustration of FIG. 18 the masks are stacked on top of one another, 1 on top of 2 on top of 3 on top of 4, as is shown in figure. The mask closest to the substrate, number four, has pores for every monomer in the polymer. Mask three, stacked on top of mask four, has pores for 3 of the 4 types of monomers in the polymer, and so covers the pores for the fourth type of monomer in mask four. In the illustration of FIG. 18, mask two, stacked on top of masks three and four, has pores for 2 of the 4 types of monomers, and so covers the pores for the third type of monomer that are present in mask 3. In the illustration of FIG. 18, mask one, stacked on top of masks two, three, and four, has pores for only 1 of the 4 types of monomers, and so covers the pores for the second type of monomer that are present in mask 2.

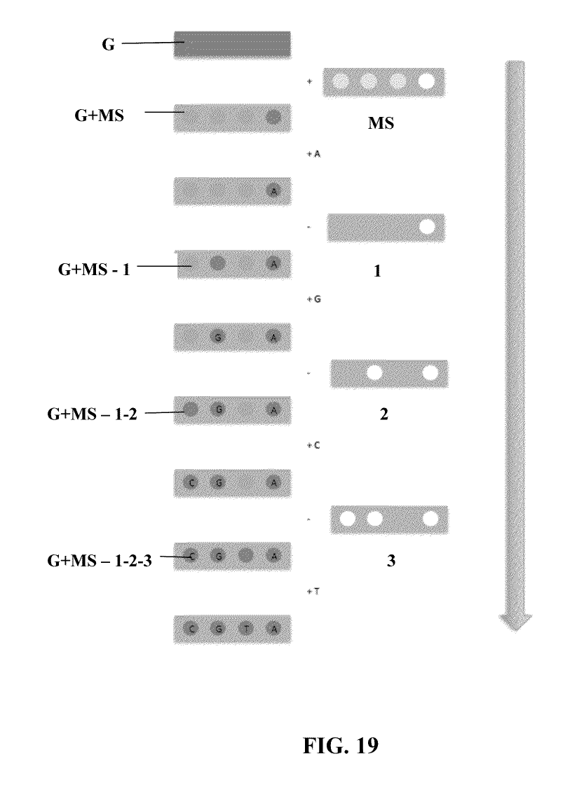

FIG. 19 shows a schematic of the workflow for patterned deposition of monomers using stacked masks. The first step is to take the complete stack of FIG. 18 and place it on the substrate. The substrate is denoted “G”, the fully stacked mask is denoted “MS”, so the stacked mask on the substrate is denoted “G+MS”. The first monomer (any monomer, not just DNA), is deposited. There is only one pore that penetrates through to the substrate, so monomers can bind only to that one revealed spot. The top layer of the mask is removed, bringing us to system “G+MS−1”. The removal of the top mask reveals a second pore that penetrates through to the substrate. A second monomer (any monomer, not just DNA) is deposited. These monomers go only into the newly revealed pore, as the first pore is occupied by the first round of deposition. The entire process of mask removal and deposition is repeated until all monomers have been deposited into the designated pores.

In some embodiments the coated surface is provided by a material per se reactive to monomer binding which is treated to be chemically inert. In those embodiments, the patterning can be performed by providing modifications one or more set of moieties on the surface resulting in functional groups being presented on the surface for binding to a monomer and/or an anchor moiety of a linker. A representative example of such kind of coated surface is herein provided by Silicon Hydrogen system which can be varied by using other surface and/or molecules other than hydrogen to passivate, such as an alkane, which can be removed with STM or other techniques, identifiable by skilled person. Such modifications can be performed as removal of atoms independently bonded to the surface such as hydrogen bonded to silicon.

An exemplary surface treated to be chemically inert to monomer binding is provided by a passivated silicon. In particular, in embodiments where the 100 and 001 surfaces of silicon are used when the silicon is activated dimer pairs are presented that form a weak pi-bond and are susceptible to selective addition [14]. In embodiments where the surface is provided by silicon, the dimers are separated by 3.8 Angstroms, a distance for forming bonds between monomers anchored at those positions. Such distance is within the characteristic width of DNA monomers and other monomers identifiable by a skilled person according to the critical width and minimum allowable spacing relationship previously described. Other examples of monomers with CWs compatible with Si 100 include dipeptides, oligosaccharides of glucose making 1,6 and 1,4 linkages.

In some embodiments the dangling bonds of an Si-100 surface can be passivated by hydrogen and selectively activated with an STM tip as shown in FIG. 20 [15, 16]. This selective removal of the hydrogen leaves an attachment site presenting a reactive radical that can be used for binding molecules at that locus, ultimately allowing for the placement of molecules with sub-angstrom precision, a capability that has already been demonstrated [17, 18]. In embodiment s where linkers or functional groups with sensitive moieties are to be attached both hydrogens from a single dimer pair of Si of the silica can be removed through STM to produce a weak Pi bond that is less reactive than a radical, being prone to a [2+2]-like cycloaddition.

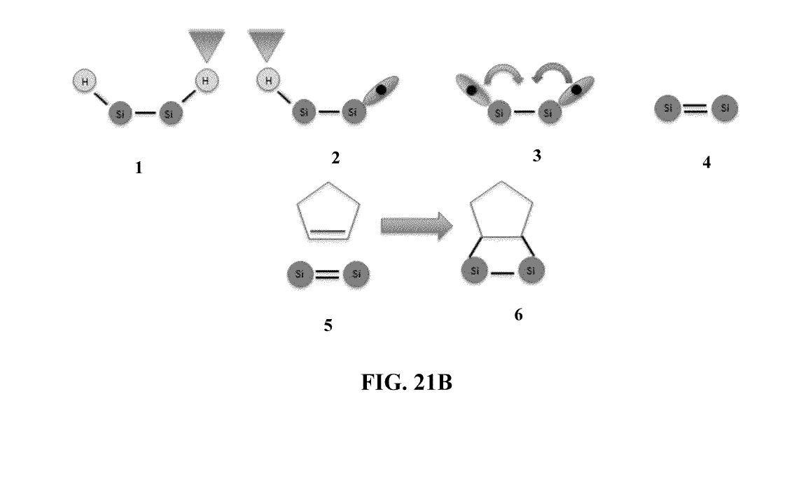

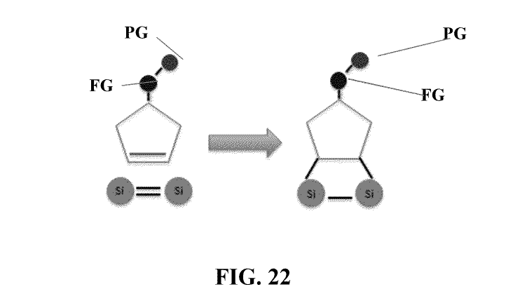

This process is schematically illustrated in FIG. 21A and exemplified in FIG. 21B. In some embodiments, to anchor monomers at these dimers, the monomer needs a linker that has a binding moiety. In an embodiment tBOC-1-Amino-Cylcopentene can be used, to present an anchor group to attach a DNA oligo to a Si 100 surface [19]. 1-Amino-Cylcopentene has a double bond at the base of the cyclopentene that is used to attach to the Silicon. The amino group is used to attach to the DNA, and the tert-Butyl oxy carbonyl (tBOC) group protects the Amine from interacting with the Silicon surface before it binds the DNA. The tBOC protection group is removed after the molecule is bound to the Silicon surface to prepare for binding other molecules. The addition to a silicon dimer of a molecule like tBOC-1-Amino-Cyclopentene is depicted in FIG. 22. As an example, the functional group can be a primary amine, and the protection group can be a t-Boc, Dde, Fmoc or MeNPOC or any other amino group protection groups as readily known to a person of ordinary skill in the art with the knowledge of the present disclosure.

Any alkene or diene compounds with a functional group with or without a protective group can be suitable as a functional group for attachment to the S═Si double bond on the silicon surface.

Exemplary linkers for a silicon surface include 1-amino-2-cyclopentene, 1-amino-3-cyclopentene the amino group can be protected with any suitable protective group such as t-Boc, Dde, Fmoc or MeNPOC. Alternatively, a cyclopentene can be functionalized with a carboxylic group such as in 1-methyl-2-cyclopentene-1-carboxylic acid.

A cyclopentene can also be functionalized by more than one functional group such as in the case of 4-amino-2-cyclopentene-1-methanol which includes an amino group and a hydroxymethyl group on the cyclopentene ring. Each of the functional groups on a cyclopentene can be further orthogonally protected. 3-Cyclopentene-1-acetaldehyde can also be used as a linker in which the aldehyde group can react with an amino group.

An amino group amino group can be protected with any suitable protective group such as t-butyloxycarbonyl (t-Boc), 1-(4,4-dimethyl-2,6-dioxocyclohex-1-ylidene)ethyl (Dde), 9-fluorenylmethyloxycarbonyl (Fmoc), [R,S]-1-[3,4-[methylene-dioxy]-6-nitrophenyl]ethyloxycarbonyl (MeNPOC), o-nitroveratryloxycarbonyl (NVOC), 2-(2-nitrophenyl)propyloxycarbonyl (NPPOC), benzyloxycarbonyl (Cbz), triphenylmethyl (Tr), or as phthalimide, p-toluenesulfonamide, benzylideneamine, trifluoroacetamide.

A hydroxyl group can be protected with methoxymethyl (MOM), tetrahydropyranyl (THP), t-butyl, allyl, benzyl (Bn), t-butyldimethylsilyl (TBDMS), t-butyldiphenylsilyl (TBDPS), acetyl, benzoyl, pivaloyl, 4,4′-dimethoxytrityl (DMT).

A carboxyl group can be protected with a t-butyl as an ester. Other carboxyl protective groups give a protected product as benzyl ester, S-t-butyl ester, or 2-alkyl-1,3-oxazoline.

A person of skilled in the art would know how to choose among different combinations of orthogonally protective groups associated with functional groups on an anchor, linker or a monomers based on the relative stability of each protective group to the deprotection conditions of other orthogonal protective groups. For example, Fmoc, Dde, t-Boc and MeNPOC are orthogonal to each other. Fmoc is readily removed by a piperidine solution to which Dde, t-Boc and MeNPOC are stable. t-Boc is deprotected by a trifluoracetic acid solution to which Fmoc, Dde, and MeNPOC are stable. Dde is removed by a hydrazine solution to which Fmoc, t-Boc and MeNPOC are stable. MeNPOC is labile to visible light to which Fmoc, Dde and t-Boc are stable

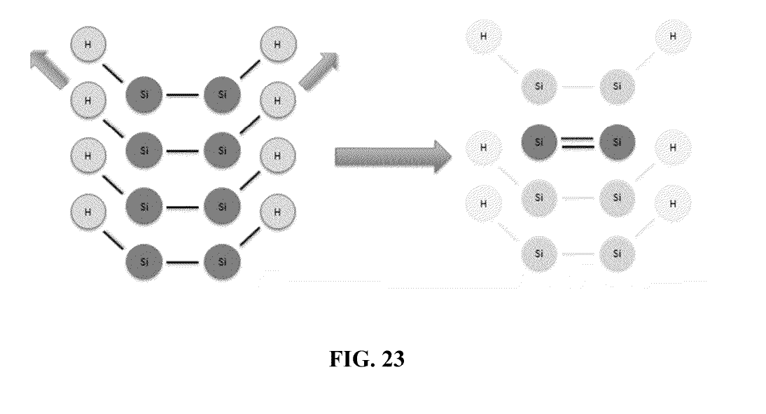

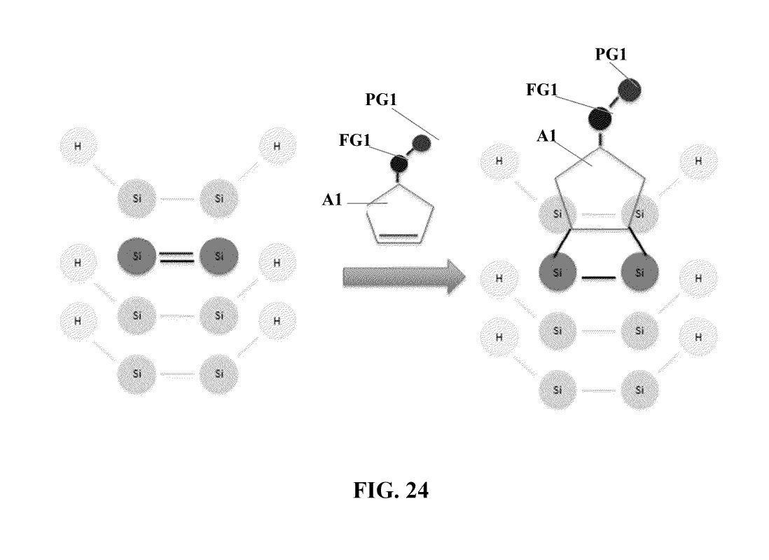

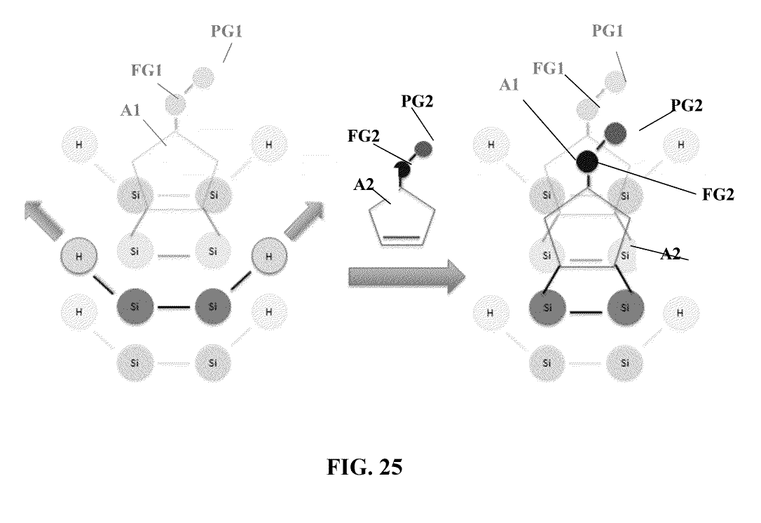

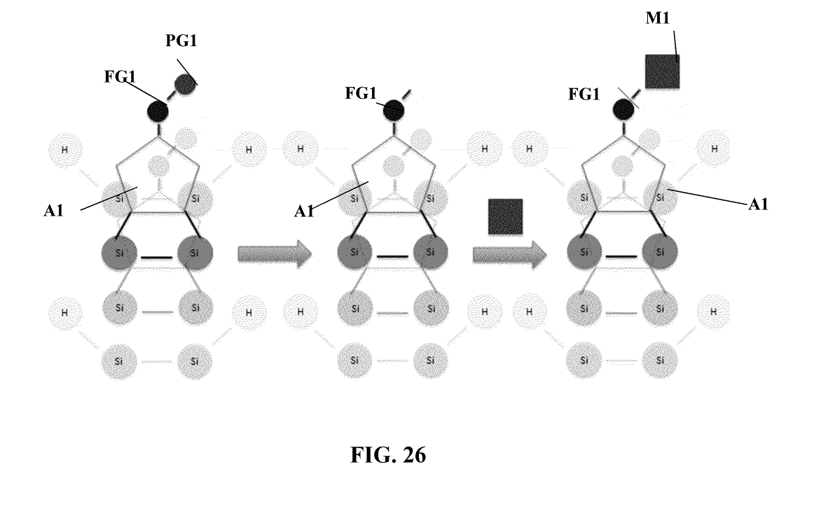

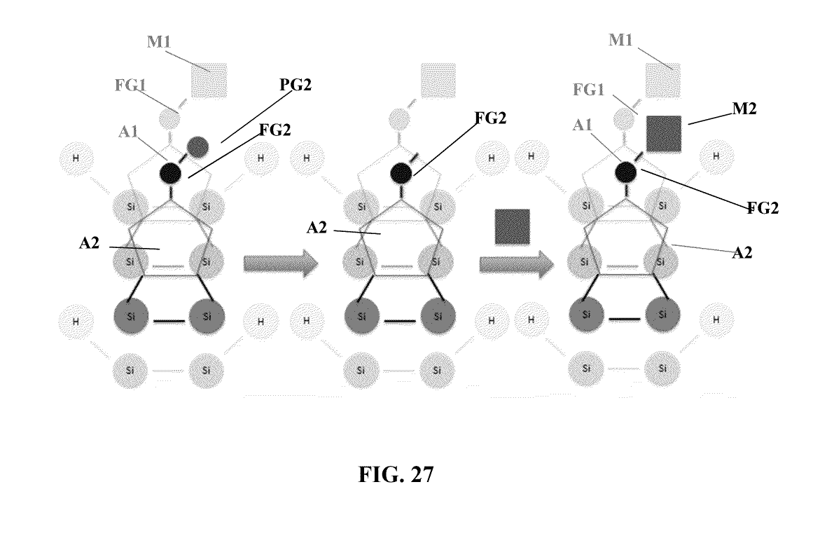

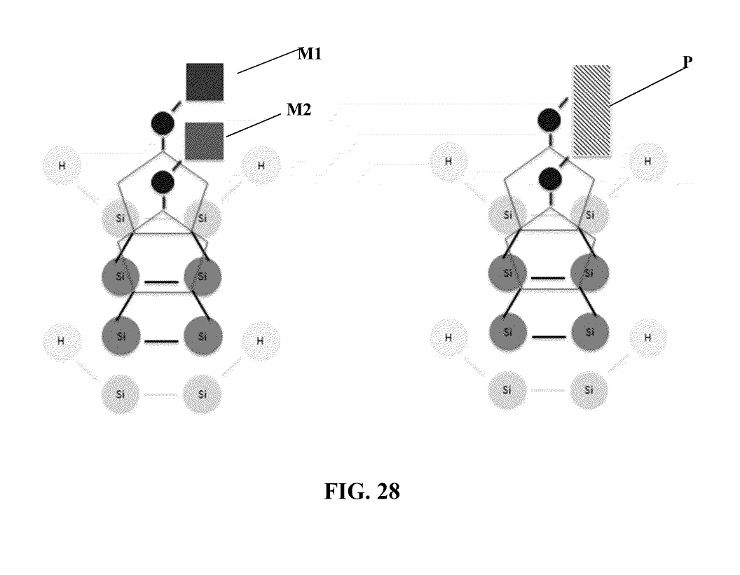

In some embodiments a surface mediated synthesis system can be performed on a passivated Si (100) surface. First, an STM removes both hydrogens from a Silicon dimer to generate a weak pi-bond, as shown in FIG. 23. The first anchor is introduced in the vapor phase and binds the Silicon dimer pair through the [2+2]-like cycloaddition, shown in FIG. 24. The STM can be used to verify the deposition of the monomer at the desired location and can possibly be used to remove mis-bound anchor molecules (correction mechanism). The hydrogen removal and deposition are repeated at an adjacent dimer pair with an orthogonally-protected monomer, as shown in FIG. 25. The functionalized Silicon is then removed from the STM and the first protection group is removed. The first monomer is then reacted with the newly revealed functional group and anchored to the surface, as shown in FIG. 26. The second protection group is then removed, and the second monomer is bound to the newly revealed functional group, and is now adjacent to the first monomer, as shown in FIG. 27. Finally, the first and second monomers are polymerized as shown in FIG. 28, possibly under an external electric field to orientate the monomers if the monomers are directional. In the final step, the polymer can be removed from the surface. Note that there are other approaches of functionalizing the Si 100 or 001 surface. For example, the group V compounds ammonia, phosphine, and arsine can bind the silicon dimer pairs[17]. Primary or secondary versions of these compounds, with the monomer as one of the constituents can serve as an anchor in a similar way that cycloalkenes do. FIG. 28 to form a product (P) can be characterized by STM, STS or any method as known by a person of ordinary skill in the art.

In some embodiments a surface mediated system can be performed on a passivated Si (100) surface through an orthogonal functional group work flow, such as the following. First, an STM removes both hydrogens from a Silicon dimer to generate a weak pi-bond, as shown in FIG. 23. The first anchor, bearing a protected functional group capable of binding a monomer, is introduced in the vapor phase and binds the Silicon dimer pair through the [2+2]-like cycloaddition, shown in FIG. 24. The STM can be used to verify the deposition of the monomer at the desired location and can possibly be used to remove mis-bound anchor molecules (correction mechanism). The hydrogen removal and deposition are repeated at an adjacent dimer pair with a protected orthogonally-functionalized monomer, capable of binding a separate monomer, as shown in FIG. 25. The functionalized Silicon is then removed from the STM and the all protection groups are removed, revealing all functional groups, and all monomers are added. As the functional groups are orthogonal, they bind their respective monomers simultaneously. The events in FIGS. 26 and 27 happen simultaneously in parallel. Finally, the first and second monomers are polymerized as shown in FIG. 28, possibly under an external electric field to orientate the monomers if the monomers are directional. In the final step, the polymer can removed from the surface. Note that there are other ways of functionalizing the Si 100 or 001 surface. The group V compounds ammonia, phosphine, and arsine can bind the silicon dimer pairs [17]. Primary or secondary versions of these compounds, with the monomer as one of the constituents, could possible serve as an anchor in the same way that cycloalkenes do as will be understood by a skilled person. Additional material structured to allow site specific addition of monomers to the surface, either through a linker or directly, that doesn't alter the monomer, by selectively revealing reactive sites through STM lithography can also be used for approaches such as the ones illustrated in FIGS. 26 to 28.

In some embodiments, multiple STM tips can be used to remove hydrogens in parallel. Such approach is expected to be performable either by independently operated tips (a possibility mentioned by Randall et. al. [15]), or by an array of tips that operates as a single unit.

In some embodiments, an anchor molecule is provided that can bind multiple monomers. The BOC-1-ACP binds one monomer through its single amine group, but a 2-5-Diaminocycopentene could bind two such monomers. Other anchor molecules could allow for many different monomers to be placed with a single lithographic event. In this case, the monomers on a single anchor do not react with one another. This can be ensured if the monomer in question is non-reactive with itself (as is the case in some alternating copolymers), or that the monomers are separated by more than one characteristic width while on the anchor.

In some embodiments, a lithographic chain reaction can be harnessed. In those embodiments, a single hydrogen is removed, yielding a free radical, and when a molecule reacts with the radical, the first radical is quenched, and a second, adjacent radical is generated. In this way, a single lithographic event can result in many bound molecules. In those embodiments, the method is performed to control the reaction so that it occurs in the desired direction on the desired surface, and there is some evidence it can be achieved [20].

In some embodiments, systems are described that comprise combinations of substrate material and possibly also masking materials. In some embodiments, substrate material for the surface can be provided by elements or compounds that form crystals with flat surfaces, or can be layered on top of another substrate with a flat surface. Both the Silicon surfaces and Silicon Oxides satisfy these criteria. Metals and their oxides can also be appropriate, are evaluated on a case by case basis. Mask that can be used to cover the surface includes either atoms or molecules that are covalently or non-covalently bound to the surface and are selectively removable by STM lithography techniques (hydrogen), or 2D materials that are laid over the surface (e.g. 2D graphene).

In some embodiments organic polymers bound on a surface can be prepared by a surface mediated synthesis using any of the suitable covalent bond forming chemistry between a surface linking group of the monomer and corresponding anchor group and optionally through orienting linker functional group on the monomer and corresponding orienting anchors on the surface.

In some embodiments, bond formation between corresponding functional groups presented on the monomer and/or on a surface can be mediated by an activating agent. In one exemplary embodiment, a carboxylic acid of an amino acid reaction with an amino group of another amino acid can be activated by any the coupling reagents such as DCC (Dicyclohexylcarbodiimide) and an additive such as HOBt (1-Hydroxybenzotriazole). Other suitable peptide bond forming coupling reactions include but are not limited to PyBOP (Benzotriazol-1-yloxy-trispyrrolidino-phosphonium hexafluorophosphate), PyBrOP (Bromo-trispyrrolidino-phosphonium hexafluorophosphate), PyAOP (7-Aza-benzotriazol-1-yloxy-tripyrrolidino-phosphonium hexafluorophosphate, PyOxim (Ethyl cyano(hydroxyimino)acetato-O2)-tri-(1-pyrrolidinyl)-phosphonium hexafluorophosphate), DEPBT ((3-(Diethoxy-phosphoryloxy)-1,2,3-benzo[d]triazin-4(3H)-one), TBTU(BF₄⁻) (2-(1H-Benzotriazol-1-yl)-N,N,N′,N′-tetramethyluronium tetrafluoroborate, HATU (2-(7-Aza-1H-benzotriazol-1-yl)-N,N,N′,N′-tetramethyluronium hexafluorophosphate).

In another exemplary embodiment, a phosphoramidite coupling to an hydroxyl group in an DNA or RNA synthesis on a surface can be activated by an acidic azole, 1H-tetrazole, 2-ethylthiotetrazole, 2-benzylthiotetrazole, 4,5-dicyanoimidazole, or a number of similar compounds.

In another exemplary embodiment, an olefin group of a monomer is coupled to an olefin group of another monomer on a surface. Olefin monomers include but are not limited to methacrylic acid, 4-methyl-1-pentene, n-vinylacetamide, p-phenylene vinylene, 4-vinylphenol, styrene, butadiene, propylene. Such surface bound organic polymer can be made using living or pseudo-living polymerization techniques. For example, a living cationic or living anionic polymerizations. Pseudo-living polymerizations include controlled radical polymerization such as atom transfer radical polymerization (ATRP) and reversible addition fragmentation chain transfer (RAFT) polymerization. In particular, in several embodiments, various polymerization reactions can be performed, comprising Ziegler-Natta polymerizations, and in particular the Ziegler Natta polymerization which use both metallocene and non-metallocene catalyst, identifiable by a skilled person upon reading of the present disclosure.

In another exemplary embodiment, surface bound polymers such as PEDOT or poly(3,4-ethylenedioxythiophene), poly(arylene oxide), polypyrrole, polyaniline, polythiophene or derivatives thereof, including copolymers thereof can be synthesized on a surface. One such derivative is 3,4-ethylenedioxythiophene for polymerization to give PEDOT. Monomers of appropriate aromatic or heteroaromatic monomer can be deposited and bound on a surface in an ordered manner. A polymerization can be initiated by introduction of oxygen and a Cu(I) catalyst, ferric chloride, ammonium persulfate or any suitable catalyst or oxidant at room temperature or a temperature that is conducive to the polymerization reaction. It is to be understood that polymers of this class are particularly useful for application as conductive polymer and organic semiconductor material. These surface bound polymers can be directly used as an integral part on an electronic device.

In some embodiments the surface-mediated synthesis herein described can be used for polymer synthesis (DNA, RNA, peptides, oligosaccharides, etc.), and for studying chemical reactions through geometric confinement in a similar manner to Kim et. al. [12]. While the intended gain for polymer synthesis is longer sequence-controlled constructs, in some embodiments, methods and systems herein described can also be useful for homopolymers by achieving exact lengths (100 monomers, 200 monomers, etc.) and thus avoiding polydispersity, preventing branching, and avoiding composition drift.

Coupling reactions involved in polymerization on the surface according to embodiments herein described comprise acid-base, cycloadditions, radical mechanisms, substitution reactions, and additional reactions identifiable by a skilled person

In some embodiments, detachment of a synthesized polymer from the surface can be performed. In those embodiments at least one covalent bond cleavable by cleaving agent (such as nucleophilic agent) or by light can be included in any of the connecting structures linking the synthesized polymer to the surface (e.g. attachment linkers, orienting linkers, and structure resulting from reaction of the surface linking group and a corresponding anchor group)

In those embodiments, the at least one cleavable bond is included proximate to a group of atoms configured within the structures so that in presence of the cleaving agent or light would unstabilize the cleavable covalent bond resulting in cleavage of the cleavable covalent bond.

Examples of structures that result in cleaving of a covalent bond in the structure in presence of an acid cleaving agent are Merrifield chloromethyl Linker, TFA cleavable linker include Wang linker and HMPB linker, Rink linker, Chlorotrityl linker, HTPM linker. Examples of structures that result in cleaving of a covalent bond in presence of light nitroveratryl-based linker and alpha-methylated nitroveratryl-based linker (Holmes, C. P. et al.; J. Org. Chem. 1995, 60, 2318; and Holmes, C. P.; J. Org. Chem. 1997, 62, 2370. Examples of structures that result in cleaving of a covalent bond in presence of nucleophile cleavable agent are Dde based linker (Plante, O. J. et al.; Science, 2001, 291, 1523).

Additional structures and related possible configuration within the connecting structures herein described are identifiable by a skilled person. In case inclusion of more than one cleavable bonds in one or more of functional groups and/or linkers used during the synthesis the cleaving conditions of the different bonds can be orthogonal as will be understood by a skilled person.

In embodiments wherein detachment of the synthesized polymer is desired, the methods of the disclosure further comprise detaching the synthesized polymer from the surface by cleaving at least one cleavable bond presented on a connecting structure linking the synthesized polymer to the surface.

Depending on the chemical structure of the resulting cleavable structure, the covalent bond can be cleaved under certain conditions that are not detrimental to the synthesized polymer on the surface.

The conditions for detachment of the cleavable linker include visible light, UV light, organic acids, inorganic acids, nucleophiles, electrophiles, reducing agents, oxidation agents, including any linker as is known by a person skill in the art. (Peter J. H. Scott, “Linker Strategies in Solid-Phase Organic Synthesis”, Wiley, 2009). Suitable scavenger can be included in the cleavage condition as is known to a person skilled in the art.

In some embodiments the surface-mediated synthesis herein described can be used for polymer synthesis other than those described above so long as the monomers meet the criteria outlined previously and the chemistry of polymerization is compatible with the surface and mask.

In some embodiments herein described, surface mediated synthesis of the disclosure allows better control could be exercised in the synthesis of polymers by more precisely controlling the overall length of the polymer, by minimizing branching, and by controlling the length of subdomains of the polymer.

In some embodiments herein described, surface mediated synthesis of the disclosure provides means of controlling the length of homopolymers, preventing branching, and facilitating reactions through proximity of the monomers that would otherwise require specialized conditions such as high pressure and temperature.

In some embodiments herein described, surface mediated synthesis of the disclosure allows patterning through masking and selective revealing that stands alone as a potentially useful technology that could be used for ends other than polymer synthesis.

In some embodiments herein described, surface mediated synthesis of the disclosure allows placement and bonding occur in separate steps allowing for error correction.

The correction can take place at different stages. Prior to polymerization, when anchors or monomers are placed on the surface, the STM can be used to verify if the anchors or monomers have been deposited at the locus, and possibly determine what has been deposited through Scanning Tunneling Microscopy or Spectroscopy. As this verification can occur before polymerization, the correct sequence of monomers can be guaranteed before the polymerization reaction takes place. In some cases, monomers can be added to the surface mediated synthesis system subsequent to a round of polymerization to fill in any gap between one monomer and another. It is assumed that in such cases monomers can only interact with the monomers localized at the adjacent attachment sites due to certain conditions imposed by monomer binding and the chemistry of polymerization reaction. During the surface mediated synthesis, multiple attempts of monomer deposition prior to polymerization or subsequent to any round of polymerization can be conducted to maximize the likelihood of the successful attachment of monomers to the surface. In some embodiment, depositing constituent monomers is repeated after any around of polymerization followed by detection of the synthesized polymer addition of monomers where there are gaps, subsequent polymerization and, repeating the depositing polymerizing and detecting until formation of a desired polymer is detected.

In some embodiments herein described, surface mediated synthesis of the disclosure allows placing monomers in proximity to one another so that the likelihood of reaction can be increased. The geometric confinement of the monomer can both ensure the proper stoichiometry and overcome substantial kinetic barriers (<5 kcal/mol) by dramatically reducing the search space.

In some embodiments herein described, surface mediated synthesis of the disclosure allows all bonds to be formed simultaneously, obviating the need to terminate the coupling reaction for one pair of monomers before initiating the reaction of another pair of monomers. The longer reaction time available in the surface mediated synthesis can lead to formation of longer fragments at higher yields.

The surface mediated synthesis herein described allows in some embodiments to reduce costs, turnaround time, and complexity in the synthesis process of several polymers. In particular, by fixing the stoichiometry of the reactions, a 10-fold molar excess of monomer typically required to drive solid-phase synthesis of the polymer and the related coupling steps are not required in the surface mediated synthesis system herein described. The surface mediated synthesis methods and systems also avoid the formation of intermediate assemblies, which otherwise requires strategies to obviate by minimizing undesired interactions within and between oligomeric fragments.

The surface attached polymer having monomers localized to the surface and fully extended can be used for probing on regions of the polymer that are otherwise occluded using such methods scanning probe microscopy or affinity assays.

The methods described herein can also be used for creating coated surfaces where the polymer coating is highly ordered as well as for studying immobilized polymers through scanning probe microscopy, affinity assays, and other methods identifiable by a skilled person.

Surface mediated synthesis can be used for synthesizing both homopolymers and heteropolymers. Surface mediated synthesis methods can be used in the preparation of homopolymers to control the exact length of the final polymer product. The methods can also be used to prepare a linear product when the polymer is prone to branching.

Surface Mediated Synthesis can also be used in the preparation of heteropolymers such as copolymers to control the exact length of the final polymer product as well as to prepare a linear product when the polymer is prone to branching. Further, in the preparation of copolymers, fixing the order of copolymers on the surface prior to polymerization can overcome composition drift and kinetic barriers that require high concentrations, pressures, as well as other conditions to promote polymerization.

In addition to the above described, surface mediated synthesis is particularly useful for preparing long sequence-controlled polymers to secure a sequence of monomers in a particular order. Such sequence control can allow for making otherwise random-sequence copolymers at a particular sequence, fixing the size of blocks in block copolymers, and preparing exact sequences as in DNA, RNA, proteins, and heteropolysaccharides. Examples of sequence-controlled polymers include DNA, RNA, Proteins, and the heterosaccharide Heparin.

### EXAMPLES

The following examples illustrate exemplary synthesis and characterization of linear polymers synthesized on-surface.

In particular, the following examples illustrate exemplary constituent monomers, such as nucleotides, amino acids and monosaccharides deposited and synthesized on a gold surface masked by a graphene layer or a passivated silicon surface activated in selected regions in accordance with exemplary procedures in accordance to the present disclosure. A person skilled in the art will appreciate the applicability of the features described in detail for the exemplified synthesis process and related synthesized polynucleotide on the gold/graphene surface to different substrates, different polymers, different reaction conditions and reagents in accordance with the present disclosure.

### Example 1

### Selection of Graphene as Masking Material

Graphene was chosen as masking material in development of a support for surface in view not only of the electronic, thermal, and mechanical properties [21] [22], but also in view of its capacity to act as an impermeable or semipermeable membrane. Bunch et al. demonstrated the impermeability of graphene to helium through the inflation of a “nanoballoon” [23], [24]. Graphene can also act as an effective barrier to oxidation of metal surfaces under certain conditions [25], [26], [27]. The purposeful introduction of pores into graphene tunes this permeability by allowing certain molecules to pass through while others are inhibited. This use of graphene has led to proposals as varied as desalination and DNA sequencing [28], [29], [30], [31], [32].

Accordingly, graphene was selected for use in creation of “holey” graphene to be used as a molecular barrier applied by adsorption and self-assembly.

Self-assembly provides a convenient route towards the bottom-up placement of single molecules with applications ranging from nanotechnology to biology [33], [34], [35], [36]. Molecules for self-assembly typically comprise an attaching head group, an interacting backbone, and a functional tail group. The head group binds the molecule to a substrate, backbone intermolecular interactions lead to crystalline packing (through design), and the exposed terminal functional group can tune interfacial chemical properties between the substrate and its environment [37]. Molecular monolayers enable controllable surface functionalization and can be used to isolate and to study individual molecules [38], [39], [40]. Self-assembly is made even more powerful when combined with patterning. Currently, patterning of self-assembled monolayers (SAMs) is achieved through conventional, soft, or hybrid lithographies [41], [3], [42], [4], [43]. SAMs can also be patterned by masking the surface with an inert material [44].

Graphene was selected as such a mask, as it is a material with relatively inert chemistry [45] and functions as an impermeable barrier against other molecules. The choice of graphene was also influenced by the number of techniques that enable the introduction of nanoscale pores of arbitrary size and location to graphene, including both e-beam bombardment and chemical approaches [9], [46], [47], [8], [48], [2], [49]. These techniques will ultimately provide flexibility in pattern shape and scale in accordance with the experimental design exemplified in the following example.

Other 2D materials like phosphorene and silicone are also expected to be usable as a masking material

### Example 2

### Selection of Gold as Substrate Material

Au (111) gold on mica: Much of gold-thiol SAMs are formed on the most abundant facet of gold, the (111) surface. Our initial experiments were done on this facet. In future iteration of the design, we could utilize surfaces with different morphologies. A potentially useful surface would be gold step edges (the (755) surface of gold is one such example), which would provide additional constraints to confine monomers. Further, gold can be evaporated onto nanostructured surface, perhaps with nano-scale trenches that could also be used to confine motion of the monomers. Materials other than gold can also be used, such as Silver (Ag).

### Example 3

### Production of A Spatially Patterned Monolayer on Gold with a Graphene Mesh

A first example “holey” graphene was fabricated according to the following process.

Graphene was produced Chemical Vapor Deposition (CVD) in which methane is flowed into a reaction chamber over a copper foil and the methane reacts to form graphene on the copper. The Graphene is then deposited on a SiO₂ substrate [50], [51], [52] to provide an exposed graphene layer. A thin layer of Au (2 nm) was then evaporated onto the exposed graphene layer. Subsequent annealing results in form a surface-bound Au nanoparticles. The Au nanoparticles catalyze oxidation of the graphene by oxygen in the air, thereby forming pores. The Au nanoparticles are then etched via brief immersion into an etchant solution

A thin protecting layer of poly(methyl methacrylate) (PMMA) is then added to facilitate transfer, and the “holey” graphene is transferred onto a Au111 substrate. The protecting layer is removed and samples are ready for characterization. Further annealing at 100° C. removes any excess solvent, and the covered Au111 substrate is now primed for molecular deposition.

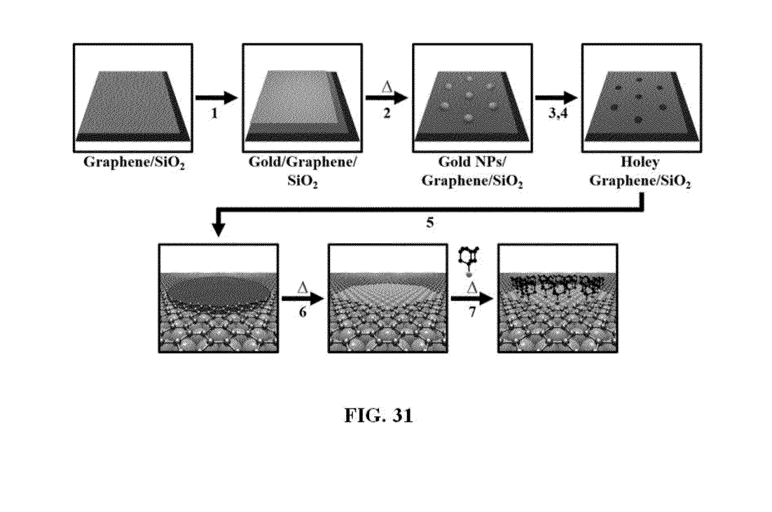

This process is shown schematically in FIG. 31. From a monolayer sheet of graphene on a SiO₂ substrate, (FIG. 31 step (1)) 2 nm of Au is deposited and (FIG. 31 step (2)) then annealed for 15 min at 350° C. (3) The Au is etched (KI/I₂, solution) for 30 sec and (4) washed in DI water for 30 sec. (5) “Holey” graphene is then transferred to a Au111/mica substrate and (6) annealed at 100° C. for 24 h. (7) The same substrate is then exposed to a vapor solution of 1-adamantanethiol (1AD) at 78° C. for 24 h for deposition.

Confirmation of the fabrication of porous graphene can be performed by techniques such as transmission electron microscopy (TEM). Confirmation of the

The steps of the above process are further illustrated in the following examples with additional exemplary experimental details.

### Example 4

### Graphene Synthesis and Deposition on SiO2 Support

Graphene was synthesized on a 25-mm-thick copper foil (99.8%, Alfa Aesar, Ward Hill, Mass.) that was treated with hydrochloric acid/DI water (1:10) (36.5-38.0%, Sigma-Aldrich, St. Louis, Mo.) for 30 min and rinsed by isopropyl alcohol (99.8%, Sigma-Aldrich, St. Louis, Mo.) for 10 min. After drying under an N₂ stream, the copper foil was loaded into the CVD furnace (1-inch tube diameter; Lindbergh/Blue M, Thermo Scientific, Waltham, Mass.). The system was pumped down to a vacuum of 10 mTorr in 30 min and refilled with 300 sccm H₂/Ar flow (25 sccm/475 sccm) and heated to 1040° C. within 25 min. Next, diluted methane and Ar were introduced into the CVD system for graphene growth at 1040° C. for 90 min (500 ppm methane in Ar, 35 sccm) with H₂/Ar (25 sccm/440 sccm). All process gases were supplied by Airgas, Inc (Burbank, Calif.).

Graphene was grown on both sides of the copper foil, and one side of the graphene/copper surface was spin-coated with PMMA (poly(methyl methacrylate); 495 PMMA C₂, MicroChem, Newton, Mass.) and baked at 140° C. for 5 min. The other side of the copper foil was exposed to O₂ plasma for 1 min to remove the graphene.

After that, the Cu foil was etched away using copper etchant (ferric chloride, Transene), resulting in a free-standing PMMA/graphene membrane floating on the surface of the etchant bath. The PMMA/graphene film was washed with HCl/deionized H₂O (1:10) and deionized water several times, and then transferred onto a 300-nm-thick SiO₂ substrate. After air-drying, the PMMA was dissolved by acetone and the substrate was rinsed with isopropyl alcohol to yield a graphene film on the SiO₂ substrate.

Other means of producing graphene and placing it on a substrate include exfoliation and synthesis directly on the substrate.

### Example 5

### Au Mediated Formation of Holey Graphene on the Graphene/SiO2 Substrate

A 2-nm-thick gold film was deposited using thermal evaporation onto the graphene/SiO₂ substrate. After annealing at 350° C. for 15 min, gold nanoparticles were found on the substrate. The holey graphene is oxidized by exposure to oxygen in the ambient air, with gold nanoparticles acting as the catalyst. The gold nanoparticles were removed by gold etchant (KI/I₂ solution, Sigma-Aldrich, St. Louis, Mo.) and washed with isopropyl alcohol and deionized water.

Additional techniques are expected to be suitable to create pores on the graphene mask such as by use of a triangulene monomer, or via e-beam lithographic methods (see Example 6 below).

### Example 6

### E-Beam Mediated Formation of Holey Graphene on a Graphene Mask

E-beam sculpting: provides one way to achieve controlled size and location of pore is to use an electron beam to bore pores where we desire them, as in Xu [2]. In Xu's implementation, an e-beam is used to sculpt a number of patterns, and the graphene is heated to 600 C so that small defects are repaired. To utilize this process for surface mediated synthesis, the sculpting would either have to happen on the target substrate (gold), or the pores would have to be premade before transfer to the substrate and selectively revealed when a pore is needed.

### Example 7

### Preparation of a Gold Substrate

The gold substrates were prepared by evaporating a gold filament at high temperature onto a small piece of mica. These substrates can be purchased from Keysight (formerly Agilent).

### Example 8

### Transfer of Holey Graphene from the Graphene/SiO2 Substrate to the Au{111}

The graphene/SiO₂ was again spin-coated with PMMA, and the SiO₂ substrate was etched away using a buffered oxide etch. The PMMA-coated holey graphene was washed in deionized water and transferred to a deionized water bath. A H₂ flame-annealed (at a rate of 1 Hz, 10 passes) Au{111}/mica substrate (Agilent, Santa Clara, Calif.) was then used to scoop the PMMA-coated graphene from the water bath. The PMMA/g's raphene/Au substrate was allowed to air dry overnight, and then the PMMA was dissolved in acetone and the graphene/Au substrate was washed with isopropyl alcohol.

Second to the synthesis of the graphene itself, the transfer of the graphene to the target substrate is the most important process in minimizing undesirable features such as defects, folds, wrinkles, and strain. Improving the transfer method can alleviate some of these issues. Liang et al. point out several ways in which the transfer could be improved, including increasing the hydrophobicity of the target substrate, annealing the graphene/substrate complex before dissolving the PMMA, and using the modified “RCA Clean” method to get rid of residual agents [53], [54], [55], [56], [57]. While the above method patterns graphene destructively, other approaches can be used to employ bottom-up methods to graphene synthesis that enable the placement and design of desired structures with controlled pore shape and pitch [58], [49], [59].

### Example 9

### Characterization of Graphene Mask by Transmission Electron Microscopy

The effectiveness of graphene as a mask against adsorption depends on the integrity of the graphene. Defects, folds, wrinkles, and strain can all compromise the impermeability of the mask. Small defects and cracking permit penetration of adsorbates through to the underlying substrate. Folding leads to multilayered regions where a pore in one layer can be occluded by another layer that is not porous. A strained lattice could open gaps in the mesh and induce tearing at pores.

The morphology and structure of the graphene were therefore characterized with field emission high-resolution TEM (FEI Titan S/TEM), typically with an accelerating voltage at an accelerating voltage of 300 kV. The diffraction patterns were collected with accelerating voltages of 300 kV to assess whether the beam energy played a role in graphene surface changes. Specimens for TEM analysis were prepared by the same as the process of graphene transfer onto 200 mesh formvar/copper grids purchased from Ted Pella, Inc. (Redding, Calif.).

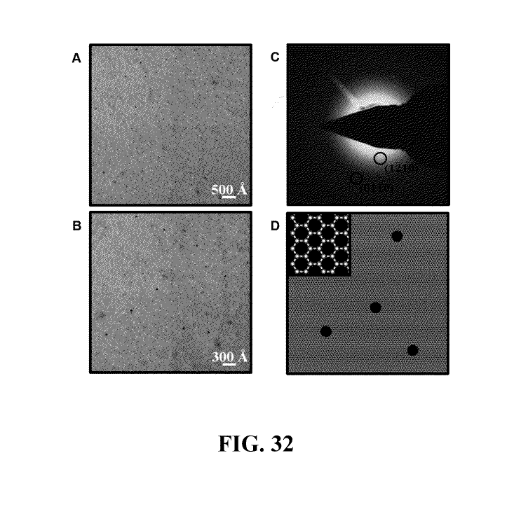

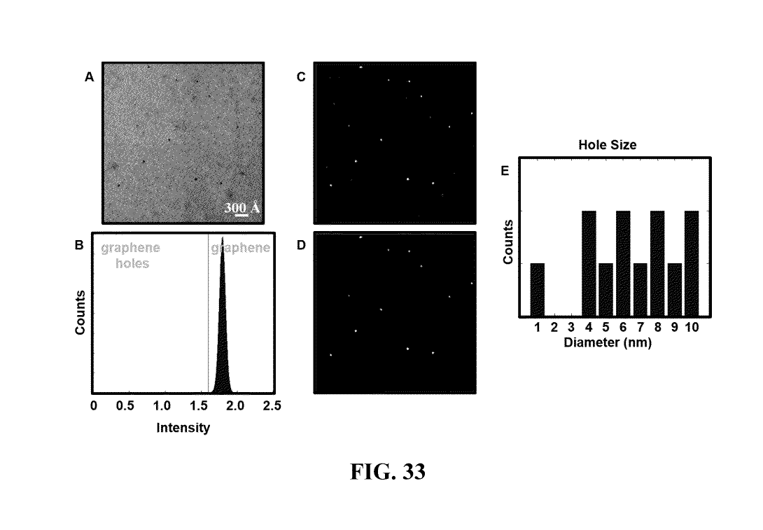

In particular the fabrication of porous graphene by transmission electron microscopy (TEM), illustrated in FIG. 32 and FIG. 33 where TEM images show a graphene mesh with randomly distributed holes; measured holes have an average diameter of 37±8 Å. FIG. 23A and FIG. 32B show TEM images of holey graphene at different resolutions. FIG. 32C shows the diffraction of FIG. 32B and confirms the hexagonal pattern of the graphene, and FIG. 32D shows a schematic the holey graphene with randomly distributed holes. Images also depict cracks in the graphene induced by the transfer and annealing processes.

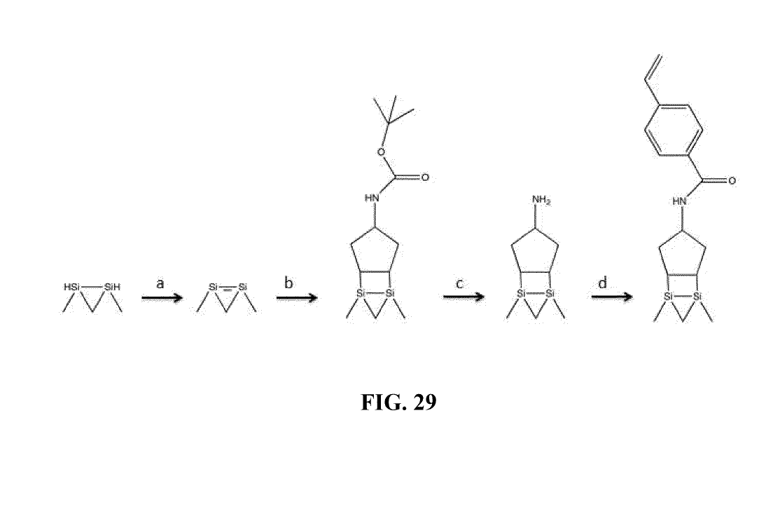

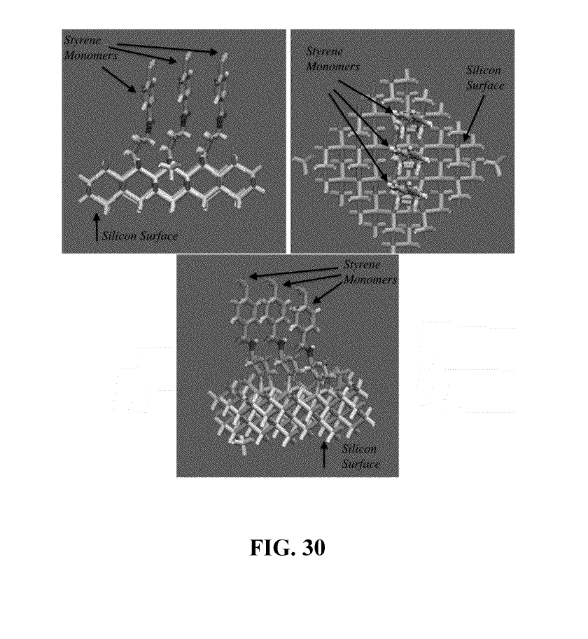

FIG. 33 shows how the size of the holes was determined. FIG. 33A shows a TEM image of the holey graphene, and FIG. 33C and FIG. 33D are thresholded images that pick out the holes in the graphene. FIG. 29B shows a histogram of the intensity values of the TEM in FIG. 33A, and the gray vertical line denotes the cutoff for the thresholding. FIG. 33E shows the histogram of hole sizes.

### Example 10

### Characterization of Graphene Mask on the Final Gold Substrate

Graphene is known to retain the surface morphology of the substrate on which it was synthesized even when attached to the PMMA overlayer [53]. When transferred to the final substrate, the morphology and structure of the graphene results in gaps between the graphene and the substrate that can cause folding and cracking when the PMMA is removed.

Water caught between the graphene and the substrate can leave gaps between the graphene and substrate upon drying that leads to folds, thereby appearing like graphite in images [53]. After the mesh is successfully transferred to Au111 and annealed, scanning tunneling microscopy (STM) can be used to probe the local environment.

The scanning tunneling microscope provides a window into the nanoscopic world, where constant-current imaging measures a convolution of electronic and topographic structure as a function of position across surfaces [60], [61], [62]. Measurements are recorded on a custom-built, ultrastable microscope held at ambient temperature and pressure [63].

Accordingly, holey graphene was deposited onto flame annealed, commercially available Au{111} on mica substrates. Samples were then imaged and then subsequently annealed at 100° C. for a period of 24 h in a gasketed glass v-vial (Wheaton, Millville, N.J.). Samples were heated in a chamber of a Barstead Thermolyne 1400 furnace (ThermoFischer Scientific, Waltham, Mass.). Samples were taken out and imaged with the STM,

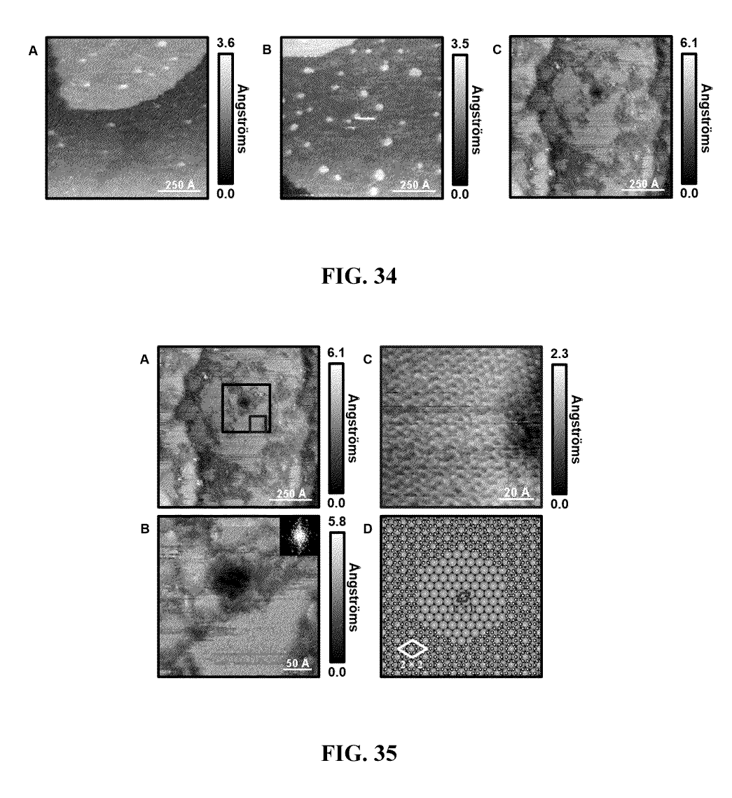

Scanning tunneling micrographs of the graphene before annealing are shown in FIG. 34, where a large depression (pore) is shown in the center of the image that is surrounded by other pores filled with residual solvent from the transfer step (FIG. 34A and FIG. 34B). Annealing removes the solvent within the pores (FIG. 34C).

Scanning tunneling micrographs of the annealed graphene-gold surface are shown in FIG. 35, where images depict porous graphene with hole diameters that match TEM measurements (FIG. 35A and FIG. 35B). The surrounding graphene Moire pattern shows a sixfold symmetry with a nearest-neighbor distance of 5.0±0.5 Å, which is in good agreement with the predicted and energetically favorable (2×2) superstructure for graphene on a Au111 substrate [64]. FIG. 35C shows the graphene lattice and FIG. 35D is a schematic of graphene with a pore in the center covering the gold surface.

### Example 11

### Characterization of the Structure of the Graphene Mask on the Au Substrate

The structure of graphene on Au111 is difficult to predict and likely to be locally varied, where measured superlattices are highly influenced by both the underlying Au substrate and the detailed structure of the STM tip [50], [65]. With this caveat in mind, acquired STM images confirm a single transferred layer of holey graphene with exposed Au regions, where image differences were quantified in real and Fourier space. Thresholding and masking techniques, performed in MATLAB, enable gold and graphene regions to be segmented and compared.

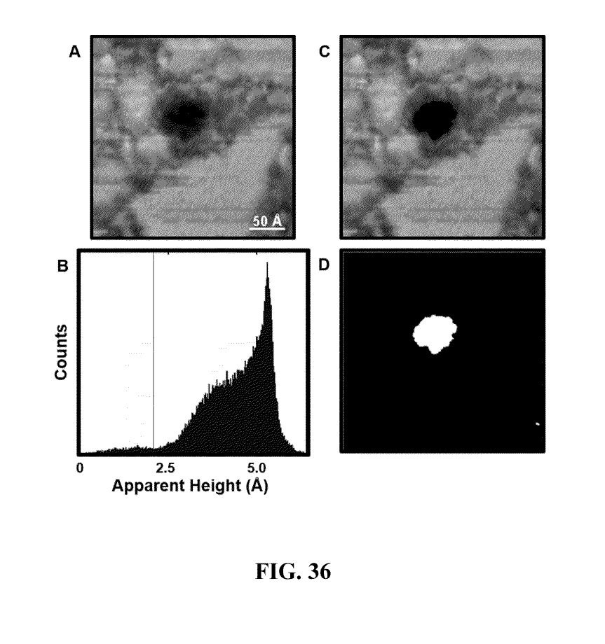

An exemplary illustration of MATLAB computation in view of the STM images is reported in FIG. 36. In STM images of the illustration of FIG. 36, under the conditions used, graphene layers are 2.1±1.1 Å more protruding in apparent height compared to exposed Au regions. FIG. 36A is an STM image of a hole in the graphene layer. FIG. 36B shows a histogram of apparent heights as determined by pixel intensity, and the vertical gray line denotes the cutoff value to be used in thresholding. FIG. 36C is the STM image that is thresholded to generate FIG. 36D, which picks out the pore from the surrounding graphene.

### Example 12

### Scanning Tunneling Micrograph Imaging

All Scanning Tunneling Micrograph measurements were performed in air using a custom beetle-style STM and a platinum/iridium tip (80:20) [63]. The known lattice of 1-dodecanethiolate SAMs on Au{111 } was used to calibrate the piezoelectric scanners. The sample was held between −1 V to −0.1 V bias range, and 256×256 pixel images were collected, at varying size, in constant-current mode with a tunneling current ranging from 2 to 80 pA. There is a strong tip dependence for imaging cage molecules, as reported previously.

### Example 13

### Scanning Tunneling Micrograph Image Analyses

All STM images were initially processed with automated routines developed in MATLAB (Mathworks, Natick, Mass.) to remove any high-frequency noise and intensity spikes that can otherwise impair reliable segmentation [61]. Images used to obtain nearest-neighbor spacings were resized to account for drift at room temperature. Transmission electron microscopy images were thresholded to segment both graphene holes and the graphene layer that was used to create a binary mask, where the average diameter of the holes was computed. The nearest-neighbor spacing of graphene in the pre-1AD-deposition and post-1AD-annealing images was computed in Fourier space. The spacing of 1-adamantanethiol and the surrounding graphene was determined by fitting centroids to molecularly resolved image areas and calculating the distances between them. Apparent height was used to determine thresholding values that then created a binary mask for image segmentation.

### Example 14

### Patterning of a 1-Adamantanethiol on a Holey Graphene/Gold Substrate

1-Adamantanethiol (1AD): In the first experiment to demonstrate the potential of graphene to serve as a mask against molecular deposition, Applicants used 1AD, a thiolated diamonoid. It was selected because it is a small, rigid structure with a well-defined lattice constant

The diamondoid 1AD is ideal for an initial patterning test, in that it is commercially available, forms well-ordered monolayers with few defects (due to limited degrees of freedom), and has a well-defined nearest neighbor spacing [66], [67], [68], [69].

Therefore, the same sample of Examples 8 and 10 is exposed to an ethanolic vapor solution of the self-assembling cage molecule 1-adamantanethiol (1AD) and subsequently imaged.

In particular, following deposition and annealing of graphene on gold substrate, samples were placed back into a clean v-vial above a solution of 1 mM commercially available 1-adamantanethiol (Sigma-Aldrich, St. Louis, Mo.) in ethanol for vapor deposition. Vials were placed back into a preheated furnace at 78° C. for a period of 24 h. Inserted 1-adamantanethiolate holey graphene samples were taken out for STM imaging. After sufficient experiments were performed, samples were placed back into a preheated furnace at 250° C. for a period of 24 h for molecular desorption. Samples were then taken out for subsequent imaging and desorption confirmation.

### Example 15

### Characterization of a 1-AD Patterned Holey Graphene/Gold Substrate

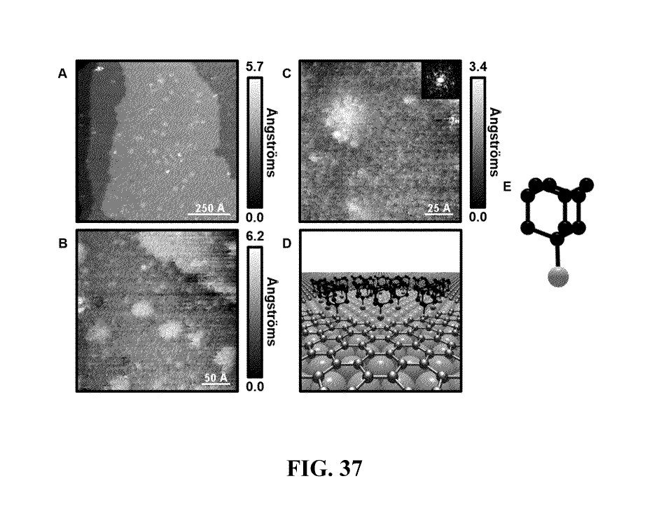

Scanning tunneling micrographs of the 1-AD holey graphene/gold substrate obtained with Example 10 recorded after deposition show islands of molecular protrusions consistent with the diameters of the pores as shown in the illustration of FIG. 37.

FIG. 37A, FIG. 37B, and FIG. 37C show the island protruding from the surrounding graphene. FIG. 37D is a schematic showing the island of 1AD formed in a pore of graphene over the gold surface. Nearest-neighbor distances within measured molecular protrusions are (7.4 A), near the previously recorded distances of 1AD (6.9 A) on Au111 that is most consistent with a (5×5) arrangement within pores [65], [70].

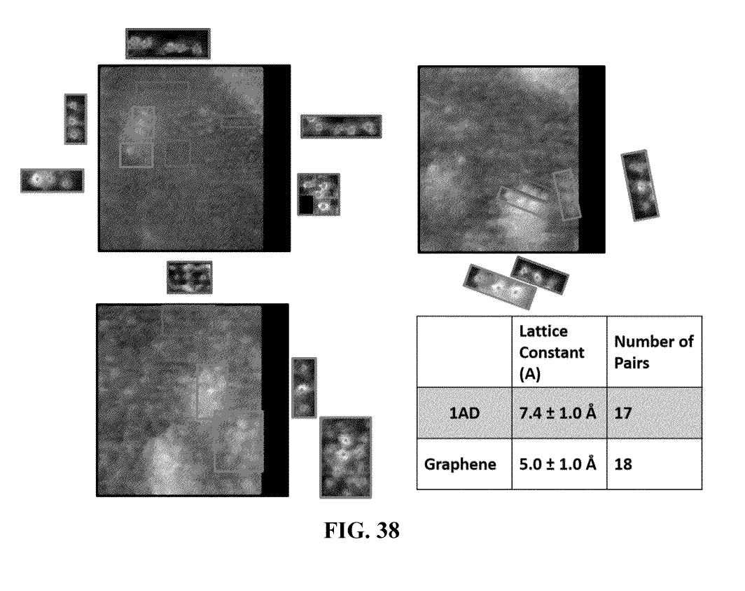

Reference is made to the illustration of FIG. 38 where the inserted molecular layer shows an average spacing (across multiple images) of 7.4±1.0 Å, while the graphene mask shows an average spacing of 5.0±01.0 Å.

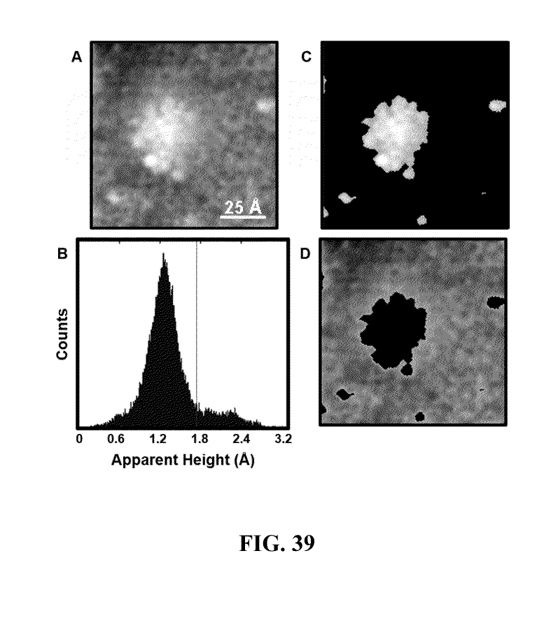

Analyses performed show a similar nearest-neighbor spacing, across numerous images, of the surrounding graphene overlayer (5.0±01.0 Å). Image masking techniques performed enable molecular regions to be analyzed separately from graphene regions as shown in the exemplary illustration of FIG. 39, where 1AD patches show an apparent height difference of 1.1±0.5 Å under the STM imaging conditions used. FIG. 39A shows an island of 1AD surrounded by graphene. FIG. 39B shows a histogram of heights as determined by pixel intensity and the gray vertical line denotes the height cutoff to discriminate between graphene and the island. FIG. 39C shows the image in FIG. 39A when heights above the cutoff are retained. FIG. 39D shows the image of FIG. 39A when heights below the cutoff are retained. Measured spacings, both in the lateral and surface normal (apparent height) directions, and consistent hole diameters confirm the blocking effect of the graphene layer. The same samples are then annealed again to test if molecular desorption can be achieved, and thus if the bare surface in the pores of the graphene mask can be regenerated.

Scanning tunneling topographs before and after this second anneal, to 250° C., are shown in FIG. 40, where evidence of molecular desorption [36], [71], [72] is obtained. Once filled holes are now empty and the hexagonal spacing of 5.0±0.5 Å is recovered outside graphene pores. FIG. 40A shows a low-resolution image of the pores filled with 1AD. FIG. 40B shows a schematic of the annealing process, where the pore in the graphene that reveals the gold was formerly occupied by 1AD molecules, denoted by the partially transparent 1ADs. FIG. 40C and FIG. 40D show the surface after annealing, one of the observations being that the pores are now empty. The inset in FIG. 40D is the fast Fourier transform of the image which shows many low frequency modes owing to the irregularities in the image, but also shows a six-fold symmetry at the modes expected for graphene. Thus, the fast Fourier transform confirms the hexagonal structure of the graphene and a lattice constant of 5.0 Å.

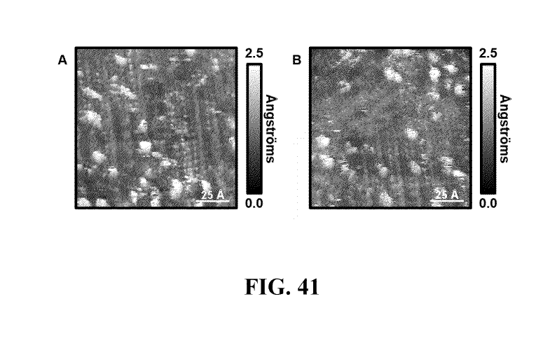

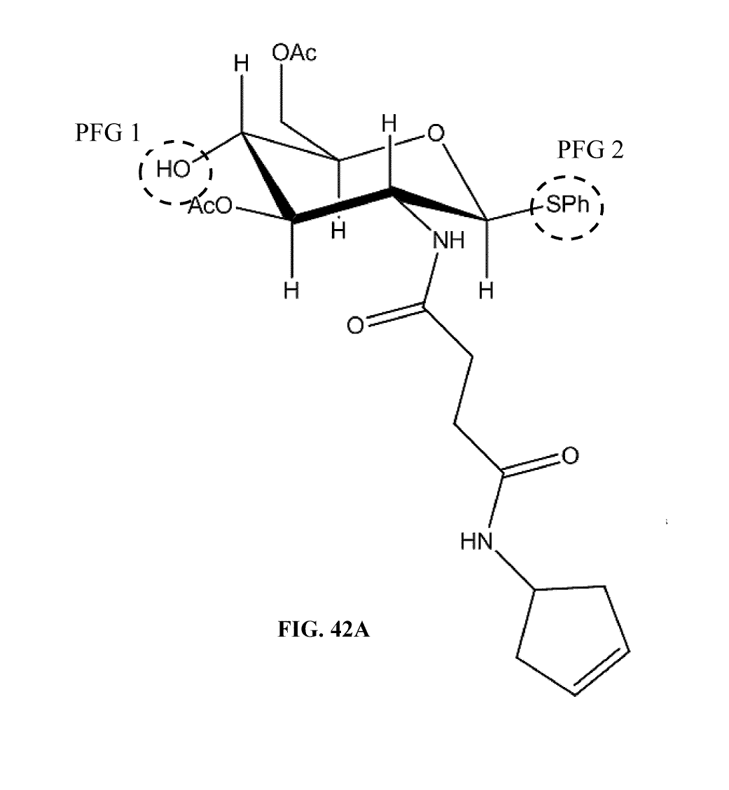

Desorption was confirmed by topographic imaging, where the mask is destructively regenerated and thus prepared for further molecular deposition steps (FIG. 41). Non-destructive methods such as displacement techniques can also be applied, since 1AD has been shown to be labile upon exposure to more strongly bound self-assembling molecules [68], [69].

### Example 16

### Use of Thiolated Molecules in “Holey” Graphene Mask

Thiolated molecules are expected to be used to pattern a gold surface masked with a “holey” graphene. It has been established that a thiolated molecule deposited on the Au(111) surface exhibits a strong affinity for gold, allowing immobilization on the gold surface to form a Self-Assembled Monolayer (SAM).

Battaglini et. al. have demonstrated materials that can be used to mask the gold surface to pattern the deposition of a SAM ([44]). Graphene was selected to be used as masking material in application with thiolated monomers because graphene was expected not to bind the thiolated nucleosides. It was also expected that the common thiolated molecules used to form SAMs would also be compatible with graphene. These thiolated molecules include long chain thiols (hexane, octane, decane, dodecanethiol etc.) with and without functional groups like amines, alcohols, and carboxylic acids, as well as cage molecules like 1-Adamantanethiol.

Several groups have demonstrated pore formation in graphene at the nanometer scale ([2]).

### Example 17

### Thiolated Nucleoside Phosphoramidite

The phosphoramidite is the standard chemistry used for DNA synthesis, but the thiolation allows for the immobilization on the gold surface. A chemical structure of one of such monomers (thiolated thymidine phosphoramidite) is included below with formula (I)

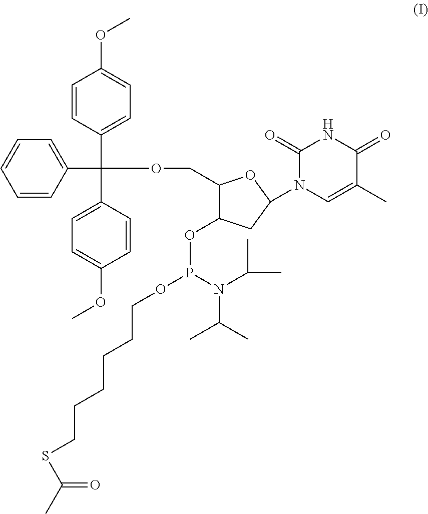 [SMILES: COc1ccc(C(OCC2OC(n3cc(C)c(=O)[nH]c3=O)CC2OP(OCCCCCCSC(C)=O)N(C(C)C)C(C)C)(c2ccccc2)c2ccc(OC)cc2)cc1]

In the compound of Formula (I) an alkane chain is terminated with an acylated sulfur. When exposed to a gold surface, acetyl group will be cleaved and the sulfur will bind to the gold, resulting in a surface-tethered nucleoside phosphoramidite. Different versions of this molecule can be used. Key is that a sulfur is present and that it is protected (acylation) so that it does not interact chemically with the nucleoside in any way. The linker needn't be a Cn chain. This chain was chosen for its similarity to the SATE group [73], which can be removed via cycloelimination. Alternative linkers could include acetylenes, benzenes, cage molecules, fullerenes, and additional linkers identifiable by a skilled person.

### Example 18

### DNA (GATA) Synthesis Via the Graphene-Gold Method

The following steps can be used to prepare a DNA molecule on gold surface as patterned by electron-beam sculpted graphene.

1. An Au(111) surface can be prepared via vapor deposition of gold onto freshly cleaved mica substrate and hydrogen flame annealing to remove impurities. Alternatively a gold mica substrate can be purchased from KEYSIGHT technologies (catalog No. N9805A Gold substrate, annealed Au 1.0×1.1cm on mica 1.4×1.1 cm);

2. A CVD graphene can be prepared and transferred onto the gold mica substrate via the PMMA method as the following. Graphene was synthesized on a 25-mm-thick copper foil (99.8%, Alfa Aesar, Ward Hill, Mass.) that was treated with hydrochloric acid/DI water (1:10) (36.5-38.0%, Sigma-Aldrich, St. Louis, Mo.) for 30 min and rinsed by isopropyl alcohol (99.8%, Sigma-Aldrich, St. Louis, Mo.) for 10 min.

After drying under an N₂ stream, the copper foil was loaded into the CVD furnace (1-inch tube diameter; Lindbergh/Blue M, Thermo Scientific, Waltham, Mass.). The system was pumped down to a vacuum of 10 mTorr in 30 min and refilled with 300 sccm H₂/Ar flow (25 sccm/475 sccm) and heated to 1040° C. within 25 min. Next, diluted methane and Ar were introduced into the CVD system for graphene growth at 1040° C. for 90 min (500 ppm methane in Ar, 35 sccm) with H₂/Ar (25 sccm/440 sccm). All process gases were supplied by Airgas, Inc (Burbank, Calif.).

Graphene was grown on both sides of the copper foil, and one side of the graphene/copper surface was spin-coated with PMMA (poly(methyl methacrylate); 495 PMMA C2, MicroChem, Newton, Mass.) and baked at 140° C. for 5 min. The other side of the copper foil was exposed to O₂ plasma for 1 min to remove the graphene. After that, the Cu foil was etched away using copper etchant (ferric chloride, Transene), resulting in a free-standing PMMA/graphene membrane floating on the surface of the etchant bath. The PMMA/graphene film was washed with HCl/deionized H₂O (1:10) and deionized water several times, and then transferred onto the gold mica substrate. After air-drying, the PMMA was dissolved by acetone and the substrate was rinsed with isopropyl alcohol to yield a graphene film on the gold mica substrate.

3. An electron-beam sculpting can be used to bore a first set of one pore on the graphene film on the gold mica substrate as shown in FIG. 16A step 3. A FEI Titan transmission electron microscope operated in STEM mode at 300 kV with a current density of 10⁷ electrons/nm²s is used for sculpting at 600° C.

To calculate the CW of the nucleotides, molecule models can be created for the constituent monomer units and the distance between monomer polymerizing functional groups can be calculated from performing molecular modeling. The molecule model can be constructed using experimental data, such as crystal structures of the constituent monomer units, or from theoretical models constructed for the constituent monomer units. The model structures used for the calculation of CW are taken from an equilibrium conformation ensemble, where the structures of the monomers are in thermal equilibrium. CW values can be calculated as a single value using a reprehensive equilibrated structure from the equilibrium conformation ensemble or as an average of multiple CW values calculated from a multiple equilibrated structures.

4. A thiolated oligomer terminated with a guanosine (G) phosphoramidite can be deposited as schematically shown in FIG. 16A step 4 on the first set of one pore so that it binds to the area where gold has been revealed in FIG. 16A step 3. The deposition was performed by incubating a thiolated guanosine (G) phosphoramidite-terminated oligo in a solution in acetonitrile at room temperature. The nucleoside phosphoramidites are very sensitive to water and atmosphere. To maintain competence, they can be protected from exposure by being placed under inert atmosphere, typically Nitrogen or Argon

5. Electron-beam sculpting can be used to bore a second set of two pores on the same graphene film on the gold mica substrate as shown in FIG. 16A step 5. Deposit a thiolated adenosine (A) phosphoramidite-terminated oligo as shown in FIG. 16A step 6 on the second set of two pores so that it binds to the area where gold has been revealed in FIG. 16A step 5.

STEM can be used in the second round of electron-beam sculpting to determine the center of the first set of pores that have already been occupied and adjust the requisite distance and direction based on the previously calculated CW values to create the second set of pores.

6. Electron-beam sculpting can be used to bore a third set of one pore on the same graphene film on the gold mica substrate as shown in FIG. 16A step 7. Deposit a thiolated thymidine (T) phosphoramidite-terminated oligo as shown in FIG. 16A step 8 on the third set of one pore so that it binds to the area where gold has been revealed in FIG. 16A step 7.

Similarly, STEM can be used once again in the third round of electron-beam sculpting to determine the center of the first and second sets of pores that have already been occupied and adjust the requisite distance and direction based on the CW values to create the third set of pores.

7. Deposition, order, sequence or orientation of the monomers on the substrate in step 8 in FIG. 16A can be verified based on images obtained by scanning probe microscopy. F

8. An electric field can be applied on the surface such that it will orient phosphoramidite groups in all the bound oligomers on the surface in the same direction for the coupling reaction.

9. Polymerization can be initiated by activation and coupling the bound monomers on the substrate: detritylation with 3% trichloroacetic acid in dichloromethane 50 seconds, washing with acetonitrile for 30 seconds, coupling in 0.5 M tetrazole in acetonitrile for 30 seconds, and washing with acetonitrile.

10. The formed DNA can be removed from the substrate by annealing at 100 C.

11. The removed DNA can be prepared and amplified by Polymerase Chain Reaction (PCR).

### Example 19

### Parallel AG DNA Synthesis on Structured Surfaces

Parallel AG DNA shown in FIG. 16B can be prepared according to a similar approach as described in Example 18 with reference to the GATA DNA synthesis.

The AG DNA synthesis differs from the GATA DNA synthesis in that rather than boring one pore for each deposition, an entire column of pores is bored for each deposition, as shown in FIG. 16B. The pores in the same column are spaced at such a distance so that no intra-column reactions can take place. The polymers are designed to form by linking the constituent monomers horizontally in rows.

In this example, the monomer binding distance can be calculated from the CW values of two adjacent nucleotides. The CW values of the nucleotides can be calculated in a similar way as previously described with reference to the GATA synthesis using molecular modeling. STEM can be used to determine the center occupied set of pores and adjust the requisite distance and direction based on the CW values to create the next set of pores.

### Example 20

### “Holey” Graphene Mask Layers for DNA Synthesis

Patterning attaching and coupling constituent monomers of nucleotides using graphene can be performed by producing pores in graphene prior to its transfer to the substrate and selectively reveal pores as they are needed.

In an exemplary approach can be done by using a masking system of graphene with different pores. A deposition with four molecules would require four layers. The layer closest to the substrate can have all pores for each of the four bases (A, G, C, and T). The layer on top of that would have pores for only 3 of the 4 bases (A, G, and C, for example). The next layer would have pores for only 2 of the four (A, and G), and the top layer would have pores for only the one of the four (A).

In this example, the pores in the mask are pre-formed before being transferred to the surface. The distances between two adjacent pores on each mask layer are determined as either equal to the monomer binding distance or a multiple times of the monomer binding distance depending on the number of monomers binding regions located in between. For example, the two pores in mask 2 of FIG. 17 are separated by twice the monomer binding distance as there is one additional monomer binding region located between them.

The pore formation process can be carried out automatically, using appropriate instruments to produce a pore or a set of pores, performing STEM imaging to determine the center of the pores, and moving automatically in a desired direction based on the calculated distances to produce the next set of pores.

Initially, only the pores for the A are revealed on the substrate. A's are introduced and they bind the substrate, occupying those pores. The first layer of graphene is removed, leaving the A's occupying their pores, and revealing the pores for the G's. The G's are deposited, and the next layer is removed, revealing the pores for the C's. The C's are deposited, and the next layer is removed, revealing the pores for the T's. With all molecules deposited, polymerization can then be initiated.

This process of using separate layers of holey graphene masks for DNA synthesis described in the current example is depicted in FIGS. 17, 17, and 19.

In FIG. 17, the four separate masks that will be stacked on one another are shown separately as mask 1, mask 2, mask 3, and mask 4. Mask 1, which will be positioned on the top of the stack farthest from the substrate, has on pore. Mask 2, the second farthest from the substrate and positioned immediately underneath mask 1, has two pores. Mask 3, positioned immediately underneath mask 2, has three pores. Mask 4, which is the bottom mask closest to the substrate, has all four pores.

FIG. 18 shows a schematic of the how the four masks are stacked together. Mask 3 is placed on top of mask4; mask 2 is placed on top of mask 3 and mask 4; mask 1 is placed on top of the other three masks.

FIG. 19 shows the process of patterned deposition using the stacked masks. The stacked four masks are placed on top of a gold substrate. The first monomer A is deposited (shown as +A). Mask 1 is removed from the top of the stacked masks, revealing a second pore, where the second monomer G is deposited (shown as +G). Next, mask 2 is removed, revealing a third pore, where the third monomer C is deposited (shown as +C). Finally, mask 3 is removed, revealing a fourth pore, where a fourth monomer T is deposited (shown as +T). Polymerization then follows the last deposition step.

### Example 21

### Hydrogen Depassivation Lithography

In this exemplary approach to activate a passivated surface, a scanning tunneling microscopy (STM) probe is passed over a hydrogen-passivated silicon surface to remove a single hydrogen and reveal a highly reactive dangling bond.

This dangling bond can then serve as a binding point for a target molecule. This approach is characterized by high control over spatial precision. [15, 16]

### Example 22

### Silicon-Hydrogen Coating Methods and Systems

In systems involving the Si (100) or Si (001) surface, the site-specific binding of molecules to the surface can be achieved through the dimer pairs that are characteristic of the Si (100) and Si (001) surfaces.

In other cases, the removal of a single hydrogen from a surface would leave a highly reactive dangling bond (a free radical). This bond would react with any part of a molecule that comes in touch with it, leaving no assurance that the attached molecule would be competent for subsequent synthetic chemistry. The dimer pair helps us get around this problem. By removing both hydrogens in a dimer pair, the resulting free radicals combine to form a weak Pi-bond. This bond is much less promiscuous and will selectively react with functional groups that favor double bonds. While this approach has been well-described in Silicon, it can also be applicable to other surfaces with dimers pairs such as Germanium.

In accordance with the above approach hydrogen provides a coating that masks the natural reactive state of the Si (100) and Si (001) surfaces where either radicals or dimers can react with molecules that come into contact with it. To achieve site-specific additions, the surface is passivated (made non-reactive) and revealed when ready. The Si (100) and Si (001) surfaces can be passivated by exposure to hydrogen that binds the radicals and dimer pairs. Other materials could be used as mask so long as they are themselves inert and removable via STM lithography.

### Example 23

### Silicon Surface Presenting a Substituted Cyclopentene Anchor

In an exemplary approach a substituted cyclopentene is expected to be usable as an anchor for monomer binding on silicon surface.

The first generation of this anchor will be a substituted cyclopentene, specifically tert-Butyloxycarbonyl 1-Amino-Cyclopentene. The key component of these cyclopentenes is the double bond at its base. This double bond participates in a [2+2]-like cylcoaddition across the dimer pair on the Silicon surface to yield a cyclopentane that is bonded in two places to the Silicon surface. In order to then attach the monomer of interest to the anchor, the cyclopentene is functionalized with a moiety that allows for crosslinking. This moiety is the amino group. The amine has been shown to interact with the Silicon dimer pair. However, if unprotected, this amine could bind the Silicon surface in place of the double bond in the pentene ring, rendering it unable to anchor a monomer. To avoid this, the amine is protected by the tert-Butyloxycarbonyl group that prevents the interaction of the amine with the Silicon surface and itself does not interact with the Silicon.

The BOC group is removed by exposure to an acid, revealing the amine and rendering it ready to bind a monomer. In order to bind different molecules in a particular order, Applicants intend to use orthogonal protections and/or functional groups. By having orthogonal chemistries, Applicants can deposit all the anchor molecules in order in one step, and then bind all the monomers in a second step. An example of a protection group orthogonal to BOC is the 4,4-Dimethyl-2,6-Dioxacylohexadiene group. In the first round of experiment, Applicants intend to use 1-Amino-Cyclopentadiene orthogonally protected by both of these groups. Alternatively, one can use orthogonal functional groups to bind different molecules. Rather than an amine, for example, other groups such as hydroxyl, carboxyl, thiols, alkynes can be used keeping in mind that either the functional groups selected does not interact with the silicon surface, or is protected by use for example of protection group.

### Example 24

### Orthogonally-Protected Monomer Anchors Placed on Silicon Surfaces

Orthogonally-protected functional groups at specified locations afford additional control over the coupling reactions on the surface.

The addition of orthogonally-protected functional groups is expected to be performed according to the following procedure.

1. Prepare and passivate Si (100) surface with hydrogen; 2. use STM to remove both hydrogens from a single dimer pair, producing a weak Pi bond that is prone to a [2+2]-like cycloaddition; 3. in the vapor phase, introduce BOC-1-ACP to bind the Silicon dimer pair; 4. verify deposition via STM imaging, possibly use STM to remove mis-bound anchor molecules (correction mechanism); 5. repeat steps 2-4 with orthogonally-protected 1-ACP (Dde-1-ACP); 6. remove functionalized Silicon from STM; 7. remove BOC protection group by acid treatment; 8. couple first monomer to revealed amine; 9. remove Dde protection group; 10. couple second monomer to revealed amine; 11. orient monomers using e-field; 12. polymerize monomers; 13. remove polymer from surface.

In some embodiments, multiple STM tips are configured to work to remove hydrogens in parallel. This could be done either with independently operated tips, or by an array of tips that operates as a single unit.

In another embodiment, anchor molecules can bind multiple monomers. While BOC-1-ACP binds one monomer through its single amine group, a 2,5-diaminocycopentene binds two such monomers to the two amino groups. In still other embodiments anchor molecules allow for many different monomers to be placed with a single lithographic event.

### Example 25

### Surface Mediated Synthesis of an Oligosaccharide Homopolymer on the Si (100) Surface

In the example described herein, the monomer deposited for the synthesis of oligosaccharide homopolymer is D-glucose (FIG. 1A), a common saccharide to many natural oligosaccharides including amylose, cellulose, and glucogen.

The oligosaccharide homopolymer described in this example is formed by β-1,6 linkages between monomers. The term “β” refers to the stereochemistry of the bond between two monomers. An axial attachment is referred as a “α” label while an equatorial attachment is referred to as a “β” label. “1” and “6” refer to the positions of the carbon atoms in the monomers, where the anomeric carbon is labeled as the 1^{st} carbon and the extra-ring carbon is labeled as 6^{th} carbon. The free hydroxyl bonded to the 6^{th} carbon is bonded to the anomeric carbon.

In such cases, surface mediated synthesis can be used to bias products between α and β linkages through the attachment geometry of the monomer. To bias products between α and β linkages, the linkage would have to present one side of the anomerica carbon to the adjacent monomer polymerizing functional group. To do this, the monomer can be anchored in such a way that it is “tipped” to present one side. For example, a secondary linker that is shorter relative to the first can be used to achieve such effect.

The characteristic width of the D-glucose monomer is the distance between the anomeric carbon and the hydroxyl on the 6^{th} carbon. The hydroxyl can rotate so the characteristic width varies between 3.3 Å and 4.3 Å. The minimum allowable spacing of the Si(100) surface is about 3.8 Å. The D-glucose monomer can adopt different low energy side-chain conformations referred to as rotamers. Such conformational orientations can cause variation in the the characteristic width. For some conformations, the CW is less than the MAS. In others, the CW is greater than the minimum allowable spacing in some cases. So long as there are accessible conformations in which the CW is greater than the MAS, long-range polymerization is achievable. The D-glucose monomer in one of these confirmations is placed on the silicon surface adjacent to another monomer, and the monomer polymerizing functional groups are close enough to react (see FIG. 1B). It is also noted that in FIG. 1B, a linker is used to attach the monomers to the surface. The linker is a three-carbon chain terminated with a carbonyl group. This would be the product if the NHS ester were used to couple the monomer to the amine on the surface.

It is noted that many oligosaccharides share the same basic structure (6-membered ring of carbon atoms) and engage in 1,6 linkages between monosaccharides. Therefore, Si (100) surface system can generally be applied a large number of monomers for polymer synthesis involving 1,6 linkage. Polysaccharides with monosaccharides bonded through a 1,4 linkage, where the monomers have a characteristic width of about 3.6 Å (±5%), can also be synthesized on the Silicon system.

Synthesis of a dodecamer using a protected form of D-glucose was previously described in [74], where all other hydroxyls are protected in the monomer. The one bonded to the 6^{th} carbon is orthogonally protected with respect to the other hydroxyls so that it can be revealed when the monomer is to be involved in polymerization. The protection for the second carbon is the pivaloyl group, which is terminated with a tert-butyl. Extending one of the branches of the tert-butyl could serve as the linker. Such a linker is implemented in this example and used to attach to the 1-Amino-Cyclopentene that is bonded to the Si (100) surface.

In another embodiment, a lithographic chain reaction is included. In this scenario, a single hydrogen is removed, yielding a free radical, and when a molecule reacts with the radical, the first radical is quenched, and a second, adjacent radical is generated. In this way, a single lithographic event can result in many bound molecules. The reaction is so controlled that it occurs in the desired direction on the desired surface [20].

### Example 25

### Surface Mediated Synthesis of a Peptide on the Si (100) Surface

A tetrapeptide heteropolymer can be synthesized on a Si (100) surface according to the following approach. The characteristic width of a single amino acid is approximately 2.5 Å, much less than the minimum allowable spacing of the Si (100) surface, which is about 3.8 Å. As a result, long-range polymerization cannot occur as the two adjacent monomers are too farther apart. A dipeptide, however, can have a characteristic width of approximately 6 Å, which satisfies the minimal allowable spacing requirement of the Si (100) surface.

A first dipeptide participating in the polymerization process is a Leucine-Alanine dipeptide shown in the FIG. 2A and a second dipeptide is a Glycine-Valine dipeptide shown in FIG. 2B. The distance between the two monomer functional groups within each monomer (labeled with arrows) is approximately 6.0 Å. Surface mediate synthesis can be used to link these two dipeptides to form a tetrapeptide.

A linker can be attached to each dipeptide. In this example, the linker is attached to the a carbon, which bonds to a nitrogen, a carboxylic acid, a side chain group as well as a hydrogen. This hydrogen bonded to the a carbon can be replaced with the linker. In this example, C3 linker terminated with a carbonyl group is used for attaching the monomers to the surface.

When the bipeptides are attached to the Si(100) surface at two adjacent attachment sites, the functional groups of two adjacent monomers, which participate in the polymerization reaction, are presented in a proximity close enough to form covalent bonds (see FIG. 2C). Due to the disparity between the characteristic width of the bipeptide and the minimum allowable spacing of the surface, which is 2.2 Å (6 Å-3.8 Å), compensatory movement of the dipeptides is required to accommodate the steric interactions between two adjacent dipeptides. Such compensatory movement can be achieved by the dipeptides rotating in the place of the surface, or by bending the entire dipeptide so that it bulges upward away from the surface. For this example, the presence of the linker is sufficient to accommodate such conformational movement.

### Example 26

### Surface Mediated Polymerization of an Oligosaccharide Homopolymer

The surface mediated synthesis of polysaccharide can be performed by the coupling reaction of properly protected monosaccharide monomers on the surface. Each of the monosaccharide behaves both as a glycosyl donor and acceptor while being attached on the surface. Monosaccharide donors in polysaccharide synthesis include but are not limited to glycosyl halides, glycosyl acetates, thioglycosides, trichloroacetimidates, pentenyl glycosides, and glycals.

In one embodiment, a monosaccharide attached to the surface presenting a free hydroxyl group on the sugar ring and a thioether such as phenyl thioether at the anomeric position is described. Coupling between a hydroxyl group of one monomer to an anomeric carbon of an adjacent monomer with a thioether group can be initiated by an activating agent. A variety of activation methods can be employed for the thioglycoside coupling, including NIS/AgOTf, NIS/TfOH, IDCP (Iodine dicollidine perchlorate), iodine, and Ph2SO/Tf2O.

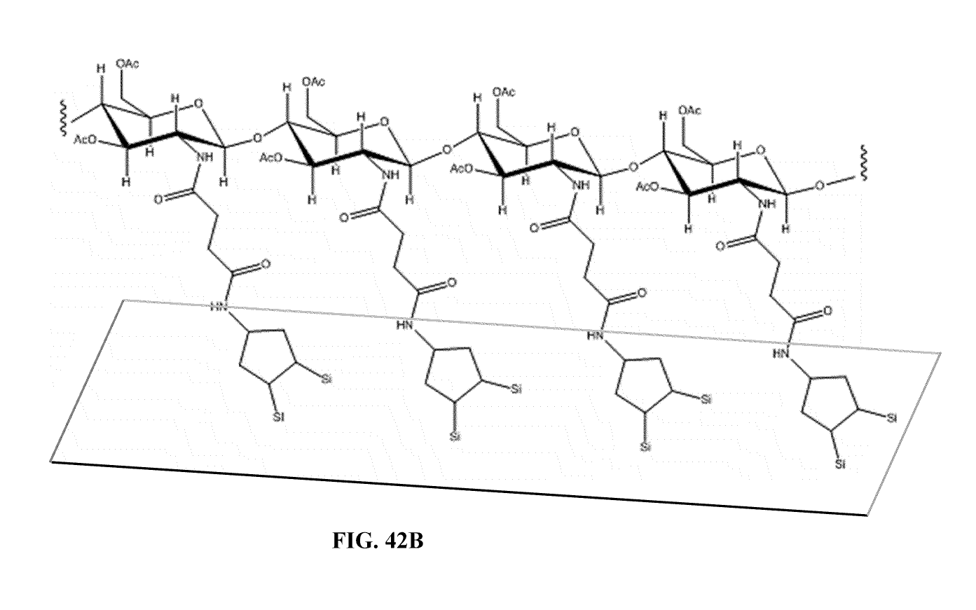

In an exemplary embodiment, an glucosamine properly protected and functionalized for attachment to the silicon surface is described in accordance with the schematic illustration of FIG. 42A which shows a chemical structure where the polymerizing functional groups (PFG1 and PFG 2) together with a linker.

Attachment of such a monomer to the silicon surface by 2+2 cycloaddition, followed by activation will produce a polysaccharide of the following structure of the silicon surface, as shown in the schematic illustration of FIG. 42B.

The examples set forth above are provided to give those of ordinary skill in the art a complete disclosure and description of how to make and use the embodiments of the molecular sieves, structure agents, methods and systems of the disclosure, and are not intended to limit the scope of what the inventors regard as their disclosure. Modifications of the above-described modes for carrying out the disclosure that are obvious to persons of skill in the art are intended to be within the scope of the following claims.

All patents and publications mentioned in the specification are indicative of the levels of skill of those skilled in the art to which the disclosure pertains.

The entire disclosure of each document cited (including patents, patent applications, journal articles, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

When a Markush group or other grouping is used herein, all individual members of the group and all combinations and possible subcombinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations which is not specifically disclosed herein.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

It is to be understood that the disclosures are not limited to particular compositions or chemical systems, which can, of course, vary. It is also to be understood that the terminology used herein is for the purpose of describing particular embodiments only, and is not intended to be limiting. As used in this specification and the appended claims, the singular forms “a,” an and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

Additionally, unless otherwise specified, the recitation of a genus of elements, materials or other components, from which an individual component or mixture of components can be selected, is intended to include all possible sub-generic combinations of the listed components and mixtures thereof. Also, “comprise,” “include” and their variants, are intended to be non-limiting, such that recitation of items in a list is not to the exclusion of other like items that can also be useful in the materials, compositions and methods of this disclosure.

Although any methods and materials similar or equivalent to those described herein can be used in the practice for testing of the products, methods and system of the present disclosure, exemplary appropriate materials and methods are described herein as examples and for guidance purpose.

In particular, it will be understood that various modifications may be made without departing from the spirit and scope of the present disclosure. Accordingly, other embodiments are within the scope of the following claims.

### REFERENCES

1. Yoshinobu, J., Physical properties and chemical reactivity of the buckled dimer on Si(100). Progress in Surface Science, 2004. 77(1-2): p. 37-70.
2. Xu, Q., et al., Controllable atomic scale patterning of freestanding monolayer graphene at elevated temperature. ACS nano, 2013. 7(2): p. 1566-1572.
3. Srinivasan, C., et al., Scanning electron microscopy of nanoscale chemical patterns. ACS nano, 2007. 1(3): p. 191-201.
4. Saavedra, H., et al., Hybrid approaches in nanolithography. Rep. Prog. Phys, 2010. 73: p. 036501.
5. Leong, W. S., C. T. Nai, and J. T. Thong, What Does Annealing Do to Metal-Graphene Contacts? Nano letters, 2014. 14(7): p. 3840-3847.
6. Allred, D. B., et al., Electrochemical Nanofabrication Using Crystalline Protein Masks. Nano Letters, 2005. 5(4): p. 609-613.
7. Radich, J. G. and P. V. Kamat, Making Graphene Holey. Gold-Nanoparticle-Mediated Hydroxyl Radical Attack on Reduced Graphene Oxide. ACS Nano, 2013. 7(6): p. 5546-5557.
8. Liu, J., et al., Fabrication of Graphene Nanomesh and Improved Chemical Enhancement for Raman Spectroscopy. The Journal of Physical Chemistry C, 2012. 116(29): p. 15741-15746.
9. Fischbein, M. D. and M. Drndié, Electron beam nanosculpting of suspended graphene sheets. Applied Physics Letters, 2008. 93(11): p. 113107.
10. Song, B., et al., Atomic-Scale Electron-Beam Sculpting of Near-Defect-Free Graphene Nanostructures. Nano Letters, 2011. 11(6): p. 2247-2250.
11. Puster, M., et al., Toward Sensitive Graphene Nanoribbon-Nanopore Devices by Preventing Electron Beam-Induced Damage. ACS Nano, 2013. 7(12): p. 11283-11289.
12. Kim, M., et al., Creating favorable geometries for directing organic photoreactions in alkanethiolate monolayers. Science, 2011. 331(6022): p. 1312-5.
13. Weck, M., et al., Ring-opening metathesis polymerization from surfaces. Journal of the American Chemical Society, 1999. 121(16): p. 4088-4089.
14. Bent, S. F., Organic functionalization of group IV semiconductor surfaces: principles, examples, applications, and prospects. Surface Science, 2002. 500(1-3): p. 879-903.
15. Randall, J. N., et al., Atomic precision lithography on Si. Journal of Vacuum Science & Technology B: Microelectronics and Nanometer Structures, 2009. 27(6): p. 2764.
16. Chen, S., et al., Patterning of sub-1 nm dangling-bond lines with atomic precision alignment on H:Si(100) surface at room temperature. Nanotechnology, 2012. 23(27): p. 275301.
17. Schofield, S. R., et al., Atomically Precise Placement of Single Dopants in Si. Physical Review Letters, 2003. 91(13).
18. Goh, K. E. J., et al., Using patterned H-resist for controlled three-dimensional growth of nanostructures. Applied Physics Letters, 2011. 98(16): p. 163102.
19. Lin, Z., et al., DNA Attachment and Hybridization at the Silicon (100) Surface. Langmuir, 2002. 18(3): p. 788-796.
20. Hossain, M. Z., H. S. Kato, and M. Kawai, Controlled Fabrication of 1D Molecular Lines Across the Dimer Rows on the Si(100)-(2×1)-H Surface through the Radical Chain Reaction. Journal of the American Chemical Society, 2005. 127(43): p. 15030-15031.
21. Novoselov, K. S., et al., Electric field effect in atomically thin carbon films. science, 2004. 306(5696): p. 666-9.
22. Allen, M. J., V. C. Tung, and R. B. Kaner, Honeycomb carbon: a review of graphene. Chemical reviews, 2009. 110(1): p. 132-145.
23. Bunch, J. S., et al., Impermeable atomic membranes from graphene sheets. Nano Lett, 2008. 8(8): p. 2458-62.
24. Berry, V., Impermeability of graphene and its applications. Carbon, 2013. 62: p. 1-10.
25. Prasai, D., et al., Graphene: corrosion-inhibiting coating. ACS nano, 2012. 6(2): p. 1102-8.
26. Nilsson, L., et al., Graphene coatings: probing the limits of the one atom thick protection layer. ACS nano, 2012. 6(11): p. 10258-66.
27. Schriver, M., et al., Graphene as a long-term metal oxidation barrier: worse than nothing. ACS nano, 2013. 7(7): p. 5763-5768.
28. Schneider, G. F., et al., DNA translocation through graphene nanopores. Nano letters, 2010. 10(8): p. 3163-3167.
29. Siwy, Z. S. and M. Davenport, Nanopores: Graphene opens up to DNA. Nat Nanotechnol, 2010. 5(10): p. 697-8.
30. Merchant, C. A., et al., DNA translocation through graphene nanopores. Nano letters, 2010. 10(8): p. 2915-2921.
31. Cohen-Tanugi, D. and J. C. Grossman, Water desalination across nanoporous graphene. Nano Lett, 2012. 12(7): p. 3602-8.
32. Russo, P., A. Hu, and G. Compagnini, Synthesis, properties and potential applications of porous graphene: a review. Nano-micro letters, 2013. 5(4): p. 260-273.
33. Ulman, A., Formation and Structure of Self-Assembled Monolayers. Chem Rev, 1996. 96(4): p. 1533-1554.
34. Poirier, G. E., Characterization of organosulfur molecular monolayers on Au (111) using scanning tunneling microscopy. Chemical reviews, 1997. 97(4): p. 1117-1128.
35. Smith, R. K., P. A. Lewis, and P. S. Weiss, Patterning self-assembled monolayers. Progress in Surface Science, 2004. 75(1): p. 1-68.
36. Love, J. C., et al., Self-assembled monolayers of thiolates on metals as a form of nanotechnology. Chemical reviews, 2005. 105(4): p. 1103-1170.
37. Claridge, S. A., et al., From the bottom up: dimensional control and characterization in molecular monolayers. Chem Soc Rev, 2013. 42(7): p. 2725-45.
38. Donhauser, Z., et al., Conductance switching in single molecules through conformational changes. science, 2001. 292(5525): p. 2303-2307.
39. Shuster, M. J., et al., Biospecific Recognition of Tethered Small Molecules Diluted in Self□ Assembled Monolayers. Advanced Materials, 2008. 20(1): p. 164-167.
40. Weiss, P. S., Functional molecules and assemblies in controlled environments: formation and measurements. Acc Chem Res, 2008. 41(12): p. 1772-81.
41. Gates, B. D., et al., New approaches to nanofabrication: molding, printing, and other techniques. Chem Rev, 2005. 105(4): p. 1171-96.
42. Willson, C. G. and B. J. Roman, The future of lithography: SEMATECH Litho Forum 2008. ACS nano, 2008. 2(7): p. 1323-8.
43. Liao, W. S., et al., Subtractive patterning via chemical lift-off lithography. science, 2012. 337(6101): p. 1517-21.
44. Battaglini, N., et al., Directed growth of mixed self-assembled monolayers on a nanostructured template: a step toward the patterning of functional molecular domains. Langmuir, 2012. 28(42): p. 15095-105.
45. Yan, L., et al., Chemistry and physics of a single atomic layer: strategies and challenges for functionalization of graphene and graphene-based materials. Chem Soc Rev, 2012. 41(1): p. 97-114.
46. Bai, J., et al., Graphene nanomesh. Nat Nanotechnol, 2010. 5(3): p. 190-4.
47. Song, B., et al., Atomic-scale electron-beam sculpting of near-defect-free graphene nanostructures. Nano Lett, 2011. 11(6): p. 2247-50.
48. Radich, J. G. and P. V. Kamat, Making graphene holey. Gold-nanoparticle-mediated hydroxyl radical attack on reduced graphene oxide. ACS nano, 2013. 7(6): p. 5546-57.
49. Han, X., et al., Scalable holey graphene synthesis and dense electrode fabrication toward high-performance ultracapacitors. ACS nano, 2014. 8(8): p. 8255-65.
50. Ishigami, M., et al., Atomic structure of graphene on SiO2. Nano Lett, 2007. 7(6): p. 1643-8.
51. Liao, L., et al., Top-gated graphene nanoribbon transistors with ultrathin high-k dielectrics. Nano Lett, 2010. 10(5): p. 1917-21.
52. Liao, L., et al., Single-layer graphene on Al203/Si substrate: better contrast and higher performance of graphene transistors. Nanotechnology, 2010. 21(1): p. 015705.
53. Liang, X., et al., Toward clean and crackless transfer of graphene. ACS nano, 2011. 5(11): p. 9144-53.
54. Gao, L., et al., Repeated growth and bubbling transfer of graphene with millimetre-size single-crystal grains using platinum. Nature communications, 2012. 3: p. 699.
55. Suk, J. W., et al., Transfer of CVD-grown monolayer graphene onto arbitrary substrates. ACS nano, 2011. 5(9): p. 6916-24.
56. Kang, J., et al., Efficient transfer of large-area graphene films onto rigid substrates by hot pressing. ACS nano, 2012. 6(6): p. 5360-5.
57. Chen, X.-D., et al., High-quality and efficient transfer of large-area graphene films onto different substrates. Carbon, 2013. 56: p. 271-278.
58. Müllen, K., Evolution of Graphene Molecules: Structural and Functional Complexity as Driving Forces behind Nanoscience. ACS nano, 2014. 8(7): p. 6531-6541.
59. Narita, A., et al., Bottom-up synthesis of liquid-phase-processable graphene nanoribbons with near-infrared absorption. ACS nano, 2014. 8(11): p. 11622-30.
60. Monnell, J. D., et al., Relative conductances of alkaneselenolate and alkanethiolate monolayers on Au{111}. J Phys Chem B, 2005. 109(43): p. 20343-9.
61. Han, P., et al., Heads and tails: simultaneous exposed and buried interface imaging of monolayers. ACS nano, 2009. 3(10): p. 3115-21.
62. Claridge, S. A., J. J. Schwartz, and P. S. Weiss, Electrons, photons, and force: quantitative single-molecule measurements from physics to biology. ACS nano, 2011. 5(2): p. 693-729.
63. Bumm, L., et al., Directed self-assembly to create molecular terraces with molecularly sharp boundaries in organic monolayers. Journal of the American Chemical Society, 1999. 121(35): p. 8017-8021.
64. Khomyakov, P., et al., First-principles study of the interaction and charge transfer between graphene and metals. Physical Review B, 2009. 79(19): p. 195425.
65. Wofford, J. M., et al., Extraordinary epitaxial alignment of graphene islands on Au (111). New Journal of Physics, 2012. 14(5): p. 053008.
66. Dameron, A. A., L. F. Charles, and P. S. Weiss, Structures and displacement of 1-adamantanethiol self-assembled monolayers on Au{111}. J Am Chem Soc, 2005. 127(24): p. 8697-704.
67. Mullen, T. J., et al., Dynamics of solution displacement in 1-adamantanethiolate self-assembled monolayers. The Journal of Physical Chemistry C, 2007. 111(18): p. 6740-6746.
68. Dameron, A. A., et al., Origins of displacement in 1-adamantanethiolate self-assembled monolayers. The Journal of Physical Chemistry C, 2007. 111(18): p. 6747-6752.
69. Saavedra, H. M., et al., 1-Adamantanethiolate monolayer displacement kinetics follow a universal form. J Am Chem Soc, 2007. 129(35): p. 10741-6.
70. Fujii, S., U. Akiba, and M. Fujihira, Geometry for self-assembling of spherical hydrocarbon cages with methane thiolates on au(111). J Am Chem Soc, 2002. 124(45): p. 13629-35.
71. Kondoh, H., C. Kodama, and H. Nozoye, Structure-dependent change of desorption species from n-alkanethiol monolayers adsorbed on Au (111): Desorption of thiolate radicals from low-density structures. The Journal of Physical Chemistry B, 1998. 102(13): p. 2310-2312.
72. Kondoh, H., et al., Molecular processes of adsorption and desorption of alkanethiol monolayers on Au (111). The Journal of chemical physics, 1999. 111(3): p. 1175-1184.
73. Tosquellas, G., et al., The pro-oligonucleotide approach: solid phase synthesis and preliminary evaluation of model pro-dodecathymidylates. Nucleic Acids Res, 1998. 26(9): p. 2069-74.
74. Plante, O. J., E. R. Palmacci, and P. H. Seeberger, Automated solid-phase synthesis of oligosaccharides. Science, 2001. 291(5508): p. 1523-1527.

1. A method to synthesize a surface-attached linear polymer containing a plurality of constituent monomers of a same or different type, the linear polymer selected from the group consisting of: a polynucleotide containing a plurality of nucleotides of same or different type, a polypeptide containing a plurality of amino acid of same or different type, and a polysaccharide containing a plurality of saccharides of same or different type, the method comprising:
a) attaching monomers of each type of constituent monomer of the linear polymer to attachment sites of a corresponding set of monomer binding regions on a coated surface, to provide attached monomers of each type of constituent monomers of the linear polymer
wherein corresponding sets of monomer binding regions for all types of constituent monomers contained in the polymer, form on the patterned surface a plurality of monomer binding regions in which an attachment site of each monomer binding region of the plurality of monomer binding regions is located at a distance MBD with respect to the attachment site of an adjacent monomer binding region of the plurality of monomer binding regions wherein
$$M B D ≅ \frac{C Wem + C Wam}{2}$$
in which CWem is a characteristic width of a monomer bound to said each monomer binding region of the plurality of monomer binding regions and CWam is a characteristic width of a monomer bound to the adjacent monomer binding region of the plurality of monomer binding regions, so that adjacent constituent monomers attached to the plurality of monomer binding regions present corresponding polymerizing functional groups at a distance approximately equal to a corresponding bond length ±50% one with respect to another, and
b) performing a coupling reaction between polymerizing functional groups of the attached monomers of each type of constituent monomers of the linear polymer to obtain the surface-attached linear polymer.

2. The method of claim 1, further comprising c) detaching the surface-attached linear polymer from the surface at least one cleavable bond presented on a connecting structure linking the synthesized polymer to the surface.

3. The method of claim 1, wherein for at least two adjacent monomers of the linear polymer CWem=CWam and wherein each of CWem and CWam of the at least two adjacent monomers is equal to or greater than a minimum allowable spacing (MAS) of the coated surface.

4. The method of claim 1, wherein for the at least two adjacent monomers of the polymer, CWem≠CWam and wherein CWem+CWam is equal to or greater than twice a minimum allowable spacing (MAS) of the coated surface.

5. The method of claim 1, wherein corresponding sets of monomer binding regions are located and distanced among themselves so that a sequential order of the monomer binding regions on the patterned coated surface corresponds to sequential order of positions of the each type of constituent monomer in the linear polymer.

6. The method of claim 1, wherein the a) attaching monomers is performed by specifically attaching a surface linking functional group of each monomer to a corresponding anchor functional group presented on a corresponding attachment site of the corresponding monomer binding region, to provide the each monomer attached in an orientation allowing formation, under suitable conditions, of covalent bonds between polymerizing functional groups of the each monomer at bond length with corresponding polymerizing functional groups of an adjacent attached monomer.

7. The method of claim 1, wherein a) attaching monomers of each type of constituent monomer comprises applying an electric field to the attached monomers to provide attached monomers in an orientation allowing formation, under suitable conditions, of covalent bonds between polymerizing functional groups of the each monomer at bond length with corresponding polymerizing functional groups of an adjacent attached monomer.

8. The method of claim 1, wherein the attached monomers of each type of constituent monomers of the linear polymer has an orientation substantially parallel to a direction of polymerization of the polymer.

9. The method of claim 1, wherein the a) attaching monomers of each type of constituent monomer comprises attaching the at least one chemically orthogonal orienting linker presented on at least one monomer of the monomers with a corresponding orienting anchor presented on the corresponding monomer binding region to provide the at least one monomer in an orientation allowing formation, under suitable conditions, of covalent bonds between polymerizing functional groups of the each monomer at bond length with corresponding polymerizing functional groups of an adjacent attached monomer.

10. The method of claim 1 wherein the a) attaching monomers of each type of constituent monomer is performed by
patterning the coated surface to selectively provide the corresponding set of monomer binding regions on the coated surface, thus forming a patterned coated surface in which monomer binding regions of the corresponding set of monomer binding regions are located and distanced among themselves so that a sequential order of the monomer binding regions on the patterned coated surface corresponds to sequential order of positions of the each type of constituent monomer in the linear polymer; and
depositing one or more monomers of said each type of constituent monomer on the monomer binding regions of the corresponding set of monomer binding regions by specifically attaching a surface linking functional group of the one or more monomers to a corresponding anchor functional group presented on the attachment sites,
the each of the one or more monomers attached to a corresponding attachment site with an orientation allowing formation, under suitable conditions, of covalent bonds between polymerizing functional groups of the one or more monomers with corresponding polymerizing functional groups of another monomer attached to the surface when the corresponding polymerizing functional groups are presented at a bond length with respect to said polymerizing functional groups of the one or more monomers.

11. The method of claim 10, wherein when the linear polymer contains one type of constituent monomers and the a) attaching monomers of each type of constituent monomer is performed by a single round of i) patterning and ii) depositing.

12. The method of claim 10, wherein the linear polymer contains two types of constituent monomers, each presenting orthogonal surface linking functional group and corresponding anchor functional group and wherein the a) attaching monomers of each type of constituent monomer is performed by a single round of patterning and the depositing

13. The method of claim 10, wherein the linear polymer contains different types of constituent monomers and a) attaching monomers of each type of constituent monomer is performed by sequentially performing rounds of i) patterning, and ii) depositing, each round to bind a single type of constituent monomer to the at least one attachment site of the corresponding set of monomer binding regions.

14. The method of claim 10, wherein the linear polymer contains different types of a constituent monomers and a) attaching monomers of each type of constituent monomer is performed by sequentially performing rounds of i) patterning, and ii) depositing, each round to bind two types of constituent monomers presenting orthogonal surface linking functional group and corresponding anchor functional groups to the at least one attachment site of the corresponding set of monomer binding regions.

15. The method of claim 10, wherein further comprising attaching the anchor functional group at the attachment site, in a configuration where the anchor functional group is presented for binding to a corresponding surface linking functional group on a monomer of the each type of constituent monomers.

16. The method of claim 1, wherein the coated surface presents a mask of inert material and patterning the surface comprises unmasking regions of the surface.

17. The method of claim 16, further comprising covering a surface with the mask of inert material to provide the coated surface before patterning.

18. The method of claim 16 wherein the mask is a graphene mask.

19. The method of claim 16, wherein the surface is a gold surface.

20. The method of claim 1, wherein the coated surface is a passivated surface and patterning the coated surface comprises activating regions of the surface of the passivated material.

21. The method of claim 20, further comprising passivating a surface of a passivatable material to provide the coated surface before a) attaching monomers.

22. The method of claim 21, wherein the passivatable material is silicon.

23. A support for surface-synthesis of a surface-attached linear polymer containing a plurality of constituent monomers of a same or different type, the linear polymer selected from the group consisting of: a polynucleotide containing a plurality of nucleotides of same or different type, a polypeptide containing a plurality of amino acid of same or different type, and a polysaccharide containing a plurality of saccharides of same or different type, the support comprising
at least one set of monomer binding regions patterned on a coated surface of the support so that a sequential order of the monomer binding regions corresponds to a sequential order of positions of a single type of constituent monomer in the linear polymer, the at least one set of monomer binding regions forming a plurality of patterned monomer binding regions,
wherein each monomer binding region of the plurality of monomer binding regions having an attachment site located at a distance MBD with respect to an attachment site of an adjacent monomer binding region of the plurality of monomer binding regions wherein
$$M B D ≅ \frac{C Wem + C Wam}{2}$$
in which CWem is a characteristic width of a monomer bound to said each monomer binding region of the plurality of monomer binding regions and CWam is a characteristic width of a monomer bound to the adjacent monomer binding region of the plurality of monomer binding regions, so that adjacent constituent monomers attached to the plurality of monomer binding regions present corresponding polymerizing functional groups at a distance approximately equal to the bond length ±50% one with respect to another.

24. The support of claim 23, wherein the coated surface has a minimum allowable spacing (MAS) and for at least two adjacent monomers of the linear polymer CWem=CWam with each of CWem and CWam equal to or greater than the minimum allowable spacing (MAS) of the coated surface.

25. The support of claim 23, wherein the coated surface has a minimum allowable spacing (MAS) and for the at least two adjacent monomers of the polymer, CWem≠CWam and with CWem+CWam equal to or greater than twice the minimum allowable spacing (MAS) of the coated surface.

26. A method to provide a support for a surface attached polymer synthesis, the method comprising
providing a support having a surface capable of attaching monomers of each type of monomers contained in the polymer
covering the surface with a mask of inert material to provide a coated surface;
patterning the coated surface to provide the coated surface with at least one set of monomer binding regions patterned on the coated surface so that a sequential order of the monomer binding regions corresponds to a sequential order of positions of a single type of monomer in the polymer, the at least one set of monomer binding regions forming a plurality of patterned monomer binding regions,
wherein each monomer binding region of the plurality of monomer binding regions is located at a distance MBD with respect to the attachment site of an adjacent monomer binding region of the plurality of monomer binding regions wherein
$$M B D ≅ \frac{C Wem + C Wam}{2}$$
in which CWem is a characteristic width of a monomer bound to said each monomer binding region of the plurality of monomer binding regions and CWam is a characteristic width of a monomer bound to the adjacent monomer binding region of the plurality of monomer binding regions, so that adjacent constituent monomers attached to the plurality of monomer binding regions present corresponding polymerizing functional groups at a distance approximately equal to the bond length ±50% one with respect to another.

27. A mask for use with a surface capable of each type of monomers of a polymer to be synthesized, the mask comprising
at least one set of holes patterned on the mask so that a sequential order of holes on the mask corresponds to a sequential order of positions of a single type of monomer in the polymer, the at least one set of holes forming a plurality of patterned holes within a same mask or in combination with one or more additional masks,
wherein the plurality of patterned holes are configured and distanced so that each hole of the plurality of holes is located with respect to an adjacent hole of the plurality of holes to provide attachment sites of underneath monomer binding regions on the surface are at a distance MBD wherein
$$M B D ≅ \frac{C Wem + C Wam}{2}$$
in which CWem is a characteristic width of a monomer bound to an attachment site of the surface underneath the each hole of the plurality of holes and CWam is a characteristic width of a monomer bound to an attachment site of the surface underneath the adjacent hole of the plurality of holes.

28. A combination of masks for use with a surface capable of each type of monomers of a polymer to be synthesized, each mask of the combination of masks comprising
one set of holes patterned on the mask so that a sequential order of holes on the mask corresponds to a sequential order of positions of a single type of monomer in the polymer, the one set of holes of each mask of the combination of masks forming a plurality of patterned holes,
wherein the plurality of patterned holes are configured and distanced so that each hole of the plurality of holes is located with respect to an adjacent hole of the plurality of holes to provide attachment sites of underneath monomer binding regions on the surface are at a distance MBD wherein
$$M B D ≅ \frac{C Wem + C Wam}{2}$$
in which CWem is a characteristic width of a monomer bound to an attachment site of the surface underneath the each hole of the plurality of holes and CWam is a characteristic width of a monomer bound to an attachment site of the surface underneath the adjacent hole of the plurality of holes.

29. A system to synthesize a sequence controlled molecule, the system comprising the support of claim 23, together with at least one of
monomers of the type of monomers contained in the polymer,
reagents to perform deposing of the monomers, and
reagents for performing coupling of the monomers

30. A system to synthesize a polymer, the system comprising
a surface of material capable attaching each type of monomers contained in a polymer to be synthesized;
the mask of claim 27 and
optionally, at least one of
monomers of the each type of monomers contained in the polymer,
reagents to perform deposing of the monomers, and
reagents for performing coupling of the monomers

31. System to synthesize a polymer, the system comprising
a surface of material capable attaching each type of monomers contained in a polymer to be synthesized;
the combination of masks of claim 28 and
optionally, at least one of
monomers of the each type of monomers contained in the polymer,
reagents to perform deposing of the monomers, and
reagents for performing coupling of the monomers

32. A polymer formed by monomers, wherein each of the monomers of the polymer is attached to a surface of the support of claim 23.
